(19) United States
(12) Patent Application Publication
(10) Pub. No.: US 2026/0317348 A1
(43) Pub. Date: Oct. 15, 2026

(54) Non-Coordinated Alkylaluminum Free Anion Modified Alumoxanes and Methods Thereof

(71) Applicant: ExxonMobil Technology and Engineering Company, Spring, TX (US)

(72) Inventors: Lubin Luo, Houston, TX (US); Jo Ann M. Canich, Houston, TX (US); Alexander V. Zabula, Seabrook, TX (US); Xuan Ye, Houston, TX (US)

(21) Appl. No.: 19/490,213

(22) PCT Filed: May 20, 2024
(86) PCT No.: PCT/US2024/030225

§ 371 Date: Dec. 4, 2025

Related U.S. Application Data
(60) Provisional application No. 63/506,543, filed on Jun. 6, 2023.

(51) Int. Cl. C07F 5/06; B01J 31/14

(52) U.S. Cl. CPC C07F 5/068; B01J 31/143; B01J 2231/12

(57) ABSTRACT

The present disclosure relates to alumoxane compositions substantially or completely undetectable alkylaluminum content, methods of forming such alumoxane compositions, catalyst systems having the alumoxane compositions, and methods of polymerizing olefins using catalyst systems having the alumoxane compositions. In some embodiments, the present disclosure relates to unsupported or supported MAO compositions, methods of forming MAO, catalyst systems having MAO, and methods of polymerizing olefins using catalyst systems having MAO. In some embodiments, a method of making an unsupported or supported MAO with undetectable or low free trihydrocarbyl aluminum includes introducing an unsupported or supported MAO with an electron withdrawing compound to form an unsupported or supported MAO composition with undetectable or low free trihydrocarbyl aluminum.

### CROSS REFERENCE TO RELATED APPLICATIONS

This application claims the benefit of and priority to U.S. Provisional Application No. 63/506,543 filed Jun. 6, 2023, the disclosure of which is incorporated herein by reference.

### FIELD

The present disclosure relates to aluminoxane compositions substantially or completely undetectable hydrocarbyl aluminum content, methods of forming such alumoxane compositions, catalyst systems having the alumoxane compositions, and methods of polymerizing olefins using catalyst systems having the alumoxane compositions.

### BACKGROUND

Olefin polymerization catalysts are of great use in industry. Hence, there is interest in finding new catalyst systems that increase the commercial usefulness of the catalyst and allow the production of polymers having improved properties. In order to polymerize monomers to form polyolefins, catalysts are activated to provide an active site on the catalyst and promote polymerization of the monomers. Active methylaluminoxane (MAO) from partially hydrolyzed trimethylaluminum (TMA) is effective in activating a type of catalyst known as metallocenes for polymerization of olefins. MAO has become the aluminum co-catalyst (also called an activator) of choice in the industry. It is available commercially in the form of 10 to 30 wt % solutions in an aromatic diluent, typically toluene.

Considerable effort has been devoted to improving the effectiveness of catalyst systems for polymerization of olefins based on use of methylaluminoxanes or modified methylaluminoxanes. For example, WO 2009/029857 shows dimethylaluminum cation (AlMe₂⁺) formation from MAO upon treatment of MAO with a Lewis base, e.g., tetrahydrofuran, in a toluene solution. Lewis base stabilized dialkylaluminum cation such as AlMe₂⁺ can also be derived from non-MAO sources and used as metallocene catalyst activators; see for example Klosin et al., WO 2000/011006, and Organometallics, 2000, v. 19, pp. 4684-4686; U.S. Pat. No. 9,090,720 shows a metallocene with dimethoxy leaving groups ethylenebisindenylzirconium dimethoxide (EtInd₂Zr(OMe)₂) extracts AlMe₂⁺ from MAO to form a [EtInd₂Zr(μ-OMe)₂AlMe₂]⁺ species, which are slowly alkylated to form fully activated species [EtInd₂Zr(μ-Me)₂AlMe₂]⁺, as a strong evidence of AlMe₂⁺ activation from MAO. The fully activated [EtInd₂Zr(μ-Me)₂AlMe₂]⁺ species is similar to other MAO activated metallocenes that also form the metallocene-dialkylaluminum cation species, for example, [Cp₂Zr(μ-Me)₂AlMe₂]⁺ or [Cp₂Ti(μ-Me)₂AlMe₂]⁺, such as examples in Babushkin and Brintzinger, J. Am. Chem. Soc., 2002, v. 124, pp. 12869-12873, and Sarzotti et al., J. Polymer Sci. A, 2007, v. 45, pp. 1677-1690, which describe the activation of a zirconocene catalyst precursor by MAO; also see Bryliakov, Talsi, and Bochmann, Organometallics, 2004, v. 23, pp. 149-152, which describes activation of a titanocene catalyst precursor by MAO. Although the MAO structure is still remaining unclear, freshly made active MAO has shown the evidence of coordinated TMA in MAO in agreement with the experimental formula (Al₄O₃Me₆)₄(TMA)₁₋₂ described by Sinn and Kaminsky (Sinn, et al., “Formation, Structure, and Mechanism of Oligomeric Methylaluminoxane”, in Kaminsky (ed.), Metalorg. Cat. for Synth. & Polym., Springer-Verlag, 1999, p. 105). The coordinated TMA is believed to be in equilibrium with free TMA because the attempt to physically remove all free TMA results in the loss of both free and coordinated TMA and the formation of the more thermally stable MAO gel, which become much less useful due to its insolubility that becomes unsupportable to form supported finished catalysts dominantly used in both gas- and slurry-phase polymerizations or not possible to use in solution polymerization. The equilibrium is shown in Scheme 1 using the Sinn's fresh MAO formula as an attempt to help understanding of the gelation process.

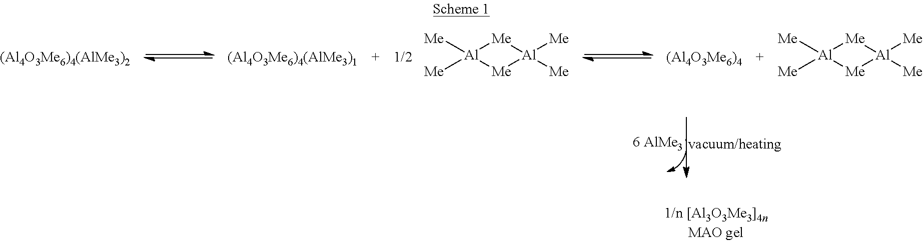

Studies have shown that the coordinated TMA in MAO actually serves as the AlMe₂⁺ source for the pre-catalyst ionization while the free TMA in MAO in equilibrium with the coordinated TMA serves as the alkylation agent as shown in Scheme 2 with the use of a circle to represent the MAO structure because (Al₄O₃Me₆)₄ unit for clearness (Luo, Jain, and Harlan, INOR 1169, American Chemical Society Priestley Medalist Symposium in Honor of Tobin J. Marks, San Francisco, CA, Apr. 5, 2017; Luo, et al., U.S. Pat. No. 8,575,284 (2013) and 9090720 (2015)):

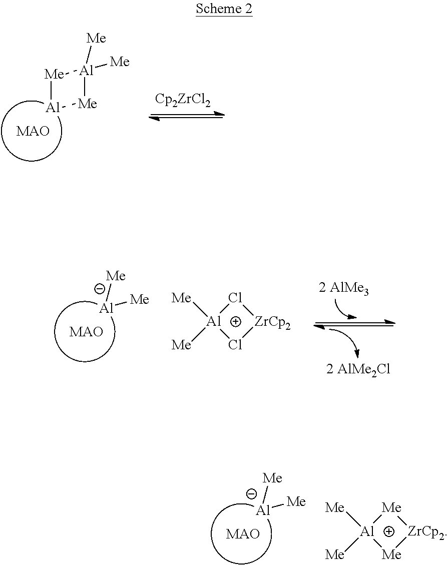

Maintaining a significant amount of free TMA in an active MAO solution is therefore necessary in order to stabilize the active MAO compositions, e.g., to stabilize the coordinated TMA capped MAO molecule structure to reduce chances of dimerization/oligomerization that forms gel that becomes insoluble as well as reduces the active MAO molecule numbers.

Nonetheless, post-metallocene catalysts and constrained-geometry-complex (CGC) catalysts (also referred to as mono-cyclopentadienyl (mono-Cp) catalysts) containing polar ligands such as oxygen and/or nitrogen donors have displayed challenges to activate with regular MAO, showing low catalyst activity and short catalyst lifetimes. Without being bound by theory, it is believed that the poor activity and short catalyst lifetime are due to the presence of free TMA in MAO that are capable of alkylating the pre-catalyst transition metal center bonded to hetero-atoms (Scheme 3 with Zr center as example), similar to the alkylation of a metallocene with dichloride leaving groups in Scheme 2:

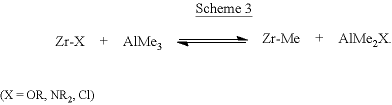

There is a need for improved MAO and methods of forming MAO that provide high activity and long catalyst lifetime to post-metallocene catalysts and/or CGC catalysts. For example, solution or supported MAO with sufficient coordinated TMA but undetectable or low free TMA content.

References for citing in an Information Disclosure Statement (37 C.F.R. 1.97(h)): U.S. 2019/0127499; U.S. 2009/0124486; U.S. Pat. No. 6,667,272; U.S. 2019/0153135; U.S. 2013/0253155; U.S. 2018/0142046; U.S. Pat. Nos. 7,193,100; 6,368,999; 8,575,284.

### SUMMARY

The present disclosure relates to an active aluminoxane composition with undetectable or low free alkylaluminum content, methods of forming such an active aluminoxane composition, catalyst systems comprising such an active aluminoxane composition, and methods of polymerizing olefins using catalyst systems comprising such an active aluminoxane composition.

In some embodiments, the aluminoxane composition with undetectable or low free aluminum alkyl content is an electron withdrawing group modified aluminoxane composition containing about 8.5 mol % or less of THF extractable alkylaluminum, based on total aluminum content of the aluminoxane composition.

In some embodiments, a method of making a alumoxane composition with undetectable or lower in free trialkylaluminum includes introducing an alumoxane with an electron withdrawing compound containing at least one electron withdrawing group to form an electron withdrawing group modified alumoxane composition. The method includes introducing a hydrocarbyl aluminum compound with an oxygen source at a temperature of about −60° C. to about −5° C. to form the alumoxane composition.

In some embodiments, the aluminoxane composition with undetectable or low free trialkylaluminum content is a methylaluminoxane (MAO) composition formed by contacting an electron withdrawing compound capable of reducing the THF extractable total trimethylaluminum (TMA) in a unsupported or a supported MAO composition to 8.5 mol % or lower, based on total aluminum content of the MAO composition.

In some embodiments, a catalyst system comprises a pre-catalyst compound and an MAO composition with undetectable or low free trialkylaluminum content, wherein the MAO composition with undetectable or low free TMA content includes an MAO, an electron withdrawing group-containing hydrocarbyl aluminum compound, and about 8.5 mol % or less of THF extractable total trialkylaluminum, based on total aluminum content of the MAO composition.

In some embodiments, the methods of forming the active MAO composition with undetectable or low free TMA content comprise a method of in-situ conversion of the THF extractable TMA in the unsupported or supported MAO to AlMe₂X, a compound capable of serving as a coordinated and free TMA equilibrium blocking agent (so-called a TEB agent), with a compound containing at least one electron withdrawing group X, so-called an electron withdrawing compound.

In some embodiments, the methods of forming the active MAO composition with undetectable or low free TMA content comprise the in-situ conversion of the majority or all of the THF extractable TMA in the MAO composition to a TEB agent AlMe₂X through bringing into contact of an electron withdrawing compound containing at least one electron withdrawing group X and an unsupported or supported MAO composition, wherein X is a fluorine atom or a perfluorinated aryloxy group.

In some embodiments, an alumoxane composition with undetectable or low free trialkylaluminum content includes an alumoxane, a TEB agent AlR₂X, wherein R is C₁ to C₁₀ hydrocarbyl group and the two R can be the same or different, and about 2 wt % Al or less as free or dimeric trihydrocarbyl aluminum compound AlR₃, based on total aluminum content of the alumoxane.

In some embodiments, a catalyst system comprises a pre-catalyst compound and a alumoxane composition with undetectable or low free trialkylaluminum content, wherein the aluminoxane composition with undetectable or low free trialkylaluminum content comprises an alumoxane, a TEB agent AlR₂X, where R is C₁ to C₁₀ hydrocarbyl group and the two R can be the same or different, and about 2 wt % Al or less as free or dimeric hydrocarbyl aluminum compounds AlR₃, based on total aluminum content of the alumoxane.

In some embodiments, the methods of forming the supported or solid MAO composition with undetectable or low free TMA content comprise a pre-formed AlR₂X treatment and a free TMA removal process, e.g., a filtration or decantation step.

In some embodiments, the electron withdrawing compound used to form the TEB agent comprises at least one Si—F unit.

In some embodiments, methods of polymerizing olefins include using catalyst systems.

### BRIEF DESCRIPTION OF THE DRAWINGS

FIG. 1 is a graph illustrating ethylene uptake of post-metallocene Complex 6 finished catalyst using an inventive activator, according to an embodiment.

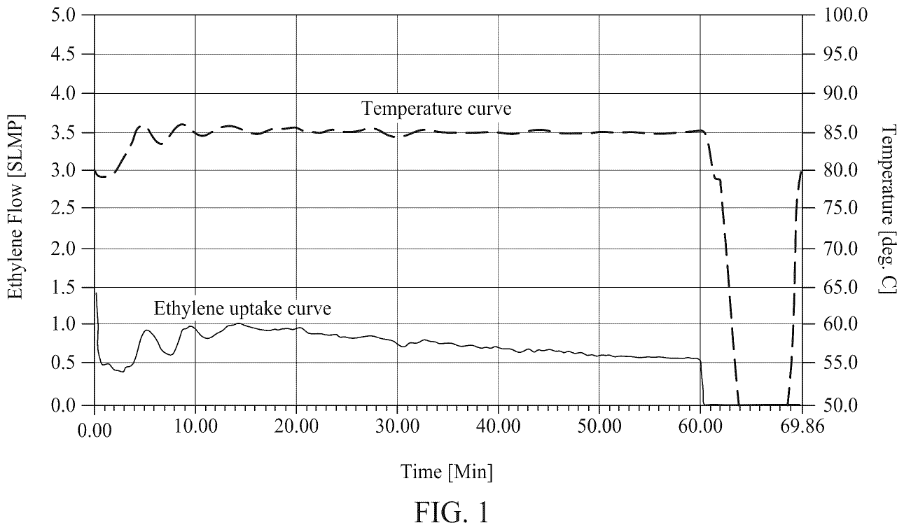

FIG. 2 is a graph illustrating ethylene uptake of post-metallocene Complex 6 finished catalyst using a conventional supported MAO activator, according to an embodiment.

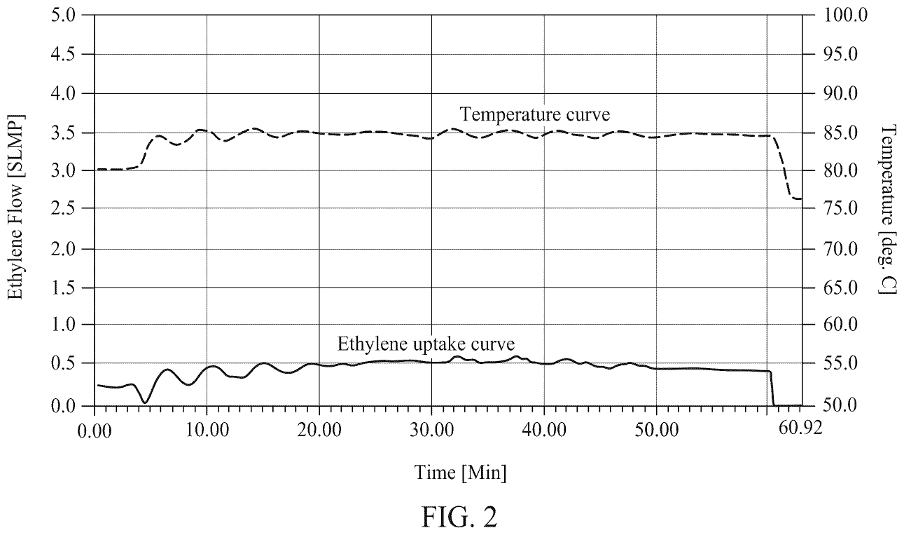

FIGS. 3A-B illustrate ¹H NMR spectra of an inventive activator (3A) showing less THF extractable TMA(THF) and more AlMe₂⁺(THF)₂ with inert species SiMe₄ and [(NHAlMe)₃]₂ vs. regular MAO (4B), both with toluene solvent as the reference, according to an embodiment.

FIGS. 4A-B illustrate ¹H NMR spectra of a 30% commercial MAO solution after KF treatment; with 4A) showing the upper solution phases after 2, 4, 7, and 10 mol % KF treatment, respectively; and with 4B) showing the final K⁺(F-MAO)⁻ clathrate phase (b) and the non-treated solution MAO (a) for comparison.

FIG. 5 is a graph illustrating the solution ethylene-butadiene copolymerization activities of three Group 3 post-metallocenes Complex 36, 34, and 35 activated with the inventive TMA free MAO (TF-MAO), respectively to compare with the regular MAO solution and the perfluoraromatic boron/AlⁱBu₂H activator systems, according to an embodiment.

### DEFINITIONS

An “olefin,” alternatively referred to as “alkene,” is a linear, branched, or cyclic compound of carbon and hydrogen having at least one double bond. For purposes of this specification and the claims appended thereto, when a polymer or copolymer is referred to as comprising an olefin, the olefin present in such polymer or copolymer is the polymerized form of the olefin. For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. Accordingly, the definition of copolymer, as used herein, includes terpolymers and the like. “Different” as used to refer to mer units indicates that the mer units differ from each other by at least one atom or are different isomerically. An “ethylene polymer” or “ethylene copolymer” is a polymer or copolymer comprising at least 50 mol % ethylene derived units, a “propylene polymer” or “propylene copolymer” is a polymer or copolymer comprising at least 50 mole % propylene derived units, and so on.

Ethylene shall be considered an α-olefin.

The term “metallocene” refers to a catalyst compound containing two substituted or unsubstituted cyclopentadienyl moieties, bridging or non-bridging together, where the two cyclopentadienyl moieties bind directly to the transition metal center having at least two leaving groups when the metal center is charge neutral or having at least one leaving group and an optional weak donor when it bears a positive charge; the term “half-metallocene” refers to a catalyst compound containing one substituted or unsubstituted cyclopentadienyl moiety and a heteroatom containing ligand, bridging or non-bridging together, where the cyclopentadienyl moiety and at least one of the heteroatom on the heteroatom containing ligand bind directly to the transition metal center having at least two leaving groups when the metal center is charge neutral or having at least one leaving group and an optional weak donor when the metal center bears a positive charge, including so-called “constrained geometry catalyst” (CGC) compounds. The term “post-metallocene” refers to a catalyst compound containing no cyclopentadienyl moiety but ligands with hetero-atoms, e.g., N, O, P, B, S, and the like, directly binding to the catalyst metal center having at least two leaving groups when it is charge neutral or having at least one leaving group and an optional weak donor when it bears a positive charge.

The terms “aluminoxane” and “alumoxane” are used interchangeably to refer to the composition made from the reaction of a trialkylaluminum, e.g., C₁-C₁₀ trialkylaluminum or the mixture thereof, with an oxygen source, which may or may not include the coordinated and free trialkylaluminum.

The term “MAO” can refer to the MAO composition that includes MAO, coordinated TMA, free TMA, and gel, e.g., species in Scheme 1, but can sometimes refer to just the MAO main molecule only, e.g., (Al₄O₃Me₆)₄, without the coordinated TMA and free TMA.

“Aluminumalkyl or alkylaluminum” means compounds containing at least one Al-alkyl (Al—R, where R is a C₁ to C₁₂ hydrocarbyl group) unit and may be coordinated to or not coordinated to the main aluminoxane structure. Such a compound if not coordinated to the main aluminoxane structure is also called a non-coordinated aluminumalkyl or a free aluminumalkyl, which may coordinate to each other to form a dimer, for example, the AlMe3 dimer in Scheme 1.

“Non-coordinated alkylaluminum” or “free alkylaluminum” has the same meaning to represent an aluminum compound having at least one alkyl group, e.g., Me, Et, iBu, Oct, in the form of either monomer or dimer that is not chemically bound to the aluminoxane structure. Although the free alkylaluminum can exchange with the coordinated alkylaluminum on the aluminoxane structure to become coordinated, the regeneration of the free alkylaluminum from the originally coordinated alkylaluminum maintains the free alkylaluminum concentration under the same conditions.

The terms aluminoxane, alumoxane, alkylaluminoxane, and alkylalumoxane are used interchangeably.

Sometimes only alkylaluminum is used to represent free alkylaluminum, e.g., TMA means free TMA.

“Free” or “free of” means undetectable with the current analytical methods, such as NMR spectroscopy or a conventional wet titration method. “Low in” means 2 wt % or 2 mol % or less based on total same element in the system, e.g., low in free TMA means the Al weight (or mol) of the free TMA content is 2 wt % (or mol %) or less based on the total Al weight (or mol) in the MAO composition. In some embodiments, “free” or “free of” includes the “low in” description, e.g., TMA free MAO may indicate the Al weight or molar number of the free TMA content is 2 wt % or 2 mol % or less based on the total Al content in MAO.

The term “undetectable” means a species quantification result from an analytical method, e.g., an NMR measurement method or a chemical titration method, is zero or near zero.

The terms “anion modified alkylaluminoxane”, “anion modified aluminoxane”, “electron-withdrawing group modified alkylaluminoxane”, “electron-withdrawing group modified aluminoxane”, and “F-MAO” have the similar meaning and are used interchangeably.

The term “electron withdrawing group” (EWG) may refer to an atom or a group X capable of withdrawing electron from the atom where X is directly bonded to, as defined in organic chemistry. Here the EWG may be more specific: If any Al—X bond formed on the Al site on MAO where a coordinated TMA is coordinated to is stronger than the Al—C bond between the same Al site on MAO and the sharing CH₃ group of the coordinated TMA, both in a 3-center-2-electron bonding, therefore to enable a partial or complete replacement of the coordinated TMA with an in-situ or pre-formed AlR₂X compound, where R=C₁-C₈ hydrocarbyl group, such an X is called EWG; e.g., X is —F or —OC₆F₅ (see Scheme 5).

The term “electron withdrawing compound” (EWC) may refer to a compound containing at least one electron-withdrawing group X capable of reacting with an aluminum alkyl compounds to form the AlR₂X compound, where R=C₁-C₈ hydrocarbyl group, that is capable of completely or partially blocking the coordinated and free TMA equilibrium in either the supported or unsupported (solution or solid) MAO composition, so-called a coordinated and free TMA equilibrium blocking agent or TEB agent (vide infra). For examples, (NH₄)₂SiF₆, SiF₄, HOC₆F₅ and the like can be used to react with AlMe₃, AlEt₃, AlOct₃ to form AlMe₂F, AlEt₂F, AlOct₂F, AlMe₂(OC₆F₅), AlEt₂(OC₆F₅), and AlOct₂(OC₆F₅), respectively, either in-situ in an MAO composition or ex-situ then adding to an MAO composition; KF, NaF, K(OC₆F₅), Na(OC₆F₅) and the like can be used to react with AlMe₂Cl, AlMe₂Br to form AlMe₂F, AlMe₂(OC₆F₅), respectively, which can then be separated from the byproduct metal salts, such as KCl or NaCl, before adding to an aluminoxane composition.

The term “coordinated and free TMA equilibrium blocking agent” (TEB) may refer to a compound having the formula AlR₂X, where R=C₁-C₈ hydrocarbyl group and X is an electron withdrawing group defined above. Such a compound is cable of replacing the coordinated TMA in an MAO composition therefore to eliminate or limit the conversion of coordinated TMA to free TMA while maintaining the capability of providing AlR₂⁺ as the active site (e.g., Scheme 4). The TEB can form in-situ or preform through bringing into contact of a so-called electron withdrawing compound as defined above with either the AlR₃ component in an aluminoxane composition or a neat AlR₃ or AlR₂Y compound, where Y is a non-fluorine halide, such as Cl, Br.

Unless otherwise specified, the term “Cₙ” means hydrocarbon(s) having n carbon atom(s) per molecule, wherein n is a positive integer.

The term “hydrocarbon” means a class of compounds containing hydrogen bound to carbon, and encompasses (i) saturated hydrocarbon compounds, (ii) unsaturated hydrocarbon compounds, and (iii) mixtures of hydrocarbon compounds (saturated and/or unsaturated), including mixtures of hydrocarbon compounds having different values of n. Likewise, a “Cₘ-C_{y}” group or compound refers to a group or compound comprising carbon atoms at a total number thereof in the range from m to y. Thus, a C₁-C₅₀ alkyl group refers to an alkyl group comprising carbon atoms at a total number thereof in the range from 1 to 50.

The terms “group,” “radical,” and “substituent” may be used interchangeably.

The terms “hydrocarbyl radical,” “hydrocarbyl group,” or “hydrocarbyl” may be used interchangeably and are defined to mean a group consisting of hydrogen and carbon atoms only. Hydrocarbyls may be C₁-C₁₀₀ radicals that may be linear, branched, or cyclic, and when cyclic, aromatic or non-aromatic. Examples of such radicals include, but are not limited to, alkyl groups such as methyl, ethyl, n-propyl, isopropyl, n-butyl, isobutyl, sec-butyl, tert-butyl, pentyl, iso-amyl, hexyl, octyl, cyclopropyl, cyclobutyl, cyclopentyl, cyclohexyl, cyclooctyl, and the like, aryl groups, such as phenyl, benzyl, naphthalenyl, and the like.

Unless otherwise indicated, (e.g., the definition of “substituted hydrocarbyl”, “substituted aromatic”, etc.), the term “substituted” means that at least one hydrogen atom has been replaced with at least one non-hydrogen group, such as a hydrocarbyl group, a heteroatom, or a heteroatom containing group, such as halide (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, where each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted hydrocarbyl” means a hydrocarbyl radical in which at least one hydrogen atom of the hydrocarbyl radical has been substituted with at least one heteroatom (such as halide, e.g., Br, Cl, F or I) or heteroatom-containing group (such as a functional group, e.g., —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, where each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “aryl” or “aryl group” means an aromatic ring and the substituted variants thereof, such as phenyl, 2-methyl-phenyl, xylyl, 4-bromo-xylyl. Likewise, “heteroaryl” means an aryl group where a ring carbon atom (or two or three ring carbon atoms) has been replaced with a heteroatom, such as N, O, or S. As used herein, the term “aromatic” also refers to pseudoaromatic heterocycles which are heterocyclic substituents that have similar properties and structures (nearly planar) to aromatic heterocyclic ligands, but are not by definition aromatic; likewise, the term aromatic also refers to substituted aromatics.

The term “substituted aromatic,” means an aromatic group having 1 or more hydrogen groups replaced by a hydrocarbyl, substituted hydrocarbyl, heteroatom or heteroatom containing group.

A “substituted phenolate” is a phenolate group where at least one, two, three, four or five hydrogen atoms in the 2, 3, 4, 5, and/or 6 positions has been replaced with at least one non-hydrogen group, such as a hydrocarbyl group, a heteroatom or heteroatom-containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, and the like, where each R* is independently hydrogen, a hydrocarbyl or halocarbyl radical, and two or more R* may join together to form a substituted or unsubstituted completely saturated, partially unsaturated, or aromatic cyclic or polycyclic ring structure), where the 1 position is the phenolate group (Ph-O—, Ph-S—, and Ph-N(R\hat{ })— groups, where R\hat{ } is hydrogen, C₁-C₄₀ hydrocarbyl, C₁-C₄₀ substituted hydrocarbyl, a heteroatom or a heteroatom-containing group). For example, a “substituted phenolate” group in the catalyst compounds described herein is represented by the formula:

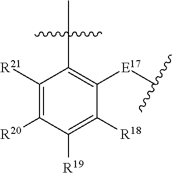

where R¹⁸ is hydrogen, C₁-C₄₀ hydrocarbyl (such as C₁-C₄₀ alkyl) or C₁-C₄₀ substituted hydrocarbyl, a heteroatom or a heteroatom-containing group, E¹⁷ is oxygen, sulfur, or NR¹⁷, and each of R¹⁷, R¹⁹, R²⁰, and R²¹ is independently selected from hydrogen, C₁-C₄₀ hydrocarbyl (such as C₁-C₄₀ alkyl) or C₁-C₄₀ substituted hydrocarbyl, a heteroatom or a heteroatom-containing group, or two or more of R¹⁸, R¹⁹, R²⁰, and R²¹ are joined together to form a C₄-C₆₂ cyclic or polycyclic ring structure, or a combination thereof, and the wavy line shows where the substituted phenolate group forms bonds to the rest of the catalyst compound.

An “alkyl substituted phenolate” is a phenolate group where at least one, two, three, four or five hydrogen atoms in the 2, 3, 4, 5, and/or 6 positions has been replaced with at least one alkyl group, such as a C₁ to C₄₀, alternately C₂ to C₂₀, alternately C₃ to C₁₂ alkyl, such as methyl, ethyl, methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, adamantyl and the like including their substituted analogues.

An “aryl substituted phenolate” is a phenolate group where at least one, two, three, four or five hydrogen atoms in the 2, 3, 4, 5, and/or 6 positions has been replaced with at least one aryl group, such as a C₁ to C₄₀, alternately C₂ to C₂₀, alternately C₃ to C₁₂ aryl group, such as phenyl, 4-fluorophenyl, 2-methylphenyl, 2-propylphenyl, 2,6-dimethylphenyl, mesityl, 2-ethylphenyl, naphthalenyl, and the like including their substituted analogues.

The term “ring atom” means an atom that is part of a cyclic ring structure. By this definition, a benzyl group has six ring atoms and tetrahydrofuran has 5 ring atoms.

A heterocyclic ring, also referred to as a heterocycle, is a ring having a heteroatom in the ring structure as opposed to a “heteroatom-substituted ring” where a hydrogen on a ring atom is replaced with a heteroatom. For example, tetrahydrofuran is a heterocyclic ring and 4-N,N-dimethylamino-phenyl is a heteroatom substituted ring. A substituted heterocyclic ring means a heterocyclic ring having 1 or more hydrogen groups replaced by a hydrocarbyl, substituted hydrocarbyl, heteroatom or heteroatom containing group.

A substituted hydrocarbyl ring means a ring comprised of carbon and hydrogen atoms having 1 or more hydrogen groups replaced by a hydrocarbyl, substituted hydrocarbyl, heteroatom or heteroatom containing group.

For purposes of the present disclosure, in relation to catalyst compounds (e.g., substituted bis(phenolate) catalyst compounds), the term “substituted” means that a hydrogen group has been replaced with a hydrocarbyl group, a heteroatom or heteroatom-containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, and the like, where each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

A tertiary hydrocarbyl group possesses a carbon atom bonded to three other carbon atoms. When the hydrocarbyl group is an alkyl group, tertiary hydrocarbyl groups are also referred to as tertiary alkyl groups. Examples of tertiary hydrocarbyl groups include tert-butyl, 2-methylbutan-2-yl, 2-methylhexan-2-yl, 2-phenylpropan-2-yl, 2-cyclohexylpropan-2-yl, 1-methylcyclohexyl, 1-adamantyl, bicyclo[2.2.1]heptan-1-yl and the like. Tertiary hydrocarbyl groups can be illustrated by the formula:

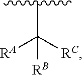

wherein R^{A}, R^{B} and R^{C} are independently hydrocarbyl groups or substituted hydrocarbyl groups that may optionally be bonded to one another, and the wavy line shows where the tertiary hydrocarbyl group forms bonds to other groups.

A cyclic tertiary hydrocarbyl group is defined as a tertiary hydrocarbyl group that forms at least one alicyclic (non-aromatic) ring. Cyclic tertiary hydrocarbyl groups are also referred to as alicyclic tertiary hydrocarbyl groups. When the hydrocarbyl group is an alkyl group, cyclic tertiary hydrocarbyl groups are also referred to as cyclic tertiary alkyl groups or alicyclic tertiary alkyl groups. Examples of cyclic tertiary hydrocarbyl groups include 1-adamantyl, 1-methylcyclohexyl, 1-methylcyclopentyl, 1-methylcyclooctyl, 1-methylcyclodecyl, 1-methylcyclododecyl, bicycle[3.3.1]nonan-1-yl, bicyclo[2.2.1]heptan-1-yl, bicyclo[2.3.3]hexan-1-yl, bicycle[1.1.1]pentan-1-yl, bicycle[2.2.2]octan-1-yl, and the like. Cyclic tertiary hydrocarbyl groups can be illustrated by Formula (B):

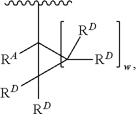

wherein R^{A} is a hydrocarbyl group or substituted hydrocarbyl group, each R^{D} is independently hydrogen or a hydrocarbyl group or substituted hydrocarbyl group, w is an integer from 1 to about 30, and R^{A}, and one or more R^{D}, and or two or more R^{D} may optionally be bonded to one another to form additional rings.

When a cyclic tertiary hydrocarbyl group contains more than one alicyclic ring, it can be referred to as polycyclic tertiary hydrocarbyl group or if the hydrocarbyl group is an alkyl group, it may be referred to as a polycyclic tertiary alkyl group.

The terms “alkyl radical” and “alkyl” are used interchangeably throughout this disclosure. For purposes of this disclosure, “alkyl radical” is defined to be C₁-C₁₀₀ alkyls that may be linear, branched, or cyclic. Examples of such radicals can include methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like including their substituted analogues. Substituted alkyl radicals are radicals in which at least one hydrogen atom of the alkyl radical has been substituted with at least a non-hydrogen group, such as a hydrocarbyl group, a heteroatom or heteroatom-containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, and the like, where each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

Where isomers of a named alkyl, alkenyl, alkoxide, or aryl group exist (e.g., n-butyl, iso-butyl, sec-butyl, and tert-butyl), reference to an alkyl, alkenyl, alkoxide, or aryl group without specifying a particular isomer (e.g., butyl) expressly discloses all isomers (e.g., n-butyl, iso-butyl, sec-butyl, and tert-butyl).

As used herein, Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, Mz) are g/mol (g mol⁻¹).

The following abbreviations may be used herein: Me is methyl, Et is ethyl, MAO is MAO, TMS is trimethylsilyl, Oct is octyl, Bu is butyl, iPr is isopropyl, Bn is benzyl (i.e., CH₂Ph), THF (also referred to as thf) is tetrahydrofuran, RT is room temperature (and is 23° C. unless otherwise indicated), tol is toluene, Cp is cyclopentadienyl, NMR is nuclear magnetic resonance, and TMA is trimethylaluminum.

A “catalyst system” is a combination of at least one pre-catalyst compound, an activator, an optional coactivator, and an optional support material. When “catalyst system” is used to describe such a pair before activation, it means the unactivated catalyst complex (pre-catalyst) together with an activator and, optionally, a coactivator. When it is used to describe such a pair after activation, it means the activated complex and the activator or other charge-balancing moiety. The catalyst compound may be neutral as in a pre-catalyst, or a charged species with a counter ion as in an activated catalyst system. For the purposes of the present disclosure and the claims thereto, when catalyst systems are described as including neutral stable forms of the components, it is well understood by one of ordinary skill in the art, that the ionic form of the component is the form that reacts with the monomers to produce polymers. A polymerization catalyst system is a catalyst system that can polymerize monomers to polymer. Furthermore, catalyst compounds and activators (including support-bound activators) represented by formulae herein embrace both neutral and ionic forms of the catalyst compounds and activators.

In the description herein, the catalyst may be described as a catalyst, a catalyst precursor, a pre-catalyst compound, catalyst compound or a transition metal compound, and these terms are used interchangeably.

An “anionic ligand” is a negatively charged ligand which donates one or more pairs of electrons to a metal ion. The term “anionic donor” is used interchangeably with “anionic ligand”. Examples of anionic donors may include, but are not limited to, methyl, chloride, fluoride, alkoxide, aryloxide, alkyl, alkenyl, thiolate, carboxylate, amido, benzyl, hydrido, amidinate, amidate, and phenyl. Two anionic donors may be joined to form a dianionic group.

A “neutral Lewis base” or “neutral donor group” is an uncharged (neutral) group which donates one or more pairs of electrons to a metal ion. Non-limiting examples of neutral Lewis bases include ethers, thioethers, amines, phosphines, ethyl ether, tetrahydrofuran, dimethylsulfide, triethylamine, pyridine, alkenes, alkynes, alenes, and carbenes. Lewis bases may be joined together to form bidentate or tridentate Lewis bases.

For purposes of the present disclosure and the claims thereto, phenolate donors can include Ph-O—, Ph-S—, and Ph-N(R\hat{ })— groups, where R\hat{ } is hydrogen, C₁-C₄₀ hydrocarbyl, C₁-C₄₀ substituted hydrocarbyl, a heteroatom or a heteroatom-containing group, and Ph is optionally substituted phenyl.

### DETAILED DESCRIPTION

The present disclosure relates to alumoxanes, methods of forming alumoxanes, catalyst systems having alumoxanes, and methods of polymerizing olefins using catalyst systems having alumoxanes.

In some embodiments, a method of making an electron withdrawing group modified alumoxane includes introducing an alumoxane with an electron withdrawing group to form an alumoxane.

In some embodiments, a method of making a low trialkylaluminum alumoxane includes introducing an alumoxane with an electron-withdrawing compound to form a strong electron-withdrawing atom or group modified alumoxane. The method includes introducing a hydrocarbyl aluminum compound with an oxygen source at a temperature of about −60° C. to about 0° C. to form the alumoxane.

In some embodiments, an electron withdrawing group modified alumoxane includes an alumoxane, an electron withdrawing group-containing hydrocarbyl aluminum compound, and about 2 wt % Al or less from free or dimeric hydrocarbyl aluminum compounds, based on total aluminum content of the alumoxane composition.

In some embodiments, a catalyst system comprises a catalyst compound and an electron withdrawing group modified alumoxane. The electron withdrawing group modified alumoxane includes an alumoxane, an electron withdrawing group-containing hydrocarbyl aluminum compound, and about 2 wt % Al or less of from free or dimeric hydrocarbyl aluminum compounds, based on total aluminum content of the alumoxane composition.

In some embodiments, methods of polymerizing olefins include using catalyst systems.

It has been discovered that when an alumoxane is treated with an electron withdrawing group containing compound, an electron withdrawing group modified aluminum species can be formed and coordinated with the alumoxane, to form a more reactive aluminum species of the alumoxane which has been discovered to promote catalyst activity and catalyst lifetime. Without being bound by theory, it is believed the presence of the electron withdrawing group containing content of the treated alumoxane provides more aluminum cations associated with the alumoxane. In addition, if the ratio of strong electron withdrawing atoms to hydrocarbyl aluminum compounds is about 1:1, the amount of free hydrocarbyl aluminum compound (such as trimethylaluminum) present in a catalyst system can be reduced or eliminated, which provides reduced side reaction of oxygen-containing catalyst compounds and/or nitrogen-containing catalyst compounds with aluminum in the catalyst system. For example, the presence of strong electron withdrawing atoms (e.g., as Al(CH₃)₂F) reduces formation of the stable hydrocarbyl aluminum dimers (e.g., dimeric Al(CH₃)₃) that would otherwise form in the absence of strong electron withdrawing atoms. The presence of strong electron withdrawing atoms instead forms more active aluminum cations.

In addition, the presence of an electron withdrawing compound in the treated alumoxane likewise reduces or eliminates side reactions of oxygen-containing catalyst compounds and/or nitrogen-containing catalyst compounds, promoting improved catalyst activity and lifetime.

In addition, hydrocarbyl aluminum compounds having an electron withdrawing atom can be formed in-situ upon forming the alumoxane. In-situ formation of hydrocarbyl aluminum compounds having an electron withdrawing atoms has a number of benefits, such as no need to purchase hydrocarbyl aluminum compounds having an electron withdrawing atoms which are very expensive if available at all (e.g., no commercial method of production of AlF(CH₃)₂). Also, an electron withdrawing compound can provide multiple electron withdrawing atoms (e.g., (NH₄)₂SiF₆) to multiple available aluminum atoms, which promotes atom economy. Many such electron withdrawing compounds are commercially available and relatively inexpensive. Use of such electron withdrawing compounds reduces the cost and atom economy of forming overall catalyst systems which likewise improves cost and atom economy of polymers produced from such catalyst systems.

In addition, alumoxanes of the present disclosure can be supported or unsupported with one or more support particles (e.g., silica). Although fluorinated supports are known, it has been discovered that the fluorine atoms are not completely converted to aluminum-fluorine-type alumoxane. Instead, upon calcination of a fluorinated-support, a significant amount of HF and SiF₄ gases are formed which has been shown to be difficult to control. In contrast, alumoxanes and methods of the present disclosure do not form HF and/or SiF₄ gases due to the very strong bond strength of aluminum-fluorine atoms.

In some embodiments, the present disclosure relates to TMA free active MAO composition, methods of forming such an MAO composition, catalyst systems having TMA free active MAO, and methods of polymerizing olefins using catalyst systems having TMA free active MAO, wherein TMA free MAO means that the free TMA content in MAO is zero or near zero while the MAO active sites capable of providing AlMe₂⁺ are maintained or increased through the treatment of a so-called coordinated and free TMA equilibrium blocking agent (TEB agent). Unlike physical removal of free TMA in MAO that causes the loss of activity, the TMA free active MAO composition with maintained or improved activity is made possible, without being bound by theory, where either the fluorinated silica or the electron withdrawing compound (e.g., (NH₄)₂SiF₆), both containing Si—F units, are capable of converting free TMA in MAO to AlMe₂F, which then replaces the coordinated TMA in MAO to form the new active site that not only blocks coordinated TMA to free TMA equilibrium, but also is capable of releasing more AlMe₂⁺ for pre-catalyst ionization as well as reducing the ion-pair interaction to increase the individual active molecule activity due to the F atom electron withdrawing effect (Scheme 4):

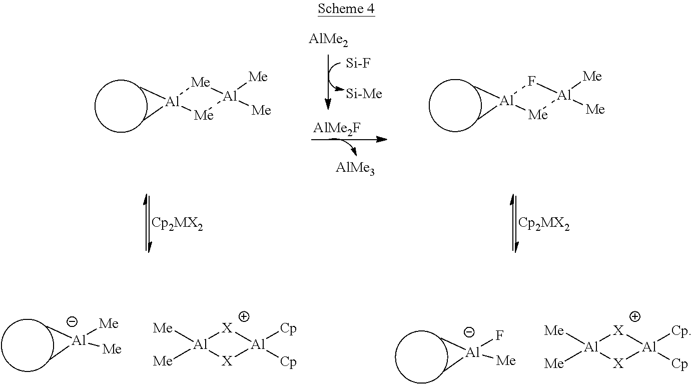

Without being bound by theory, the replacement of coordinated TMA with AlMe₂F converts the equilibrium of Scheme 1 (Scheme 5 a) to Scheme 5 b therefore efficiently blocks the free and coordinated TMA equilibrium, presumably due to the presence of the strong electron withdrawing F atom that makes breaking 1 strong Al—F bond and 1 weak Al-Me bond to form two weak Al-Me bonds not energetically plausible (Scheme 5 b). Therefore, by matching the total TMA (both free and coordinated TMA) in MAO with Si—F units, a TMA free system can be obtained.

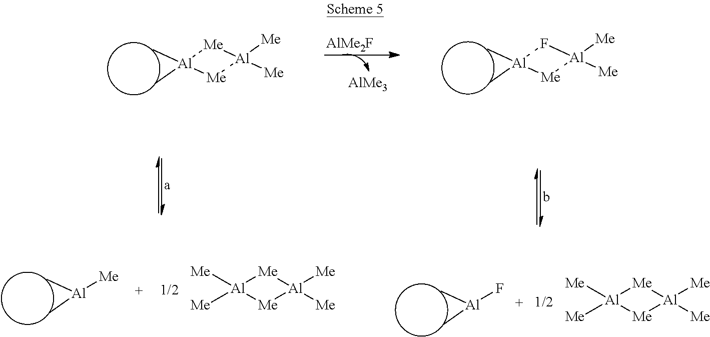

In some embodiments, a method of making a TMA free MAO includes the treatment of MAO, in a solution or a supported form, with an electron withdrawing compound capable of converting the total TMA (free and coordinated TMA) to AlMe₂F as the major derivative and an optional minor non-fluorinated inert aluminumalkyl derivative, depending on the electron withdrawing compound structure in use.

In some embodiments, a method of making a TMA free MAO composition in solution or supported form includes introducing a solution or supported MAO composition containing free TMA and coordinated TMA and an electron withdrawing compound containing at least one strong electron withdrawing atom or group X capable of converting free TMA to AlMe₂X to form a modified MAO composition with undetectable or low free TMA content. The method includes introducing a hydrocarbyl aluminum compound with an oxygen source optionally in a support at a temperature of about −60° C. to about 0° C. to form a regular MAO composition before the fluorination treatment.

In some embodiments, a TMA free MAO composition includes an electron withdrawing group modified MAO in solution form or supported form with about 8.5 mol % or less of THF extractable trihydrocarbyl aluminum compounds, based on total aluminum content of the MAO.

In some embodiments, a catalyst system comprises a catalyst compound and a TMA free MAO composition in solution or supported form, wherein the TMA free MAO composition includes an electron withdrawing group modified MAO in solution form or supported form with about 8.5 mol % or less of THF extractable trihydrocarbyl aluminum compounds, based on total aluminum content of the MAO.

In some embodiments, methods of making the TMA free supported MAO composition include the treatment of the supported MAO with an electron withdrawing compound and a trialkylaluminum, following a filtration step to remove the excess free TMA.

In some embodiments, methods of making the TMA free supported MAO composition include the treatment of the support with an electron withdrawing compound before the MAO supportation, but with the reactive fluorine atoms on the support adjusted to match the total TMA in the MAO later loaded in the support to obtain a TMA free supported MAO composition.

In some embodiments, methods of polymerizing olefins include using catalyst systems.

It has been discovered that when an MAO is treated with an electron withdrawing compound, an electron withdrawing group modified alkylaluminum species can be formed and coordinated with the MAO, to form a more reactive aluminum species of the MAO, which has been discovered to promote catalyst activity and catalyst lifetime. Without being bound by theory, it is believed the presence of the electron withdrawing group content of the treated MAO provides more aluminum cations associated with the MAO as shown in Scheme 4. In addition, if the ratio of strong electron withdrawing atoms or groups to hydrocarbyl aluminum compounds is about 1:1, the amount of free trihydrocarbyl aluminum compound (such as trimethylaluminum) present in a catalyst system can be reduced or eliminated, which therefore reduces the decomposition reactions of oxygen-containing catalyst compounds and/or nitrogen-containing catalyst compounds with the oxygen or nitrogen reactive trihydrocarbyl aluminum in the catalyst system. For example, the presence of fluorine atoms converts the most reactive primary trihydrocarbyl aluminum (e.g., dimeric form of AlMe₃) to a less active secondary dihydrocarbyl aluminum (e.g., as Al(CH₃)₂F) therefore to reduce or eliminate the formation of the primary trihydrocarbyl aluminum as the equilibrium reaction of coordinated AlMe₂F in the MAO composition shown in Scheme 5 that would otherwise form in the absence of fluorine atoms as the equilibrium reaction of coordinated TMA in regular MAO shown in Scheme 5. The presence of fluorine atoms instead forms more aluminum cations and more active ion-pair due to weaker ion-pair interaction, as shown in Scheme 4.

In addition, the presence of fluorine in the treated MAO likewise reduces or eliminates the chance of forming free TMA in the regular MAO free TMA and coordinated TMA equilibrium and thus reduces or eliminates the side reactions of oxygen-containing catalyst compounds and/or nitrogen-containing catalyst compounds, promoting improved catalyst activity and lifetime.

In addition, except that hydrocarbyl aluminum compounds having fluorine atoms can be formed in-situ from the reaction of TMA in the MAO composition with an electron withdrawing compound thus to convert the primary aluminumalkyl TMA to a secondary aluminumalkyl AlMe₂F, a secondary aluminumalkyl such as AlMe₂F can also be formed ex-situ and added to a supported MAO composition following a free TMA removal step, such as a filtration and wash step. However, adding a secondary aluminumalkyl such as AlMe₂F to a solution MAO is less preferred because of the challenging free TMA removal in the solution system.

In addition, MAO of the present disclosure can be supported or unsupported with one or more support particles (e.g., silica). Although fluorinated supports are known, it has been discovered that the support fluorination processes, e.g., those described in WO 2000/12565, generate equipment corrosive HF and SiF₄ gases as well as are difficult to obtain an accurate fluorine loading due to uncontrollable F loss. In contrast, MAO and methods of the present disclosure do not form HF and/or SiF₄ gases due to the very strong bond strength of aluminum-strong electron withdrawing atoms or groups therefore the fluorine loading can be more accurately controlled.

### Unsupported Alumoxanes and Supported Alumoxanes

Alumoxanes are oligomeric compounds containing —Al(R)—O— or —Al(R)₂—O— subunits, where R is an alkyl group, typically a C₁ to C₁₂ alkyl group, such as the inactive MAO gel shown in Scheme 1. Examples of useful alumoxanes include methylalumoxane (MAO), modified methylalumoxane (MMAO), ethylalumoxane, triethylalumoxane, triisobutylalumoxane, tetraethyldialumoxane, and di-isobutylalumoxane.

Unsupported MAO may refer to either solution MAO, such as the commercial MAO solution products produced by W. R. Grace, Tosoh, or Nouryon, or solid MAO, such as the one produced by Tosoh. Unsupported solid MAO can be prepared through the removal of the solvent of a solution MAO product, and form-controlled particle sizes with different solid formation methods, e.g., spray-drying.

There are a variety of methods for preparing MAO and modified MAO, such as the methods described in U.S. Pat. No. 4,542,199 and Chen and Marks, 100 Chem. Rev. 1391 (2000). MAO can also be modified for different purposes, e.g., increasing activity, solubility. Examples of useful MAO include MAO from TMA with an oxygenate (e.g., W. R. Grace MAO from TMA with water, or Nouryon PMAO from TMA with an organic oxygen source, or Tosoh solid MAO), higher alkyl modified MAO (e.g., Nouryon MMAO), carbocation agent modified MAO (U.S. Pat. No. 9,090,720), dialkylaluminum cation precursor agent modified MAO (U.S. Pat. No. 8,575,284), halogen modified MAO (U.S. Pat. No. 7,355,058), etc.

Active MAO is formed from the contact of largely excess TMA with an oxygen source (such as water, metal salt coordinated water, CO₂, methylacylic acid, benzoic acid, or other reactive oxygen containing organics) under suitable reaction conditions.

Active MAO of the present disclosure can be obtained commercially or synthesized. Active MAO of the present disclosure can be prepared in-situ by contacting the hydrocarbyl aluminum compound with an oxygen source, e.g., TMA with water in an aliphatic or aromatic diluent, at a temperature of less than 0° C. to −60° C., such as −10° C. to −50° C., such as −15° C. to −30° C.

Supported MAO of the present disclosure can be prepared by conventional methods such as bringing into contact of a pre-formed MAO solution with a support (e.g., silica). For example, the solution MAO can be added to a solid support or a support slurry or a reverse addition following by optional heating to form the supported MAO. Supported MAO of the present disclosure can also be prepared in-situ by contacting the hydrocarbyl aluminum compound with an oxygen source loaded in a support. For example, water pre-loaded in a support material (e.g., silica) in slurry form in an aliphatic or aromatic diluent or in solid form with optional cooling can be added to a TMA solution cooled to a temperature of less than 0° C. to −60° C., such as −10° C. to −50° C., such as −15° C. to −30° C. following a heating process as described in U.S. Pat. No. 11,161,922; or a non-hydrolytic organic oxygenate can be mixed with TMA under cooling, e.g., at a temperature of less than 0° C. to −60° C., such as −10° C. to −50° C., such as −15° C. to −30° C. to form a pre-MAO composition and then mix a support (e.g., silica) following by a heating process to obtain the supported MAO as described in U.S. Pat. No. 11,021,552.

For solution MAO supportation, suitable diluents for forming a support slurry, e.g., silica slurry, are capable of dissolving MAO to ensure a good MAO distribution inside the pores of the support, such as diluents such as toluene, benzene, or xylenes. For in-situ supported MAO, suitable diluents are materials in which the reactants, e.g., the hydrocarbyl aluminum such as TMA, the non-hydrolytic organic oxygenate, and the derivatives of the two reagents, are at least partially soluble and which are liquid at reaction temperatures. Non-limiting example diluents are non-cyclic alkanes with formula CₙH₍₂ₙ₊₂₎ where n=4 to 30, such as isobutene, butane, isopentane, hexane, n-heptane, octane, nonane, decane and the like, cycloalkanes with formula CₙH₂ₙ₋₂ where n=5 to 30, such as cyclopentane, methylcyclopentane, cyclohexane, methylcyclohexane and the like, and mixtures thereof. Suitable aromatic diluents can include toluene, benzene, or xylenes.

### Hydrocarbyl Aluminum Compounds for MAO and Modified MAO

The active alumoxane composition (such as MAO) can be exclusively formed with trimethylaluminum (TMA), but other aluminumalkyl compounds can be used to modify the MAO. The hydrocarbyl aluminum compounds used for alumoxane modification can be alkylaluminum compounds such as a trialkylaluminum compound. For example, the alkyl substituents can be alkyl groups of up to 10 carbon atoms, such as octyl, isobutyl, ethyl or methyl. Thus, suitable hydrocarbyl aluminum compounds may include trimethylaluminum, triethylaluminum, tripropylalumiuum, tri-n-butylaluminum, tri-isobutyl-aluminum, tri(2-methylpentyl)aluminum, trihexylaluminum, tri-n-octylaluminum, and tri-n-decylaluminum. In some embodiments, hydrocarbyl aluminum compounds are trimethylaluminum and tri-n-octylaluminum. In some embodiments, hydrocarbyl aluminum compounds are represented by the formula R₃Al where each R is independently a hydrocarbon containing between 1 and 30 carbon atoms.

In some embodiments, the hydrocarbyl aluminum compound is one or more of trialkylaluminum mixtures, e.g., dimethylethylaluminum or methyldiethylaluminum from AlMe₃ and AlEt₃ mixture, diethylisobutylaluminum or ethyldiisobutylaluminum from AlEt₃ and AliBu₃ mixture, and the like.

### Oxygen Sources

Suitable oxygen sources are any oxygen sources in which one or more oxygen atoms is able to react with the hydrocarbyl aluminum compound to form a new Al—O bond. In at least one embodiment, the oxygen source may be or include water, such as pure water or water in a metal salt hydrate. In some embodiments, the oxygen source can be one or more hydroxy or carbonyl containing compounds for example an alcohol, CO or CO₂, an acetone, or a carboxylic acid. In at least one embodiment of the present disclosure, the oxygen source is one or more of carbon dioxide, a carboxylic acid, a ketone, an aldehyde, an ester, an anhydride, an alcohol, or combination thereof.

In at least one embodiment of the present disclosure, the oxygen source is represented by the formula R¹R²C═CR³CO₂H wherein each of R¹ and R² is independently hydrogen, alkyl, alkenyl, aryl or heteroatom containing group and R³ is alkyl, alkenyl, aryl or heteroatom containing group.

In at least one embodiment of the present disclosure, the oxygen source includes in the hydrocarbyl aluminum compound, e.g., the reaction product of TMA with an alcohol, a ketone, an ester, or an organic acid. Examples of hydrocarbyl aluminum compounds which include an oxygen source include dimethyl aluminum methoxide, dimethyl aluminum ethoxide, dimethyl aluminum isopropoxide, dimethyl aluminum n-butoxide, dimethyl aluminum isobutoxide, pentamethyldialuminum-t-butoxide, tetramethyldialuminumdi-t-butoxide, pentamethyldialuminum-i-propoxide, tetramethyldialuminumdi-i-propoxide, or the mixture of the listed compounds and the like.

The starting charging molar ratio of Al:O, where O is the active oxygen in the active oxygen containing compound, can be 100:1, 60:1, 30:1, 10:1, 1:1, or 0.9:1 to form the desired MAO compositions with or without excess free hydrocarbyl aluminum compounds. In some embodiments, the molar ratio of Al:O can be about 0.9:1 to about 100:1, such as about 1:1 to about 10:1, alternatively about 10:1 to about 60:1, such as about 30:1 to about 60:1. If undesired excess hydrocarbyl aluminum compound(s) is (are) present, it (they) can be removed, for example, by filtration and then washed with an aliphatic diluent and/or treated with fluorine compound(s) of the present disclosure.

In some embodiments, the oxygen source is one or more of carbon dioxide, a carboxylic acid, an ester, an anhydride, an alcohol or combination thereof.

In some embodiments, the oxygen source is one or more of carbon dioxide, a carboxylic acid, an ester, an anhydride and an alcohol or combination thereof, optionally containing water.

In some embodiments, the oxygen source is R¹R²C═CR³CO₂H wherein each of R¹ and R² is independently hydrogen, alkyl, alkenyl, aryl or heteroatom containing group and R³ is alkyl, alkenyl, aryl or heteroatom containing group.

In some embodiments, the oxygen source is methacrylic acid.

In at least one embodiment of the present disclosure, the oxygen source is a hydrocarbylboroxine as described in Welborn, U.S. Pat. No. 5,001,244.

### Electron Withdrawing Compounds and Processes for Introducing Electron Withdrawing Compounds to Alumoxane

TMA can react with hydrolytic compounds such as an alcohol ROH to rapidly form AlMe₍₃₋ₙ₎(OR)ₙ (n≤3) with n and the OR position depending on the ROH reactivity, steric hindrance, and the reaction conditions. Small R groups, e.g., MeOH, EtOH, and ^{t}BuOH are MAO poison because, without being bound by theory, the small R groups convert both the free and coordinated TMA to form very stable oxygen bridging structures and the RO— group is a strong electron donating group that destabilizes the MAO anion (Scheme 6):

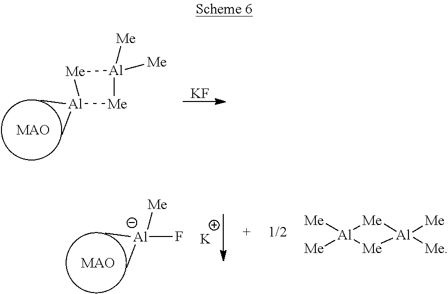

Sterically hindered alcohols such as 3,5-di-t-butyl-4-hydroxytoluene (BHT) form terminal OR groups but may need largely excess for near TMA free system, without being bound by theory, due to the equilibrium in Scheme 7:

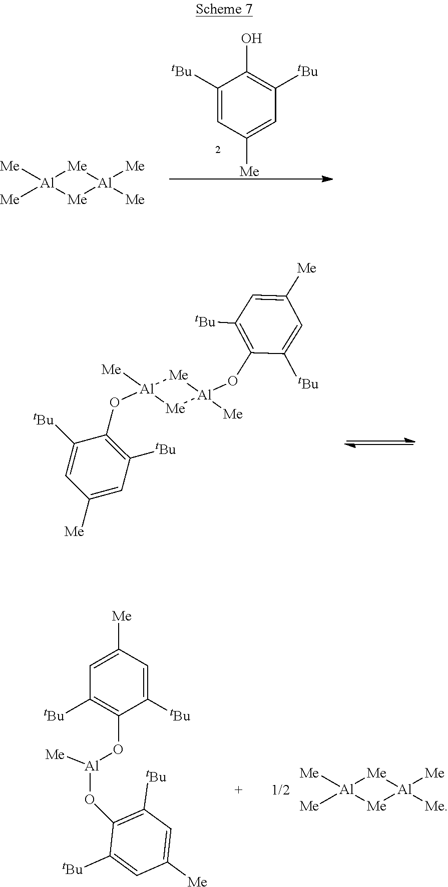

For example, Ijpeij et al., U.S. Pat. No. 7,956,140 uses BHT:Al from 0.5:1 to 2 ratio for MAO treatment to provide the activation of CGC catalyst precursors containing nitrogen donor ligands. Such a system may have a large amount of neutral BHT in the system that is not desired in some end products since MAO is usually used in a largely excess amount to ensure efficient activation and the amount of the coordinated TMA (the active site) may also decrease due to the coordinated TMA to free TMA equilibrium (Scheme 1).

As the Schemes 4 and 5 indicate, compounds containing reactive strong electron withdrawing atom(s) or group(s), e.g., the Si—F moiety containing compounds such as a fluorinated silica support and the silica fluorination agent (NH₄)₂SiF₆, have been found to be capable of converting the free TMA in MAO to AlMe₂F that can serve as a coordinated and free TMA equilibrium blocking agent (TEB agent). The TEB agent can then replace the coordinated TMA (which becomes free TMA) therefore to eliminate the coordinated TMA to free TMA equilibrium as well as to provide more AlMe₂⁺ for pre-catalyst ionization and more dispersed MAO anion charge to weaken the active ion-pair interaction due to the introduction of the strong electron withdrawing atoms on the MAO anions as shown in Scheme 4, therefore, to increase the system's activity. The total TMA in MAO to TEB agent conversion is therefore a much more efficient method to remove the free TMA in MAO while maintaining or improving the activation efficiency to obtain a system that is suitable to activate pre-catalysts built with ligands containing TMA reactive hetero-atom donors, e.g., N, O, S, and/or P donors in the ligands for post-metallocene and CGC half-metallocene pre-catalysts.

In some embodiments, the electron withdrawing compound is an inorganic compound having the Formula (I):

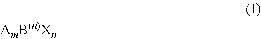

where A is an ammonium cation; m=0, 1, or 2, provided that when m=0, B is H, a group 3, 4, 5, 6, 7, 13, 14, 15, 16, or 17 element, and when m is not zero, B is a group 3, 4, 5, 13, 14, or 15 element; u is the valence state of element B and can be 1, 2, 3, or 4; X is an electron withdrawing atom or group; n=m+u.

In some embodiments, the inorganic fluorine containing compound having the Formula (I) is selected from NH₄BF₄, (NH₄)₂SiF₆, NH₄PF₆, NH₄F, (NH₄)₂TaF₇, NH₄NbF₄, (NH₄)₂GeF₆, (NH₄)₂SmF₆, (NH₄)₂TiF₆, (NH₄)₂ZrF₆, MoF₆, ReF₆, GaF₃, SO₂ClF, F₂, SiF₄, SF₆, ClF₃, ClF₅, BrF₅, IF₇, NF₃, HF, BF₃, B(OC₆F₅)₃, AlF₃, Al(OC₆F₅)₃, NHF₂ and NH₄HF₂. Of these, ammonium hexafluorosilicate may be preferred due to its high F efficiency.

In some embodiments, the electron withdrawing compound is an organic compound having the Formula (II):

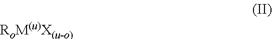

where R is a C₁ to C₁₀ hydrocarbyl group; M is a group 13 or 14 element; o=1 for M=group 13 element; o=2 for M=non-Al group 13 element; and o=1, 2, or 3, for M=group 14 element; and X is an electron withdrawing atom or group; u is the valence state of element M.

In some embodiments, the organic fluorine compound having the Formula (II) is selected from Me₃SiF, Me₂SiF₂, MeSiF₃, Et₃SiF, Et₂SiF₂, EtSiF₃, Ph₃SiF, Ph₂SiF₂, PhSiF₃, Me₃CF, Me₂CF₂, MeCF₃, Et₃CF, Et₂CF₂, EtCF₃, Ph₃CF, Ph₂CF₂, PhCF₃, Me₂BF, MeBF₂, MeAlF₂, Et₂BF, EtBF₂, EtAlF₂, Ph₂BF, PhBF₂, Me₃Si(OC₆F₅), Me₂Si(OC₆F₅)₂, MeSi(OC₆F₅)₃, Me₃C(OC₆F₅), Ph₃C(OC₆F₅), Me₂B(OC₆F₅), MeB(OC₆F₅)₂, MeAl(OC₆F₅)₂.

Formation of Coordinated and Free Hydrocarbyl Aluminum Equilibrium Blocking Agent (TEB Agent) and its Use to Obtain Solution, Solid, or Supported Alumoxane with Undetectable Free Trihydrocarbyl Aluminum

In some embodiments, for a solution, solid, or supported alumoxane (e.g., MAO) composition, the TEB agent has a formula AlR₂X (R=C₁ to C₈ hydrocarbyl group and X is an electron withdrawing group), which is formed in-situ by the treatment of the MAO composition with an electron withdrawing inorganic or organic compound. The amount of the electron withdrawing compound relative to trihydrocarbyl aluminum compound (e.g., TMA) in MAO can be controlled such that after the TEB agent forms and replaces the coordinated trihydrocarbyl aluminum compound (e.g., coordinated TMA) in MAO, resulting in little or no free trihydrocarbyl aluminum compound (or dimer thereof) remained. For example, in some embodiments, a ratio of the active strong electron withdrawing atom (e.g., F) or group (e.g., C₆F₅O—) number of the strong electron withdrawing compound to hydrocarbyl aluminum compound is about 1.5:1 to about 1:1.5, such as about 1.3:1 to about 1:1.3, such as about 1.2:1 to about 1:1.2, such as about 1.1:1 to about 1:1.1, such as about 1.05:1 to about 1:1.05. In some embodiments, the ratio is a molar ratio or alternatively is based on the number of the strong electron withdrawing atoms or groups in the strong electron withdrawing compound relative to moles of the hydrocarbyl aluminum compound, e.g., (NH₄)SiF₆ to Al(CH₃)₃ would be a 8:1 molar ratio but a 6:6 ratio (i.e., 1:1 ratio) based on the number of fluorine atoms in the strong electron withdrawing compound relative to moles of the hydrocarbyl aluminum compound, plus a 2:2 ratio (i.e., 1:1 ratio) of TMA to TMA reactive NH₄⁺ that forms an inert compound presumably with a formula of (Al₃Me₃N₃H₃)₂.

In some embodiments, the amount of free trihydrocarbyl aluminum compound (or dimer thereof) is determined after formation of the solution, solid, or supported MAO composition. For example, a sample of unsupported MAO or supported MAO produced or obtained commercially can be treated with tetrahydrofuran (THF) to convert both free or coordinated TMA in MAO to a TMA-THF adduct, THF-MAO-adducts, as well as an AlMe₂⁺-THF₂ adduct as shown in Scheme 8:

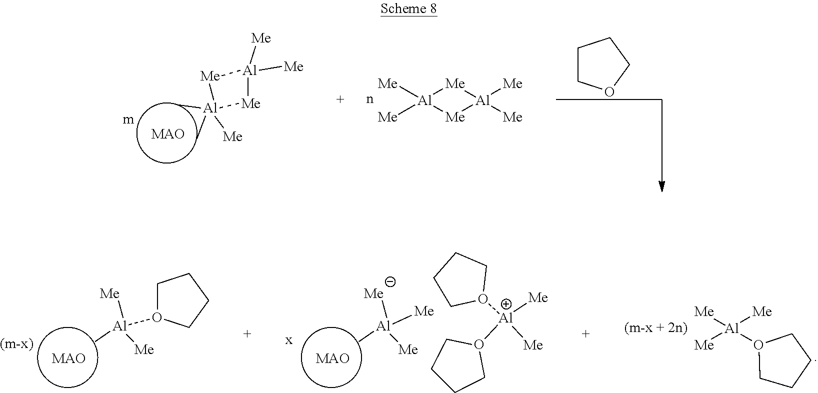

The relative amount of each adduct can be determined by nuclear magnetic resonance (NMR) spectroscopy. Once the total amount of free and coordinated hydrocarbyl aluminum compound is determined, an amount of the strong electron withdrawing compound can be introduced to the MAO based on a predetermined ratio of the electron withdrawing group of the strong electron withdrawing to the free hydrocarbyl aluminum in MAO. For example, in some embodiments, a ratio of the strong electron withdrawing atoms or groups in the strong electron withdrawing compound to total trihydrocarbyl aluminum compound in MAO is about 1.5:1 to about 1:1.5, such as about 1.3:1 to about 1:1.3, such as about 1.2:1 to about 1:1.2, such as about 1.1:1 to about 1:1.1, such as about 1.05:1 to about 1:1.05. In some embodiments, the ratio is a molar ratio or alternatively is based on the number of strong electron withdrawing atoms or groups in the strong electron withdrawing compound relative to moles of the trihydrocarbyl aluminum compound (e.g., (NH₄)₂SiF₆ to Al(CH₃)₃ would be a 8:1 molar ratio but a 6:6 ratio based on the number of fluorine atoms in the strong electron withdrawing compound relative to moles of the trihydrocarbyl aluminum compound, plus a 2:2 ratio of TMA to TMA reactive NH₄⁺ that forms an inert compound presumably with a formula of (Al₃Me₃N₃H₃)₂). Determining an amount of free hydrocarbyl aluminum compound (or dimer thereof) after formation of MAO further improves atom economy because less fluorine compound can be used as compared to a process where an amount of fluorine compound is used relative to the amount of overall hydrocarbyl aluminum compound used to form the MAO.

The TEB agent formation reaction (of electron withdrawing compound with free hydrocarbyl aluminum compound (or dimer thereof)) can proceed at any suitable temperature, such as about 0° C. to about 100° C., such as about 10° C. to about 30° C., such as about 20° C., such as ambient temperature. The reaction can proceed neat (e.g., solid-solid) or can proceed using any suitable diluent. In some embodiments, a diluent can be an organic diluent, such as an aliphatic diluent or an aromatic diluent. Aliphatic diluent can be non-cyclic alkanes with formula CₙH₍₂ₙ₊₂₎ where n=4 to 30, such as isobutane, butane, isopentane, hexane, n-heptane, octane, nonane, or decane, cycloalkanes with formula CₙH₂ₙ₋₂ where n=5 to 30, such as cyclopentane, methylcyclopentane, cyclohexane, methylcyclohexane and the like, and mixtures thereof. Aromatic diluent may include benzene, toluene, or xylenes.

After treatment with an electron withdrawing compound, an MAO (unsupported or supported) can have an amount of Al from free hydrocarbyl aluminum compound of about 2 wt % or less, such as about 1.5 wt % or less, such as about 1 wt % or less, such as about 0.5 wt % or less, such as about 0.25 wt % or less, such as about 0.1 wt % to about 2 wt %, such as about 0.1 wt % to about 1.5 wt %, such as about 0.2 wt % to about 1 wt %, such as about 0.3 wt % to about 0.7 wt %, based on total aluminum content of the MAO.

In some embodiments, for a solid or supported MAO composition, the TEB agent is formed before adding to the solid or supported MAO composition, following a free TMA removal step, e.g., a filtration or decant step to remove free TMA without the requirement of TMA quantification based on the chemistry of Scheme 9 below:

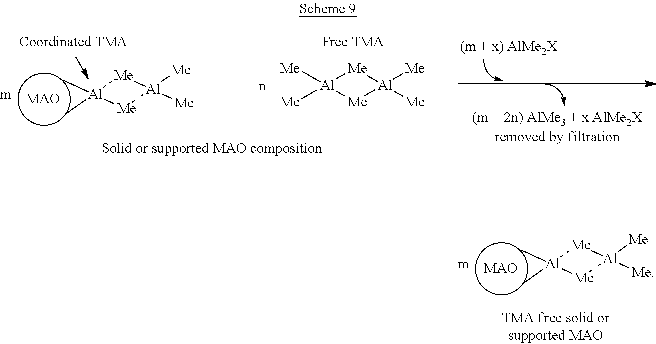

Preparation methods for pre-formed TEB agents include but not limited to:
1) bringing into contact of AlR₃, where R is a C₁ to C₈ hydrocarbyl group or the mixture there of, such as Me, Et, ⁱBu, Oct, and preferably the Me group, with a strong electron withdrawing compound, to form in-situ the AlR₂X compound as the major product.
2) bringing into contact of AlR₂Y, where R is defined in 1) and Y is a non-fluorine halide such as Cl, Br, or I, with an electron withdrawing salt with the Formula (III):

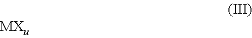

where M is a group 1 or 2 metal; X is the electron withdrawing group as defined in the Strong Electron Withdrawing Compound section; and u is the metal M valence state. The reaction stoichiometry is shown in Scheme 10:

$${AlR}_{2} Y + 1 / {uMX}_{u} = {AlR}_{2} X + 1 / {uMY}_{u} \qquad Scheme 10$$

where MYᵤ can be removed as a solid waste, such as removal by filtration.

In some embodiments, AlR₂Y is selected from AlMe₂Cl, AlMe₂Br, AlMe₂I, AlEt₂Cl, AlEt₂Br, AlEt₂I, AlⁱBu₂Cl, AlⁱBu₂Br, AlⁱBu₂I, AlOct₂Cl, AlOct₂Br, AlOct₂I, AlMe₂CN, AlEt₂CN, AlⁱBu₂CN, AlOct₂CN, and the like; and MXᵤ is selected from LiF, NaF, KF, MgF₂, CaF₂, BaF₂, LiOC₆F₅, NaOC₆F₅, KOC₆F₅, Mg(OC₆F₅)₂, Ca(OC₆F₅)₂, Ba(OC₆F₅)₂, and the like. It should be understood that ClMgOC₆F₅ and the like may also be used, e.g., AlMe₂Cl+ClMgOC₆F₅ to form AlMe₂OC₆F₅+MgCl₂. An MgCl₂ agglomerator such as dioxolane can be used to oligomerize MgCl₂ for better solid separation form the desired AlMe₂F or AlMe₂OC₆F₅ product.

### Optional Support Materials and the Derived Trihydrocarbyl Aluminum-Free Supported Alumoxanes

In embodiments herein, the catalyst system may include a support material. For example, a support material can be contacted with a pre-formed solution alumoxane, e.g., a commercial solution MAO, to form the supported MAO, followed by contacting the supported MAO with a strong electron withdrawing compound to form the TEB agent in-situ or a pre-formed TEB agent of the present disclosure. Alternatively, a support material can be contacted with TMA free MAO of the present disclosure to form a supported activator followed by contacting the supported activator with a pre-catalyst compound. Alternatively, a pre-catalyst compound is contacted with a TMA free MAO to form a solution catalyst system followed by contacting the catalyst system with a support material to form a supported catalyst system. Alternatively, a supported material can be loaded with an oxygen source, e.g., water, followed by adding the oxygen source loaded support, in a solid form or slurry for, with or without cooling, to a cold TMA solution with optional heating to form the supported MAO composition, and then followed by the treatment of either an in-situ formed TEB agent through contacting the supported MAO with a strong electron withdrawing compound with optional AlR₃ and optional filtration/wash step or a pre-formed TEB agent with necessary filtration/wash step to form the TMA free supported MAO before contacting a pre-catalyst to form the finished catalyst.

The support material can be a porous support material, for example, talc, and inorganic oxides. Other support materials include zeolites, clays, organoclays, or another organic or inorganic support material, or mixtures thereof.

The support material can be an inorganic oxide. The inorganic oxide can be in a finely divided form. Suitable inorganic oxide materials for use in catalyst systems herein may include groups 2, 4, 13, and 14 metal oxides, such as silica, alumina, and mixtures thereof. Other inorganic oxides that may be employed either alone or in combination with the silica, or alumina can be magnesia, titania, zirconia. Other suitable support materials, however, can be employed, for example, finely divided functionalized polyolefins, such as finely divided polyethylene. Examples of suitable supports may include magnesia, titania, zirconia, montmorillonite, phyllosilicate, zeolites, talc, clays. Also, combinations of these support materials may be used, for example, silica-chromium, silica-alumina, silica-titania. In at least one embodiment, the support material is selected from Al₂O₃, ZrO₂, SiO₂, SiO₂/Al₂O₃, SiO₂/TiO₂, silica clay, silicon oxide/clay, or mixtures thereof.

The support material, such as an inorganic oxide, can have a surface area of about 10 m²/g to about 800 m²/g, pore volume of about 0.1 cm³/g to about 4.0 cm³/g and average particle size of about 3 m to about 300 m. The surface area of the support material can be of about 50 m²/g to about 500 m²/g, pore volume of about 0.5 cm³/g to about 3.5 cm³/g and average particle size of about 10 m to about 200 m. For example, the surface area of the support material can be about 100 m²/g to about 400 m²/g, pore volume of about 0.8 cm³/g to about 3.0 cm³/g and average particle size can be about 5 m to about 100 m. The average pore size of the support material useful in the present disclosure can be of about 50 Å to about 1000 Å, such as about 60 Å to about 500 Å, and such as about 75 Å to about 350 Å. In at least one embodiment, the support material is a high surface area, amorphous silica (surface area=300 m²/gm; pore volume of 1.65 cm³/gm). For example, suitable silicas can be the silicas marketed under the tradenames of DAVISON™ 952 or DAVISON™ 955 (Davison Chemical Division of W.R. Grace and Company). In other embodiments, DAVISON™ 948 is used. Alternatively, a silica can be ES-70, ES70X, ES757, PD17062, PD16042, PD16043, or PD14024 silica (Ecovyst, formerly PQ Corporation, Malvern, Pennsylvania), DM L403, DM-L303, D60-120A, D150-60A (AGC Chemicals Company, Japan), CARiACT G-10, P-10, P-6, or Q-10 silica (Fuji Silysia Chemical LTD), Sipernat 310, or Sipernat 50 (Evonik) that has been calcined, for example, at 200° C., 400° C., 600° C., or 875° C.

The support material should be dry, that is, free or substantially free of absorbed water for pre-formed MAO supportation but can be uncalcined for in-situ MAO supportation when water is used as the oxygen source. Drying of the support material can be affected by heating or calcining at about 100° C. to about 1000° C., such as at least about 600° C. When the support material is silica, it is heated to at least 200° C., such as about 200° C. to about 850° C., and such as at about 600° C.; and for a time of about 30 minutes to about 100 hours, about 4 hours to about 72 hours, or about 24 hours to about 60 hours. The calcined support material must have at least some reactive hydroxyl (OH) groups to produce supported catalyst systems of the present disclosure. The calcined support material is then contacted with at least one polymerization catalyst including at least one catalyst compound and an activator.

The support material, having reactive surface groups, such as hydroxyl groups, is slurried in a non-polar diluent and the resulting slurry is contacted with a pre-catalyst compound in solid form or solution form and MAO in any sequence when with a pre-formed TMA free MAO and with preformed regular MAO first and then with a pre-catalyst compound after the supported MAO is treated with an in-situ formed TEB agent or a pre-formed TEB agent and other necessary steps to obtain the TMA free supported MAO. In at least one embodiment, the slurry of the support material is first contacted with the activator (e.g., TMA free MAO) for a period of time of about 0.5 hour to about 24 hours, about 2 hours to about 16 hours, or about 4 hours to about 8 hours. The solution or solid form of the pre-catalyst compound is then contacted with the supported activator. In at least one embodiment, the supported catalyst system is generated in-situ. In alternate embodiments, the slurry of the TMA free supported MAO is first contacted with the pre-catalyst compound for a period of time of about 0.5 hour to about 24 hours, about 1 hour to about 16 hours, or about 2 hours to about 8 hours.

The mixture of the catalyst(s), activator(s) and support is heated about 0° C. to about 70° C., such as about 23° C. to about 60° C., such as at room temperature. Contact times can be about 0.5 hour to about 24 hours, such as about 2 hours to about 16 hours, or about 4 hours to about 8 hours.

Suitable non-polar diluents are materials in which all of the reactants used herein, e.g., the activator and the pre-catalyst compound, are at least partially soluble and which are liquid at polymerization temperatures. Non-polar diluents for in-situ MAO supportation can be alkanes, such as isopentane, hexane, isohexane, n-heptane, octane, nonane, and decane, although a variety of other materials including cycloalkanes, such as cyclohexane, aromatics, such as benzene, toluene, and ethylbenzene, may also be employed, whereas for pre-formed MAO supportation, aromatics, such as benzene, toluene, and ethylbenzene, can be used.

In at least one embodiment, the supported activator is a supported TMA free MAO (TF-MAO), which is a silica (e.g., ES70 silica calcined at 400° C.) supported MAO with undetectable or low free TMA after the total TMA in MAO is partially or completely converted to a TEB agent to form a coordinated TEB agent on the main MAO structure with an optional step of free TMA removal.

### Catalyst System Formation

Embodiments of the present disclosure include methods for preparing a catalyst system including contacting in an organic diluent the unsupported MAO (TMA free solution) or supported MAO (TMA free support) with at least one pre-catalyst compound having a Group 3 through Group 12 metal atom or lanthanide metal atom. Alternatively, a TMA free solution MAO is first brought into contact with at least one pre-catalyst compound before contacting the support.

In at least one embodiment, the unsupported MAO or supported MAO is heated prior to contact with the catalyst compound.

The unsupported MAO or supported MAO can be solvated or slurried in an organic diluent and the resulting mixture is contacted with a solution of at least one catalyst compound. The catalyst compound can also be added as a solid to the mixture of the organic diluent and the MAO. In at least one embodiment, the mixture of the MAO is contacted with the catalyst compound for a period of time of about 0.02 hours to about 24 hours, such as about 0.1 hour to about 1 hour, about 0.2 hours to about 0.6 hours, about 2 hours to about 16 hours, or about 4 hours to about 8 hours.

The mixture of the catalyst compound and the MAO may be heated to a temperature of about 0° C. to about 70° C., such as about 23° C. to about 60° C., for example room temperature. Contact times may be about 0.02 hours to about 24 hours, such as about 0.1 hours to about 1 hour, about 0.2 hours to about 0.6 hours, about 2 hours to about 16 hours, or about 4 hours to about 8 hours.

Suitable organic diluents are materials in which some or all of the reactants used herein, e.g., the MAO and the catalyst compound, are at least partially soluble (or in the case of the solid support, suspended) and which are liquid at reaction temperatures. Non-limiting example diluents are non-cyclic alkanes with formula CₙH₍₂ₙ₊₂₎ where n is 4 to 30, such as isobutane, butane, isopentane, hexane, n-heptane, octane, nonane, decane and the like, and cycloalkanes with formula CₙH₍₂ₙ₋₂₎ where n is 5 to 30, such as cyclopentane, methylcyclopentane, cyclohexane, methylcyclohexane and mixtures thereof. Aromatic diluent can include benzene, toluene, or xylenes.

The diluent can be charged into a reactor, followed by an MAO. Catalyst can then be charged into the reactor, such as a solution of catalyst in an organic diluent or as a solid. The mixture can be stirred at a temperature, such as room temperature. Additional diluent may be added to the mixture to form a mixture having a desired consistency, such as a slurry having from about 2 cc/g of silica to about 20 cc/g silica, such as about 4 cc/g. The diluent can then be removed. Removing diluent dries the mixture and may be performed under a vacuum atmosphere, purged with inert atmosphere, heating of the mixture, or combinations thereof. For heating of the mixture, any suitable temperature can be used that evaporates the aliphatic diluent. It is to be understood that reduced pressure under vacuum will lower the boiling point of the aliphatic diluent depending on the pressure of the reactor. Diluent removal temperatures can be about 10° C. to about 200° C., such as about 60° C. to about 140° C., such as about 60° C. to about 120° C., for example about 80° C. or less, such as about 70° C. or less. In at least one embodiment, removing diluent includes applying heat, applying vacuum, and applying nitrogen purged from bottom of the vessel by bubbling nitrogen through the mixture. The mixture is dried.

### Pre-Catalyst Compounds

The terms “catalyst”, “catalyst compound”, “catalyst complex”, “transition metal complex”, “transition metal compound”, “precatalyst compound”, and “precatalyst complex” are used interchangeably to describe a transition metal or lanthanide metal complex that forms an olefin polymerization catalyst when combined with a suitable activator.

In at least one embodiment, the present disclosure provides a catalyst system comprising a catalyst compound having a metal atom. The catalyst compound can be a metallocene catalyst compound. The metal can be a Group 3 through Group 12 metal atom, such as Group 3 through Group 10 metal atoms, or lanthanide Group atoms. The catalyst compound having a Group 3 through Group 12 metal atom can be monodentate or multidentate, such as bidentate, tridentate, or tetradentate, where a heteroatom of the catalyst, such as phosphorous, oxygen, nitrogen, or sulfur is chelated to the metal atom of the catalyst. Non-limiting examples include bis(phenolate)s. In at least one embodiment, the Group 3 through Group 12 metal atom is selected from Group 5, Group 6, Group 8, or Group 10 metal atoms. In at least one embodiment, a Group 3 through Group 10 metal atom is selected from Cr, Sc, Ti, Zr, Hf, V, Nb, Ta, Mn, Re, Fe, Ru, Os, Co, Rh, Ir, and Ni. In at least one embodiment, a metal atom is selected from Groups 4, 5, and 6 metal atoms. In at least one embodiment, a metal atom is a Group 4 metal atom selected from Ti, Zr, or Hf. The oxidation state of the metal atom can range from 0 to +7, for example +1, +2, +3, +4, or +5, for example +2, +3 or +4.

A catalyst compound of the present disclosure can be a chromium or chromium-based catalyst. Chromium-based catalysts include chromium oxide (CrO₃) and silylchromate catalysts. Chromium catalysts have been the subject of much development in the area of continuous fluidized-bed gas-phase polymerization for the production of polyethylene polymers. Such catalysts and polymerization processes have been described, for example, in U.S. Patent Application Publication No. 2011/0010938 and U.S. Pat. Nos. 7,915,357, 8,129,484, 7,202,313, 6,833,417, 6,841,630, 6,989,344, 7,504,463, 7,563,851, 8,420,754, and 8,101,691.

Mono-Cp catalyst precursor compounds useful in the present disclosure have one cyclopentadienyl (Cp) ligand (which includes ligands that are isolobal to cyclopentadienyl) and at least one polar atom in at least one non-Cp ligand, bridging or unbridging to the Cp ligand, directly bonded to the pre-catalyst metal center.

In at least one embodiment, the mono-Cp pre-catalyst compound of the present disclosure is represented by formula (MC-I):

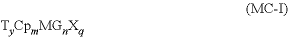

where Cp is independently a substituted or unsubstituted cyclopentadienyl ligand or substituted or unsubstituted ligand isolobal to cyclopentadienyl such as indenyl, fluorenyl, tetrahydro-s-indacenyl and tetrahydro-as-indecenyl. M is a group 4 transition metal, such as Hf, Ti, or Zr. G is a heteroatom group represented by the formula JR*_{z} where J is N, P, O or S, and R* is a linear, branched, or cyclic C₁-C₂₀ hydrocarbyl. z is 1 or 2. T is a bridging group. y is 0 or 1. X is a leaving group. m=1, n=1, 2 or 3, q=0, 1, 2 or 3, and the sum of m+n+q is equal to the oxidation state of the transition metal, such as 2, 3 or 4, such as 4.

In at least one embodiment, J is N, and R* is methyl, ethyl, propyl, butyl, pentyl, hexyl, heptyl, octyl, nonyl, cyclooctyl, cyclododecyl, decyl, undecyl, dodecyl, adamantyl or an isomer thereof. Exemplary JR*_{z} groups include t-butyl amido and cyclododecylamido.

Examples of the bridging group T include CH₂, CH₂CH₂, SiMe₂, SiPh₂, SiMePh, Si(CH₂)₃, Si(CH₂)₄, O, S, NPh, PPh, NMe, PMe, NEt, NPr, NBu, PEt, PPr, Me₂SiOSiMe₂, and PBu. In at least one embodiment, T is represented by the formula ER^{d2} or (ER^{d2})₂, where E is C, Si, or Ge, and each R^{d} is, independently, hydrogen, halogen, C₁ to C₂₀ hydrocarbyl (such as methyl, ethyl, propyl, butyl, pentyl, hexyl, heptyl, octyl, nonyl, decyl, undecyl, or dodecyl) or a C₁ to C₂₀ substituted hydrocarbyl, or two R^{d} can form a cyclic structure including aromatic, partially saturated, or saturated cyclic or fused ring system.

Each X is independently selected from the group consisting of hydrocarbyl radicals having from 1 to 20 carbon atoms, aryls, hydrides, amides, alkoxides, sulfides, phosphides, halides, dienes, amines, phosphines, ethers, and a combination thereof, (two Xs may form a part of a fused ring or a ring system), such as each X is independently selected from halides, aryls and C₁ to C₅ alkyl groups, such as each X is a phenyl, methyl, ethyl, propyl, butyl, pentyl, or chloro group.

In at least one embodiment, the mono-Cp catalyst precursor compound of formula (MC-I) is selected from: dimethylsilandiyl (2,3,4,5-tetramethylcyclopentadienyl)(cyclododecylamido)M(R)₂; dimethylsilandiyl (2,3,4,5-tetramethylcyclopentadienyl)(cycloundecylamido)M(R)₂; dimethylsilandiyl (2,3,4,5-tetramethylcyclopentadienyl)(cyclodecylamido)M(R)₂; dimethylsilandiyl (2,3,4,5-tetramethylcyclopentadienyl)(t-butylamido)M(R)₂; dimethylsilandiyl (cyclopentadienyl)(1-adamantylamido)M(R)₂; dimethylsilandiyl (3-tertbutylcyclopentadienyl)(1-adamantylamido)M(R)₂; dimethylsilandiyl (tetramethylcyclopentadienyl)(1-adamantylamido)M(R)₂; dimethylsilandiyl (tetramethylcyclopentadienyl)(1-adamantylamido)M(R)₂; dimethylsilandiyl (tetramethylcyclopentadienyl)(1-adamantylamido)M(R)₂; dimethylsilandiyl (tetramethylcyclopentadienyl)(1-tertbutylamido)M(R)₂; dimethylsilandiyl (fluorenyl)(1-tertbutylamido)M(R)₂; dimethylsilandiyl (tetramethylcyclopentadienyl)(1-cyclododecylamido)M(R)₂; μ-(C₆H)₂C(tetramethylcyclopentadienyl)(1-cyclododecylamido)M(R)₂; dimethylsilandiyl (η⁵-2,6,6-trimethyl-1,5,6,7-tetrahydro-s-indacen-1-yl)(tertbutylamido)M(R)₂; where M is selected from Ti, Zr, and Hf; and each R is selected from halogen or C₁ to C₅ alkyl (such as chloro, bromo, methyl, ethyl, propyl, butyl, pentyl or isomers thereof). In at least one embodiment, M is Ti and each R is methyl.

Mono-Cp pre-catalyst compounds of the present disclosure may be synthesized as described in U.S. Pat. Nos. 5,621,126 and 5,547,675 which are incorporated herein by reference.

The mono-Cp pre-catalyst compounds can also include compounds having the structure represented by formula (MC-II) preferably having C₈ or pseudo-C₈ symmetry:

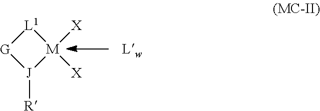

wherein:
M is zirconium;
L¹ is a unsubstituted fluorenyl, heterocyclopentapentalenyl, or heterofluorenyl, or a substituted fluorenyl, heterocyclopentapentalenyl, or heterofluorenyl ligand with one or more symmetric or pseudo symmetric substituents, each substituent group being, independently, a radical group which is a hydrocarbyl, substituted hydrocarbyl, halocarbyl, substituted halocarbyl, silylcarbyl or germylcarbyl, and optionally two or more adjacent substituents may join to form a substituted or unsubstituted, saturated, partially unsaturated or aromatic, cyclic or polycyclic substituent;
G is a bridging group;
J is a heteroatom from group 15, such as N or P, such as N;
R′ is a radical group which is a hydrocarbyl, substituted hydrocarbyl, halocarbyl, or substituted halocarbyl;
L′ is a neutral Lewis base and w represents the number of L′ bonded to M where w is 0, 1, or 2, and optionally any L′ and any X may be bonded to one another;
X are independently, hydride radicals, hydrocarbyl radicals, substituted hydrocarbyl radicals, halocarbyl radicals, substituted halocarbyl radicals, silylcarbyl radicals, substituted silylcarbyl radicals, germylcarbyl radicals, or substituted germylcarbyl radicals; or both X are joined and bound to the metal atom to form a metallacycle ring containing from about 3 to about 20 carbon atoms; or both together can be an olefin, diolefin or aryne ligand; both X may, independently, be a halogen, alkoxide, aryloxide, amide, phosphide or other univalent anionic ligand or both X can also be joined to form a anionic chelating ligand.

In formula (MC-II), L¹ is fluorenyl or substituted fluorenyl, such as fluorenyl, 2,7-dimethylfluorenyl, 2,7-diethylfluorenyl, 2,7-dipropylfluorenyl, 2,7-dibutylfluorenyl, 2,7-diphenylfluorenyl, 2,7-dichlorofluorenyl, 2,7-dibromofluorenyl, 3,6-dimethylfluorenyl, 3,6-diethylfluorenyl, 3,6-dipropylfluorenyl, 3,6-dibutylfluorenyl, 3,6-diphenylfluorenyl, 3,6-dichlorofluorenyl, 3,6-dibromofluorenyl or 1,1,4,4,7,7,10,10-octamethyl-octahydrodibenzofluorenyl, such as fluorenyl, 2,7-dimethylfluorenyl, 2,7-diethylfluorenyl, 2,7-dipropylfluorenyl, 2,7-dibutylfluorenyl, 3,6-dimethylfluorenyl, 3,6-diethylfluorenyl, 3,6-dipropylfluorenyl, 3,6-dibutylfluorenyl, or 1,1,4,4,7,7,10,10-octamethyl-octahydrodibenzofluorenyl, such as 2,7-di-tert-butylfluorenyl, 3,6-di-tert-butylfluorenyl, 1,1,4,4,7,7,10,10-octamethyl-octahydrodibenzofluorenyl, or fluorenyl. G is methylene, dimethylmethylene, diphenylmethylene, dimethylsilylene, methylphenylsilylene, diphenylsilylene, di(4-triethylsilylphenyl)silylene, ethylene, such as diphenylmethylene, diphenylsilylene, methylphenylsilylene, and dimethylsilylene; such as dimethylsilylene. Suitable J can be nitrogen. R′ is hydrocarbyl or halocarbyl, such as C₃-C₂₀ hydrocarbyl, such as all isomers (including cyclics and polycyclics) of propyl, butyl, pentyl, hexyl, heptyl, octyl, nonyl, decyl, undecyl, dodecyl, benzyl, phenyl and substituted phenyl, such as tert-butyl, neopentyl, benzyl, phenyl, diisopropylphenyl, adamantyl, norbornyl, cyclohexyl, cyclooctyl, cyclodecyl, and cyclododecyl, such as tert-butyl, adamant-1-yl, norbom-2-yl, cyclohexyl, cyclooctyl, and cyclododecyl. X is hydrocarbyl or halo, such as methyl, benzyl, floro or chloro, such as methyl or chloro; w is zero (L′ being absent); M is zirconium.

Unlimited examples of Mono-Cp catalyst compounds with polar donor(s) include but are not limited to:

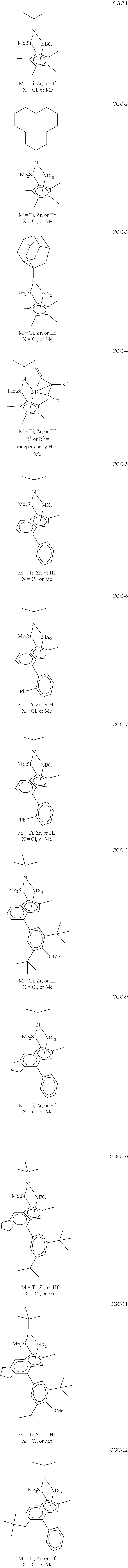

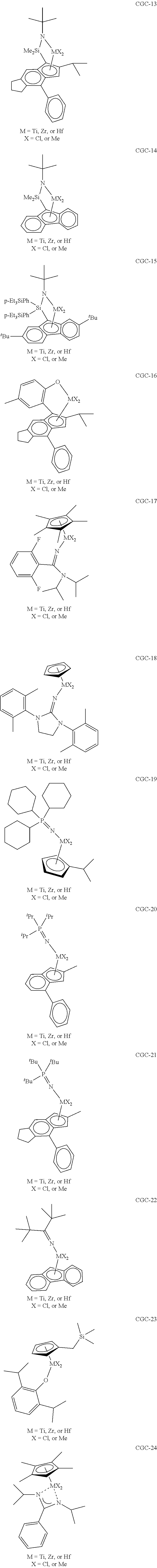

The mono-metallocene pre-catalyst compound may also be selected from: dimethylsilyl (tetramethylcyclopentadienyl)(cyclododecylamido)titanium dimethyl; dimethylsilyl (tetramethylcyclopentadienyl)(cyclododecylamido)titanium dichloride; dimethylsilyl (tetramethylcyclopentadienyl)(t-butylamido)titanium dimethyl; or dimethylsilyl (tetramethylcyclopentadienyl)(t-butylamido)titanium dichloride.

In some embodiments, pre-catalysts of the present disclosure can be “post-metallocene” catalysts having an oxygen and/or nitrogen atom(s). For example, a catalyst of the present disclosure can be a metal complex having: a metal selected from groups 3-10 or lanthanide metals, and a tridentate, mono- or di-anionic ligand containing one or two anionic donor groups and two or one neutral Lewis base donor, where the one or two neutral Lewis base donors is covalently bonded between the two anionic donors, and where the metal-ligand complex features a pair of 4-, 5-, 6-, 7-, or 8-membered metallocycle rings or a pair of mixed membered metallocycle rings, such as a mix of 4- and 5-membered rings, a mix of 5- and 6-membered rings, a mix of 6- and 7-membered rings, a mix of 5- and 7-membered rings, or a mix of 7- and 8-membered rings.

The catalyst complexes of the present disclosure include a metal selected from groups 3-10 or lanthanide metals of the Periodic Table of the Elements, a tridentate dianionic ligand containing two anionic donor groups and a neutral heterocyclic Lewis base donor, wherein the heterocyclic donor is covalently bonded between the two anionic donors. In some embodiments, the dianionic, tridentate ligand features a central heterocyclic donor group and two phenolate donors and the tridentate ligand coordinates to the metal center to form two eight-membered rings.

In some embodiments, the heterocyclic Lewis base donor of the catalyst compound features a nitrogen or oxygen donor atom. For example, heterocyclic groups include derivatives of pyridine, pyrazine, pyrimidine, triazine, thiazole, imidazole, thiophene, oxazole, thiazole, furan, and substituted variants of thereof. In some embodiments, the heterocyclic Lewis base lacks hydrogen(s) in the position alpha to the donor atom. In some embodiments, a heterocyclic Lewis base donor includes pyridine, 3-substituted pyridines, and 4-substituted pyridines.

The anionic donors of the tridentate dianionic ligand may be arylthiolates, phenolates, or anilides. In some embodiments, anionic donors are phenolates. The tridentate dianionic ligand coordinates to the metal center to form a complex that may lack a mirror plane of symmetry. In some embodiments, the tridentate dianionic ligand coordinates to the metal center to form a complex that has a two-fold rotation axis of symmetry; when determining the symmetry of the bis(phenolate) complexes only the metal and dianionic tridentate ligand are considered (i.e., ignore remaining ligands).

Catalyst compounds of the present disclosure can be bis(aryl phenolate)pyridine complexes. Bis(aryl phenolate)pyridine complexes may have a tridentate bis(aryl phenolate)pyridine ligand that is coordinated to a group 4 transition metal with the formation of two eight-membered rings. In some embodiments, a bis(aryl phenolate)pyridine complexes includes transition metal complexes of a dianionic, tridentate ligand that features a central neutral donor group and two phenolate donors, where the tridentate ligands coordinate to the metal center to form two eight-membered rings, for example, the post-metallocene catalyst can be an 8-8 catalyst. In complexes of this type, it is advantageous for the central neutral donor to be a heterocyclic group. It is advantageous for the heterocyclic group to lack hydrogens in the position alpha to the heteroatom. In complexes of this type, it may also be advantageous for the phenolates to be substituted with one or more cyclic tertiary alkyl substituents. The use of cyclic tertiary alkyl substituted phenolates can improve the ability of these catalysts to produce high molecular weight polymer.

In some embodiments, bis(phenolate) ligands can be tridentate dianionic ligands that coordinate to the metal M in such a fashion that a pair of 8-membered metallocycle rings are formed. The bis(phenolate) ligands wrap around the metal to form a complex with a 2-fold rotation axis, thus giving the complexes C₂ symmetry. The C₂ geometry and the 8-membered metallocycle rings are features of these complexes that make them effective catalyst components for the production of polyolefins, particularly isotactic poly(alpha olefins). If the ligands were coordinated to the metal in such a manner that the complex had mirror-plane (C₈) symmetry, then the catalyst would be expected to produce only atactic poly(alpha olefins); these symmetry-reactivity concepts are summarized by Bercaw, J. E. (2009) in Macromolecules, v. 42, pp. 8751-8762. The pair of 8-membered metallocycle rings of the catalyst compounds is also a notable feature that is advantageous for temperature stability, and isoselectivity of monomer enchainment. Related group 4 complexes featuring smaller 6-membered metallocycle rings are known (Macromolecules 2009, v. 42, pp. 8751-8762) to form mixtures of C₂ and C₈ symmetric complexes when used in olefin polymerizations and are thus not well suited to the production of highly isotactic poly(alpha olefins).

Bis(phenolate) ligands that contain oxygen donor groups (i.e., E=E′=oxygen of Formula (I)) can be substituted with alkyl, substituted alkyl, aryl, or other groups. It can be advantageous that each phenolate group be substituted in the ring position that is adjacent to the oxygen donor atom. For example, that substitution at the position adjacent to the oxygen donor atom can be an alkyl group containing 1-20 carbon atoms. The substitution at the position next to the oxygen donor atom can be a non-aromatic cyclic alkyl group with one or more five- or six-membered rings. Substitution at the position next to the oxygen donor atom can be a cyclic tertiary alkyl group. In some embodiments, substitution at the position next to the oxygen donor atom is adamantan-1-yl or substituted adamantan-1-yl.

The neutral heterocyclic Lewis base donor is covalently bonded between the two anionic donors (e.g., between two phenolate groups) via “linker groups” that join the heterocyclic Lewis base to the anionic donors. The “linker groups” are indicated by (A³A²) and (A^{2′}A^{3′}) in Formula (PM-I). The choice of each linker group may affect the catalyst performance, such as the tacticity of the poly(alpha olefin) produced. Each linker group can be a C₂-C₄₀ divalent group that is two-atoms in length. One or both linker groups may independently be phenylene, substituted phenylene, heteroaryl, vinylene, or a non-cyclic two-carbon long linker group. When one or both linker groups are phenylene, the alkyl substituents on the phenylene group may be chosen to optimize catalyst performance. Typically, one or both phenylenes may be unsubstituted or may be independently substituted with C₁ to C₂₀ alkyl, such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, or an isomer thereof, such as isopropyl, etc.

In some embodiments, a catalyst compound is represented by Formula (PM-I):

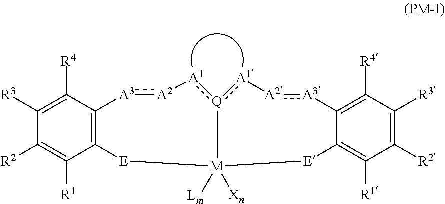

wherein:
M is a group 3, 4, 5, or 6 transition metal or a lanthanide (such as Hf, Zr or Ti);
E and E′ are each independently O, S, or NR⁹, where R⁹ is independently hydrogen, C₁-C₄₀ hydrocarbyl, C₁-C₄₀ substituted hydrocarbyl, or a heteroatom-containing group, such as O, such as both E and E′ are O;
Q is group 14, 15, or 16 atom that forms a dative bond to metal M, such as Q is C, O, S or N, such as Q is C, N, or O, such as Q is N;
A¹QA^{1′} are part of a heterocyclic Lewis base containing 4 to 40 non-hydrogen atoms that links A² to A^{2′} via a 3-atom bridge with Q being the central atom of the 3-atom bridge (A¹QA^{1′} combined with the curved line joining A¹ and A^{1′} represents the heterocyclic Lewis base);
each of A¹ and A^{1′} are independently C, N, or C(R²²), where R²² is selected from hydrogen, C₁-C₂₀ hydrocarbyl, and C₁-C₂₀ substituted hydrocarbyl (for example, each of A¹ and A^{1′} are C);
A³ [symbol] A² is a divalent group containing 2 to 40 non-hydrogen atoms that links A¹ to the E-bonded aryl group via a 2-atom bridge, such as ortho-phenylene, substituted ortho-phenylene, ortho-arene, substituted ortho-arene, indolene, substituted indolene, benzothiophene, substituted benzothiophene, pyrrolene, substituted pyrrolene, thiophene, substituted thiophene, 1,2-ethylene (—CH₂CH₂—), substituted 1,2-ethylene, 1,2-vinylene (—HC═CH—), or substituted 1,2-vinylene, such as A³ [symbol] A² is a divalent hydrocarbyl group;
A^{2′} [symbol] A^{3′} is a divalent group containing 2 to 40 non-hydrogen atoms that links A^{1′} to the E′-bonded aryl group via a 2-atom bridge such as ortho-phenylene, substituted ortho-phenylene, ortho-arene, substituted ortho-arene, indolene, substituted indolene, benzothiophene, substituted benzothiophene, pyrrolene, substituted pyrrolene, thiophene, substituted thiophene, 1,2-ethylene (—CH₂CH₂—), substituted 1,2-ethylene, 1,2-vinylene (—HC═CH—), or substituted 1,2-vinylene, such as A^{2′} [symbol] A_{3′} is a divalent hydrocarbyl group;
each L is independently a Lewis base;
each X is independently an anionic ligand;
n is 1, 2 or 3;
m is 0, 1, or 2;
n+m is not greater than 4;
each of R¹, R², R³, R⁴, R^{1′}, R^{2′}, R^{3′}, and R^{4′} is independently hydrogen, C₁-C₄₀ hydrocarbyl, C₁-C₄₀ substituted hydrocarbyl, a heteroatom or a heteroatom-containing group (such as R^{1′} and R¹ are independently a cyclic group, such as a cyclic tertiary alkyl group), or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings;
any two L groups may be joined together to form a bidentate Lewis base;
an X group may be joined to an L group to form a monoanionic bidentate group; and
any two X groups may be joined together to form a dianionic ligand group.

The metal, M, is selected from group 3, 4, 5, or 6 elements, such as group 4. For example, the metal, M, is zirconium or hafnium.

The donor atom Q of the neutral heterocyclic Lewis base (in Formula (PM-I)) can be nitrogen, carbon, or oxygen. In some embodiments, Q is nitrogen.

Non-limiting examples of neutral heterocyclic Lewis base groups include derivatives of pyridine, pyrazine, pyrimidine, triazine, thiazole, imidazole, thiophene, oxazole, thiazole, furan, and substituted variants of thereof. Heterocyclic Lewis base groups can include derivatives of pyridine, pyrazine, thiazole, and imidazole.

Each of A¹ and A^{1′} of the heterocyclic Lewis base (of Formula (PM-I)) is independently C, N, or C(R²²), where R²² is selected from hydrogen, C₁-C₂₀ hydrocarbyl, and C₁-C₂₀ substituted hydrocarbyl. In some embodiments, each of A¹ and A^{1′} is carbon. When Q is carbon, each of A¹ and A^{1′} can be selected from nitrogen and C(R²²). When Q is nitrogen, each of A¹ and A^{1′} can be carbon. In some embodiments, Q=nitrogen and A¹=A^{1′}=carbon. When Q is nitrogen or oxygen, the heterocyclic Lewis base of Formula (PM-I) might not have any hydrogen atoms bound to the A¹ or A^{1′} atoms, which may be preferred because it is thought that hydrogens in those positions may undergo unwanted decomposition reactions that reduce the stability of the catalytically active species.

The heterocyclic Lewis base (of Formula (PM-I)) represented by A¹QA^{1′} combined with the curved line joining A¹ and A^{1′} can be selected from the following, with each R²³ group selected from hydrogen, heteroatoms, C₁-C₂₀ alkyls, C₁-C₂₀ alkoxides, C₁-C₂₀ amides, and C₁-C₂₀ substituted alkyls.

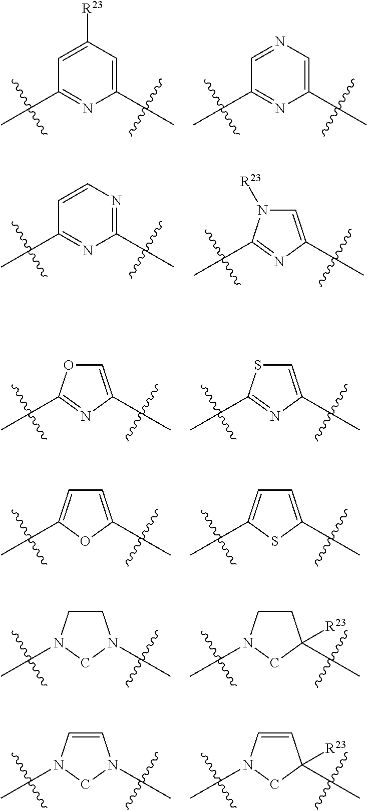

In some embodiments, the heterocyclic Lewis base (of Formula (PM-I)) represented by A¹QA^{1′} combined with the curved line joining A¹ and A^{1′} is a six membered ring containing zero or one ring heteroatoms or a five membered ring containing zero, one two or three ring heteroatoms. Alternately, the heterocyclic Lewis base (of Formula (PM-I)) represented by A¹QA^{1′} combined with the curved line joining A¹ and A^{1′} is not a six membered ring containing two or more ring heteroatoms.

In some embodiments of Formula (PM-I), Q is C, N or O, such as Q is N.

In some embodiments of Formula (PM-I), each of A¹ and A^{1′} is independently carbon, nitrogen, or C(R²²), with R²² selected from hydrogen, C₁-C₂₀ hydrocarbyl, substituted C₁-C₂₀ hydrocarbyl. In some embodiments, each of A¹ and A^{1′} is carbon.

In some embodiments of Formula (PM-I), A¹QA^{1′} of Formula (PM-I) is part of a heterocyclic Lewis base, such as a pyridine, pyrazine, pyrimidine, triazine, thiazole, imidazole, thiophene, oxazole, thiazole, furan, or a substituted variant of thereof.

In some embodiments of Formula (PM-I), A¹QA^{1′} are part of a heterocyclic Lewis base containing 2 to 20 non-hydrogen atoms that links A² to A^{2′} via a 3-atom bridge with Q being the central atom of the 3-atom bridge. In some embodiments, each A¹ and A^{1′} is a carbon atom and the A¹QA^{1′} fragment forms part of a pyridine, pyrazine, pyrimidine, triazine, thiazole, imidazole, thiophene, oxazole, thiazole, furan, or a substituted variant of thereof group, or a substituted variant thereof.

In at least one embodiment of Formula (PM-I), Q is carbon and each of A¹ and A^{1′} is N or C(R²²), where R²² is selected from hydrogen, C₁-C₂₀ hydrocarbyl, substituted C₁-C₂₀ hydrocarbyl, a heteroatom or a heteroatom-containing group. In such embodiments, the A¹QA^{1′} fragment forms part of a cyclic carbene, N-heterocyclic carbene, cyclic amino alkyl carbene, or a substituted variant thereof.

In some embodiments of Formula (PM-I), A³ [symbol] A² is a divalent group containing 2 to 20 non-hydrogen atoms that links A¹ to the E-bonded aryl group via a 2-atom bridge, where the A³ [symbol] A² is a linear alkyl or forms part of a cyclic group (such as an optionally substituted ortho-phenylene group, or ortho-arylene group) or a substituted variant thereof.

A^{2′} [symbol] A^{3′} is a divalent group containing 2 to 20 non-hydrogen atoms that links A^{1′} to the E′-bonded aryl group via a 2-atom bridge, where the A^{2′} [symbol] A^{3′} is a linear alkyl or forms part of a cyclic group (such as an optionally substituted ortho-phenylene group, or ortho-arylene group or, or a substituted variant thereof.

In some embodiments of Formula (PM-I), M is Zr or Hf, Q is nitrogen, both A¹ and A^{1′} are carbon, both E and E′ are oxygen, and both R¹ and R^{1′} are C₄-C₂₀ cyclic tertiary alkyls.

In some embodiments of Formula (PM-I), M is Zr or Hf, Q is nitrogen, both A¹ and A^{1′} are carbon, both E and E′ are oxygen, and both R¹ and R^{1′} are adamantan-1-yl or substituted adamantan-1-yl.

In some embodiments of Formula (PM-I), M is Zr or Hf, Q is nitrogen, both A¹ and A^{1′} are carbon, both E and E′ are oxygen, and both R¹ and R^{1′} are C₆-C₂₀ aryls.

In some embodiments, a catalyst compound is represented by Formula (PM-II):

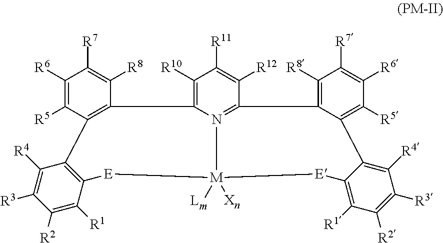

wherein:
M is a group 3, 4, 5, or 6 transition metal or a lanthanide (such as a group 4 transition metal that is Hf, Zr or Ti);
E and E′ are each independently O, S, or NR⁹, where R⁹ is independently hydrogen, C₁-C₄₀ hydrocarbyl, C₁-C₄₀ substituted hydrocarbyl, or a heteroatom-containing group, such as O, such as both E and E′ are 0;
each L is independently a Lewis base;
each X is independently an anionic ligand;
n is 1, 2 or 3;
m is 0, 1, or 2;
n+m is not greater than 4;
each of R¹, R², R³, R⁴, R^{1′}, R^{2′}, R^{3′}, and R^{4′} is independently hydrogen, C₁-C₄₀ hydrocarbyl, C₁-C₄₀ substituted hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings;
any two L groups may be joined together to form a bidentate Lewis base;
an X group may be joined to an L group to form a monoanionic bidentate group;
any two X groups may be joined together to form a dianionic ligand group;
each of R⁵, R⁶, R⁷, R⁸, R^{5′}, R^{6′}, R^{7′}; R^{8′}, R¹⁰, R¹¹, and R¹² is independently hydrogen, C₁-C₄₀ hydrocarbyl, C₁-C₄₀ substituted hydrocarbyl, a heteroatom or a heteroatom-containing group, or one or more of R⁵ and R⁶, R⁶ and R⁷, R⁷ and R⁸, R^{5′} and R^{6′}, R^{6′} and R^{7′}, R^{7′} and R^{8′}, R¹⁰ and R¹¹, or R¹¹ and R¹² may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings.

In Formula (PM-I) or (PM-II), E and E′ are each selected from oxygen or NR⁹, where R⁹ is independently hydrogen, C₁-C₄₀ hydrocarbyl, C₁-C₄₀ substituted hydrocarbyl, or a heteroatom-containing group. In some embodiments, E and E′ are oxygen. When E and/or E′ are NR⁹, R⁹ can be selected from C₁ to C₂₀ hydrocarbyls, alkyls, or aryls. In one embodiment E and E′ are each selected from O, S, or N(alkyl) or N(aryl), where the alkyl can be a C₁ to C₂₀ alkyl, such as methyl, ethyl, propyl, butyl, pentyl, hexyl, octyl, nonyl, decyl, undecyl, dodecyl, and the like, and aryl is a C₆ to C₄₀ aryl group, such as phenyl, naphthalenyl, benzyl, methylphenyl, and the like.

In some embodiments, A³ [symbol] A² and A^{2′} [symbol] A^{3′} are independently a divalent hydrocarbyl group, such as C₁ to C₁₂ hydrocarbyl group.

In some embodiments of catalyst compounds of Formula (PM-I) or (PM-II), when E and E′ are oxygen, each phenolate group can be substituted in the position that is next to the oxygen atom (i.e., R¹ and R^{1′} in Formula (PM-I) and (PM-II)). Thus, when E and E′ are oxygen, each of R¹ and R^{1′} is independently a C₁-C₄₀ hydrocarbyl, a C₁-C₄₀ substituted hydrocarbyl, a heteroatom or a heteroatom-containing group, such as each of R¹ and R^{1′} is independently a non-aromatic cyclic alkyl group with one or more five- or six-membered rings (such as cyclohexyl, cyclooctyl, adamantyl, or 1-methylcyclohexyl, or substituted adamantyl), such as a non-aromatic cyclic tertiary alkyl group (such as 1-methylcyclohexyl, adamantyl, or substituted adamantyl).

In some embodiments of the catalyst compound of Formula (PM-I) or (PM-II), each of R¹ and R^{1′} is independently a tertiary hydrocarbyl group. In other embodiments of Formula (PM-I) or (PM-II), each of R¹ and R^{1′} is independently a cyclic tertiary hydrocarbyl group. In other embodiments of the catalyst compound of Formula (PM-I) or (PM-II), each of R¹ and R^{1′} is independently a polycyclic tertiary hydrocarbyl group.

In some embodiments of the catalyst compound of Formula (PM-I) or (PM-II), each of R¹ and R^{1′} is independently a tertiary hydrocarbyl group. In other embodiments of the catalyst compound of Formula (PM-I) or (PM-II), each of R¹ and R^{1′} is independently a cyclic tertiary hydrocarbyl group. In other embodiments of the catalyst compound of Formula (PM-I) or (PM-II), each of R¹ and R^{1′} is independently a polycyclic tertiary hydrocarbyl group.

The linker groups (i.e., A³ [symbol] A² and A^{2′} [symbol] A^{3′} in Formula (PM-I)) can each be part of an ortho-phenylene group, such as a substituted ortho-phenylene group. It may be preferred for the R⁷ and R^{7′} positions of Formula (PM-II) to be hydrogen or C₁ to C₂₀ alkyl, such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, or an isomer thereof, such as isopropyl, etc. For applications targeting polymers with high tacticity, it may be preferred for the R⁷ and R^{7′} positions of Formula (PM-II) to be a C₁ to C₂₀ alkyl, such as for both R⁷ and R^{7′} to be a C₁ to C₃ alkyl.

In some embodiments of Formula (PM-I) or (PM-II), M is a group 4 metal, such as Hf or Zr.

In some embodiments of Formula (PM-I) and (PM-II), each of E and E′ is O.

In some embodiments of Formula (PM-I) and (PM-II), each of R¹, R², R³, R⁴, R^{1′}, R^{2′}, R^{3′}, and R^{4′} is independently hydrogen, C₁-C₄₀ hydrocarbyl, C₁-C₄₀ substituted hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings, such as hydrogen, methyl, ethyl, propyl, butyl, pentyl, hexyl, or an isomer thereof.

In some embodiments of Formula (PM-I) and (PM-II), each of R¹, R², R³, R⁴, R^{1′}, R^{2′}, R^{3′}, and R^{4′} is independently selected from methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthalenyl, cyclohexyl, cyclohexenyl, methylcyclohexyl, and isomers thereof.

In some embodiments of Formula (PM-I) and (PM-II), each of R⁴ and R^{4′} is independently hydrogen or a C₁ to C₃ hydrocarbyl, such as methyl, ethyl or propyl.

In embodiments of Formula (PM-I) and (PM-II), R⁹ is hydrogen, C₁-C₄₀ hydrocarbyl, C₁-C₄₀ substituted hydrocarbyl, or a heteroatom-containing group, such as hydrogen, methyl, ethyl, propyl, butyl, pentyl, hexyl, or an isomer thereof. In some embodiments, R⁹ is C₁ to C₆ alkyl (such as methyl, ethyl, propyl, or butyl), phenyl, 2-methylphenyl, 2,6-dimethylphenyl, or 2,4,6-trimethylphenyl.

In embodiments of Formula (PM-I) and (PM-II), each X is, independently, selected from the group consisting of hydrocarbyl radicals having from 1 to 20 carbon atoms (such as alkyls or aryls), hydrides, amides, alkoxides, sulfides, phosphides, halides, alkyl sulfonates, and a combination thereof, (two or more X's may form a part of a fused ring or a ring system), such as each X is independently selected from halides, aryls, and C₁ to C₅ alkyl groups, such as each X is independently a hydrido, dimethylamido, diethylamido, methyltrimethylsilyl, neopentyl, phenyl, benzyl, methyl, ethyl, propyl, butyl, pentyl, fluoro, iodo, bromo, or chloro group.

Alternatively, each X may be, independently, a halide, a hydride, an alkyl group, or an alkenyl group.

In some embodiments of Formula (PM-I) and (PM-II), each L is a Lewis base, independently, selected from the group consisting of ethers, thio-ethers, amines, nitriles, imines, pyridines, halocarbons, and phosphines, such as ethers, thioethers, or a combination thereof, optionally two or more L's may form a part of a fused ring or a ring system, such as each L is independently selected from ether or thioether groups, such as each L is an ethyl ether, tetrahydrofuran, dibutyl ether, or dimethylsulfide group.

In some embodiments of Formula (PM-I) and (PM-II), each of R¹ and R^{1′} is independently cyclic tertiary alkyl groups.

In some embodiments of Formula (PM-I) and (PM-II), n is 1, 2 or 3, such as 2.

In some embodiments of Formula (PM-I) and (PM-II), m is 0, 1 or 2, such as 0.

In some embodiments of Formula (PM-I) and (PM-II), each of R¹ and R^{1′} is not hydrogen.

In some embodiments of Formula (PM-I) and (PM-II), M is Hf or Zr, each of E and E′ is O; each of R¹ and R^{1′} is independently a C₁-C₄₀ hydrocarbyl, a substituted C₁-C₄₀ hydrocarbyl, a heteroatom or a heteroatom-containing group, each of R², R³, R⁴, R^{2′}, R^{3′}, and R^{4′} is independently hydrogen, C₁-C₂₀ hydrocarbyl, substituted C₁-C₂₀ hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings; each X is, independently, selected from the group consisting of hydrocarbyl radicals having from 1 to 20 carbon atoms (such as alkyls or aryls), hydrides, amides, alkoxides, sulfides, phosphides, halides, and a combination thereof, (two or more X's may form a part of a fused ring or a ring system); each L is, independently, selected from the group consisting of ethers, thioethers, and halo carbons (two or more L's may form a part of a fused ring or a ring system).

In some embodiments of Formula (PM-II), each of R⁵, R⁶, R⁷, R⁸, R^{5′}, R^{6′}, R^{7′}, R^{8′}, R¹⁰, R¹¹ and R¹² is independently hydrogen, C₁-C₄₀ hydrocarbyl, substituted C₁-C₄₀ hydrocarbyl, a heteroatom or a heteroatom-containing group, or one or more adjacent R groups may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings.

In some embodiments of Formula (PM-II), each of R⁵, R⁶, R⁷, R⁸, R^{5′}, R^{6′}, R^{7′}, R^{8′}, R¹⁰, R¹¹ and R¹² is independently hydrogen, methyl, ethyl, propyl, butyl, pentyl, hexyl, or an isomer thereof.

In some embodiments of Formula (PM-II), each of R⁵, R⁶, R⁷, R⁸, R^{5′}, R^{6′}, R^{7′}, R^{8′}, R¹⁰, R¹¹ and R¹² is independently selected from methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthalenyl, cyclohexyl, cyclohexenyl, methylcyclohexyl, or isomers thereof.

In some embodiments of Formula (PM-II), M is Hf or Zr, each of E and E′ is O; each of R¹ and R^{1′} is independently a C₁-C₄₀ hydrocarbyl, a substituted C₁-C₄₀ hydrocarbyl, a heteroatom or a heteroatom-containing group;
each of R¹, R², R³, R⁴, R^{1′}, R^{2′}, R^{3′}, and R^{4′} is independently hydrogen, C₁-C₂₀ hydrocarbyl, substituted C₁-C₂₀ hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings;
R⁹ is hydrogen, C₁-C₂₀ hydrocarbyl, C₁-C₂₀ substituted hydrocarbyl, or a heteroatom-containing group, such as hydrogen, methyl, ethyl, propyl, butyl, pentyl, hexyl, or an isomer thereof;
each X is, independently, selected from the group consisting of hydrocarbyl radicals having from 1 to 20 carbon atoms (such as alkyls or aryls), hydrides, amides, alkoxides, sulfides, phosphides, halides, dienes, amines, phosphines, ethers, and a combination thereof, (two or more X's may form a part of a fused ring or a ring system);
n is 2; m is 0; and each of R⁵, R⁶, R⁷, R⁸, R^{5′}, R^{6′}, R^{7′}, R^{8′}, R¹⁰, R¹¹ and R¹² is independently hydrogen, C₁-C₂₀ hydrocarbyl, C₁-C₂₀ substituted hydrocarbyl, a heteroatom or a heteroatom-containing group, or one or more adjacent R groups may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings, such as each of R⁵, R⁶, R⁷, R⁸, R^{5′}, R^{6′}, R^{7′}, R^{8′}, R¹⁰, R¹¹ and R¹² is are independently selected from methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthyl, cyclohexyl, cyclohexenyl, methylcyclohexyl, and isomers thereof.

In some embodiments of Formula (PM-II), M is Zr or Hf, both E and E′ are oxygen, and both R¹ and R^{1′} are C₄-C₂₀ cyclic tertiary alkyls.

In some embodiments of Formula (PM-II), M is Zr or Hf, both E and E′ are oxygen, and both R¹ and R^{1′} are adamantan-1-yl or substituted adamantan-1-yl.

In some embodiments of Formula (PM-II), M is Zr or Hf, both E and E′ are oxygen, and each of R¹, R^{1′}, R³ and R^{3′} are adamantan-1-yl or substituted adamantan-1-yl.

In some embodiments of Formula (PM-II), M is Zr or Hf, both E and E′ are oxygen, both R¹ and R^{1′} are C₄-C₂₀ cyclic tertiary alkyls, and both R⁷ and R^{7′} are C₁-C₂₀ alkyls.

In some embodiments, a catalyst compound is one or more of: dimethylzirconium[2′,2′″-(pyridine-2,6-diyl)bis(3-adamantan-1-yl)-5-(tert-butyl)-[1,1′-biphenyl]-2-olate)], dimethylhafnium[2′,2′″-(pyridine-2,6-diyl)bis(3-adamantan-1-yl)-5-(tert-butyl)-[1,1′-biphenyl]-2-olate)], dimethylzirconium[6,6′-(pyridine-2,6-diylbis(benzo[b]thiophene-3,2-diyl))bis(2-adamantan-1-yl)-4-methylphenolate)], dimethylhafnium[6,6′-(pyridine-2,6-diylbis(benzo[b]thiophene-3,2-diyl))bis(2-adamantan-1-yl)-4-methylphenolate)], dimethylzirconium[2′,2′″-(pyridine-2,6-diyl)bis(3-((3r,5r,7r)-adamantan-1-yl)-5-methyl-[1,1′-biphenyl]-2-olate)], dimethylhafnium[2′,2′″-(pyridine-2,6-diyl)bis(3-((3r,5r,7r)-adamantan-1-yl)-5-methyl-[1,1′-biphenyl]-2-olate)], dimethylzirconium[2′,2′″-(pyridine-2,6-diyl)bis(3-((3r,5r,7r)-adamantan-1-yl)-4′,5-dimethyl-[1,1′-biphenyl]-2-olate)], dimethylhafnium[2′,2′″-(pyridine-2,6-diyl)bis(3-((3r,5r,7r)-adamantan-1-yl)-4′,5-dimethyl-[1,1′-biphenyl]-2-olate)], or combinations thereof.

In some embodiments, a pre-catalyst compound is one or more of the Group 4 based pre-catalysts below:

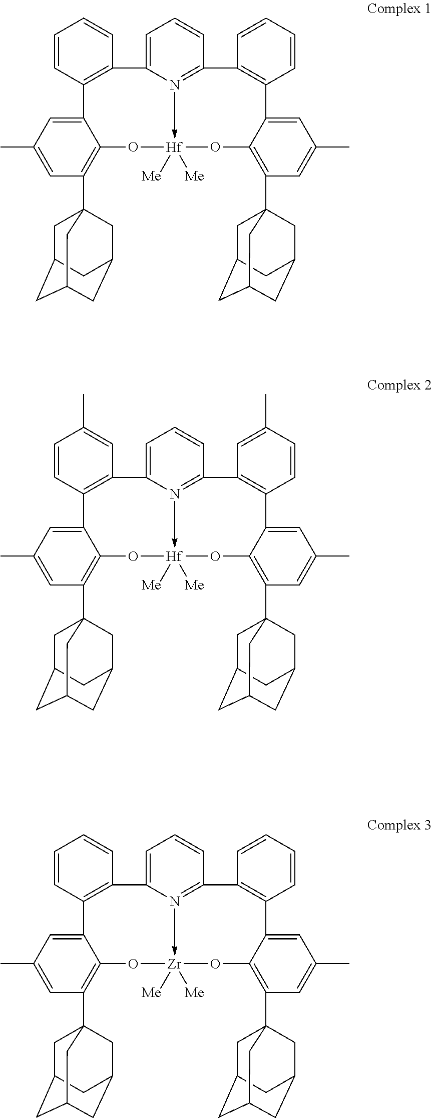

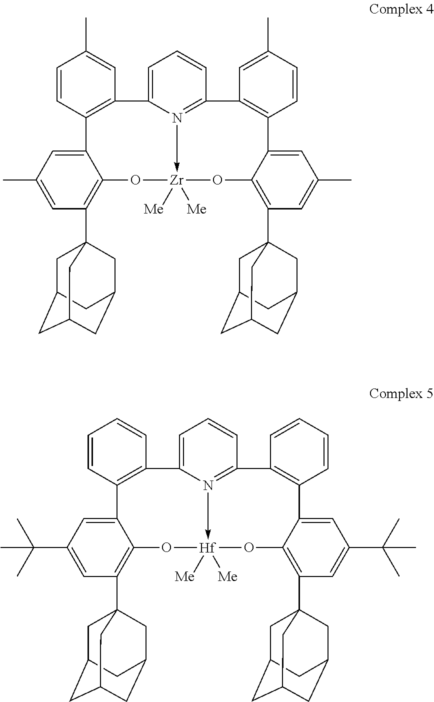

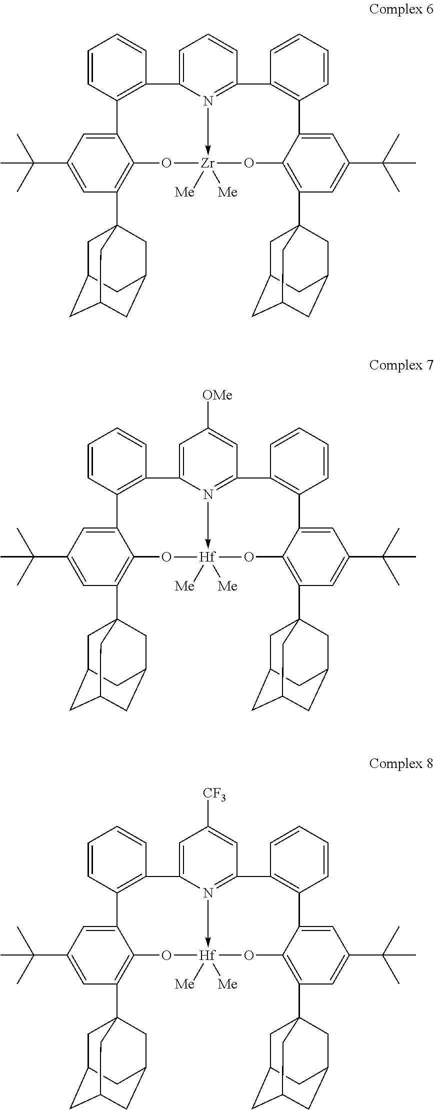

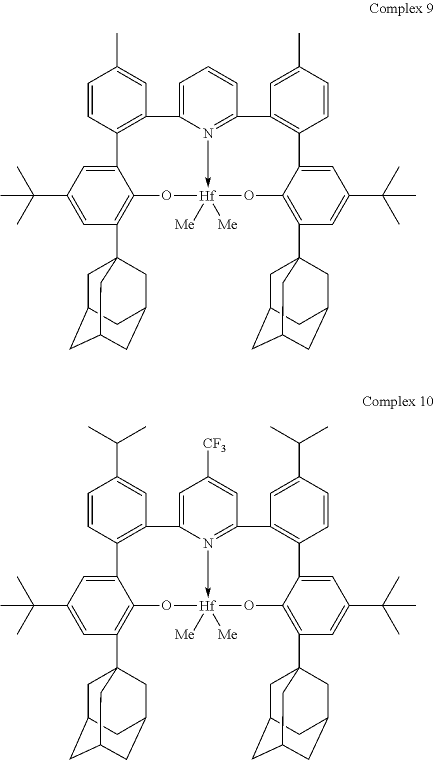

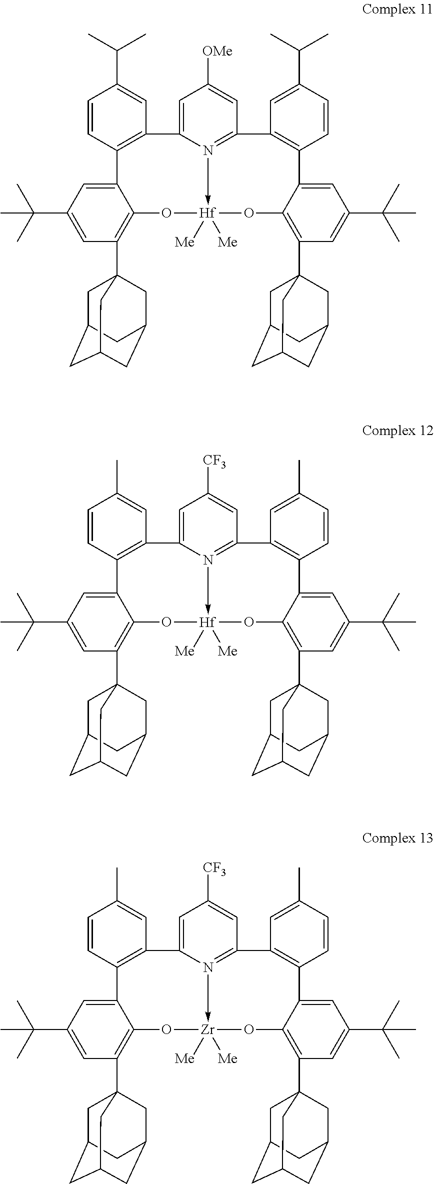

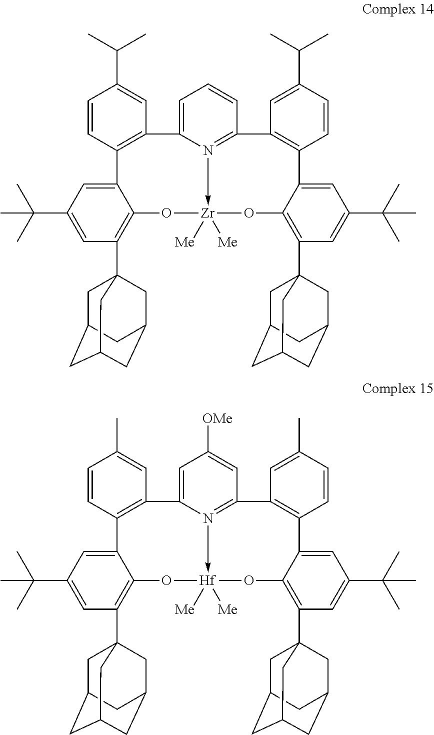

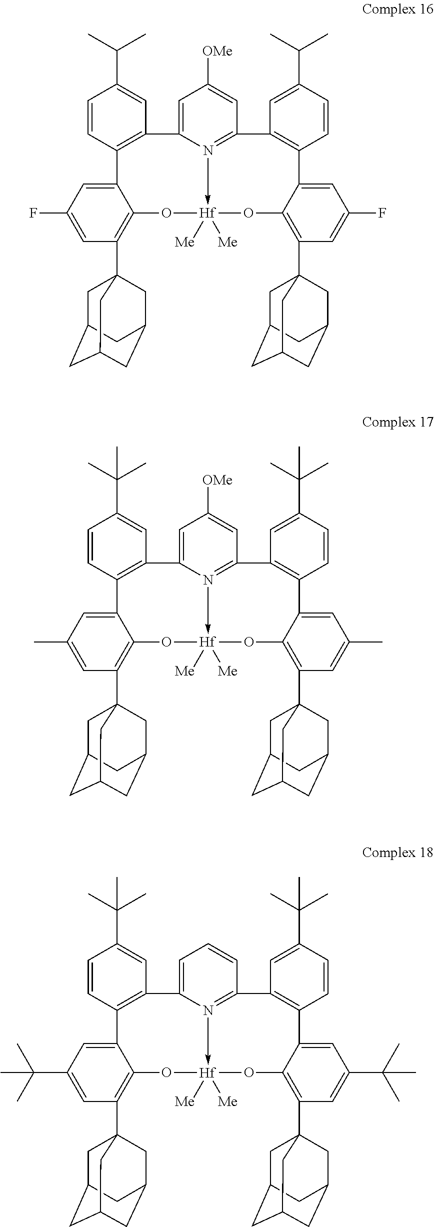

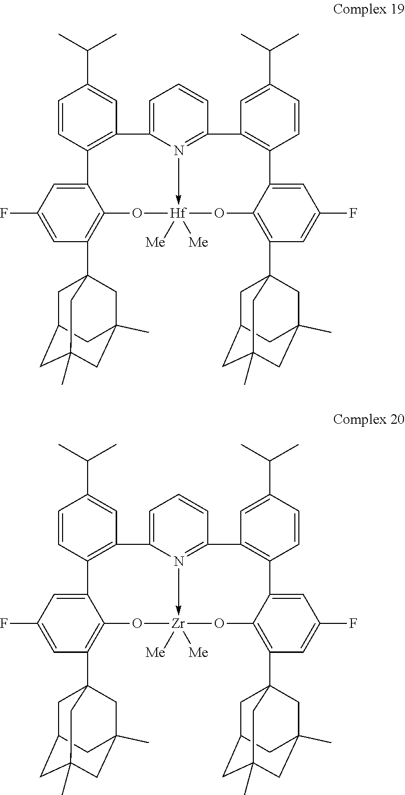

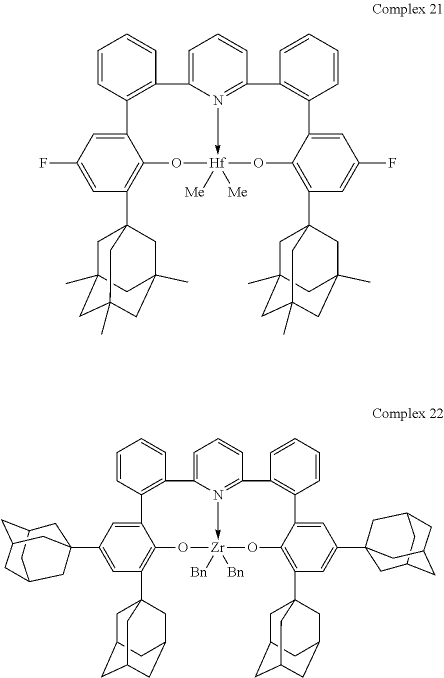

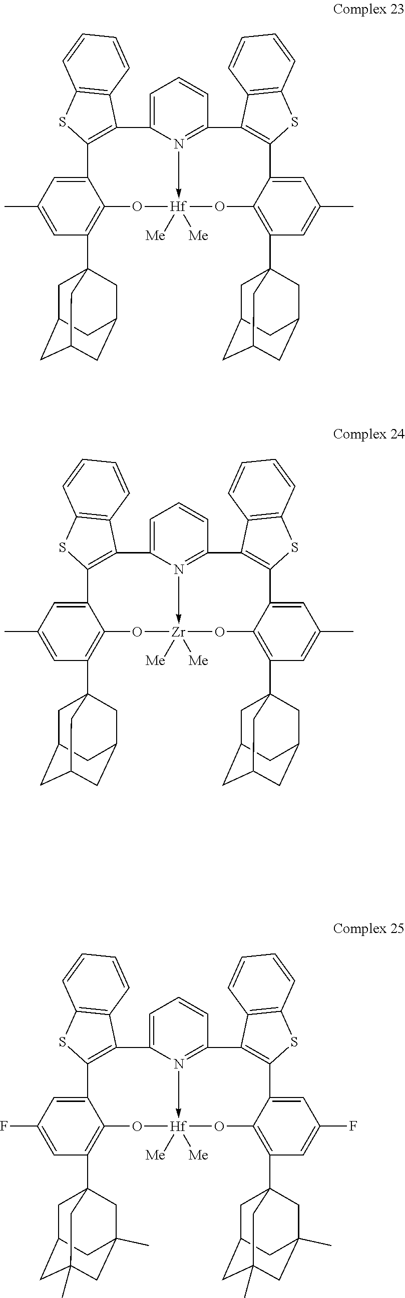

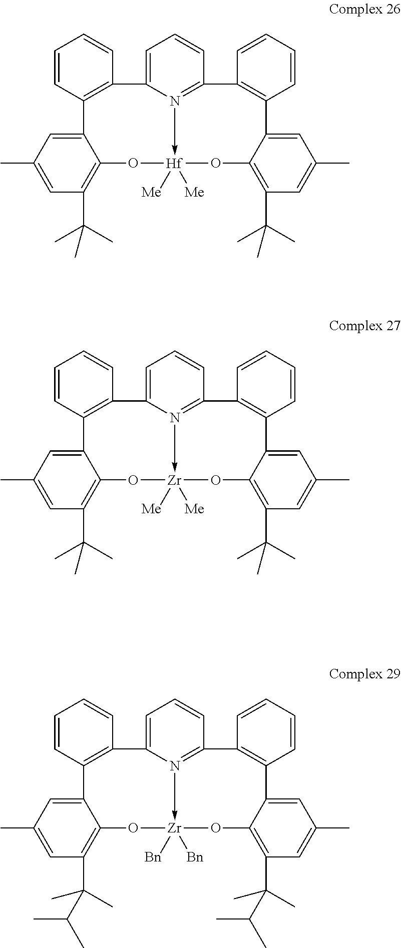

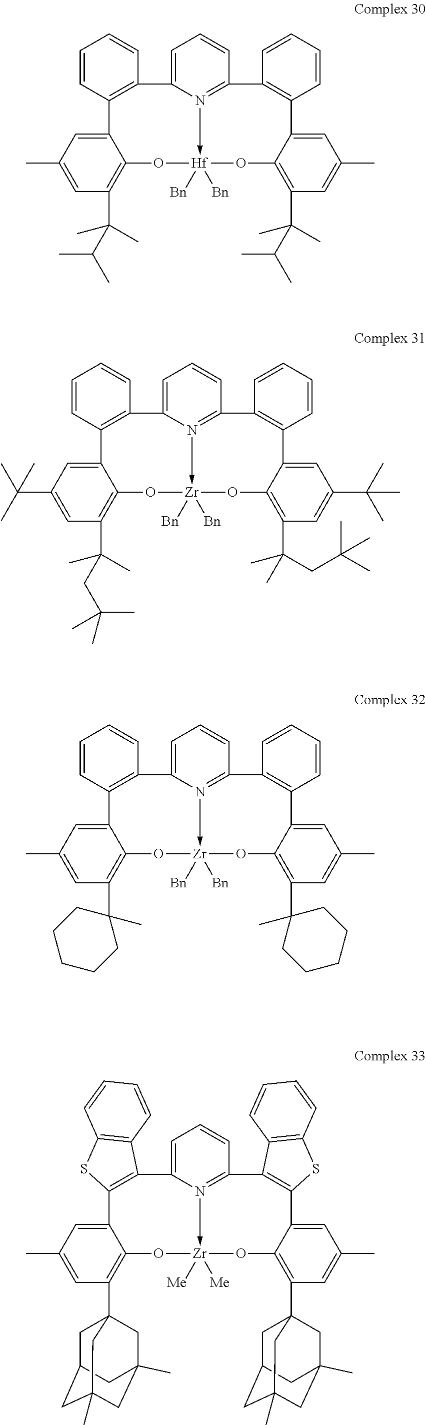

In some embodiments, a pre-catalyst compound is one or more of the Group 3 based pre-catalysts:

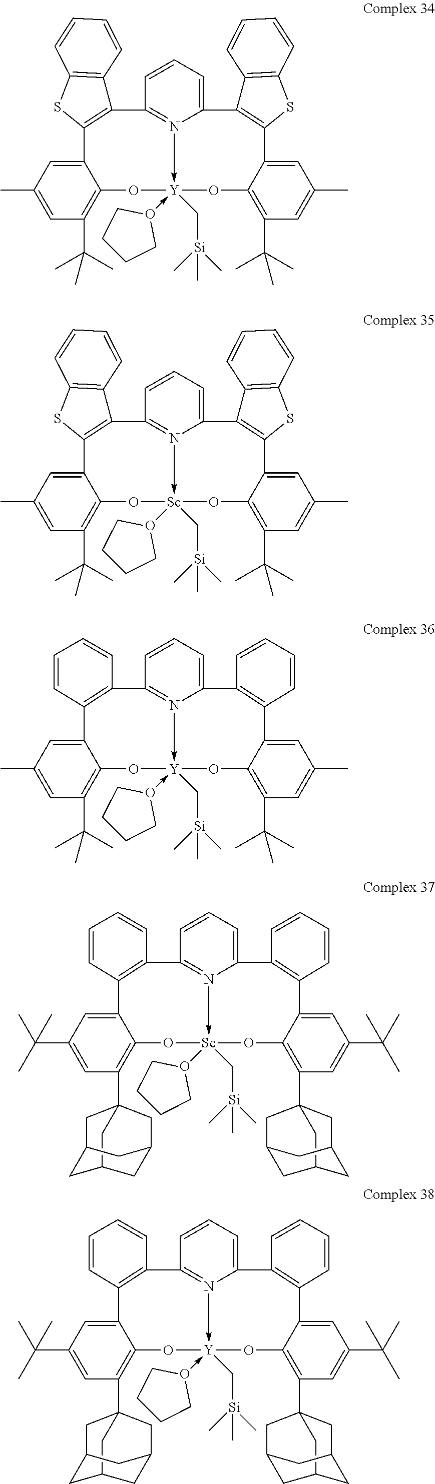

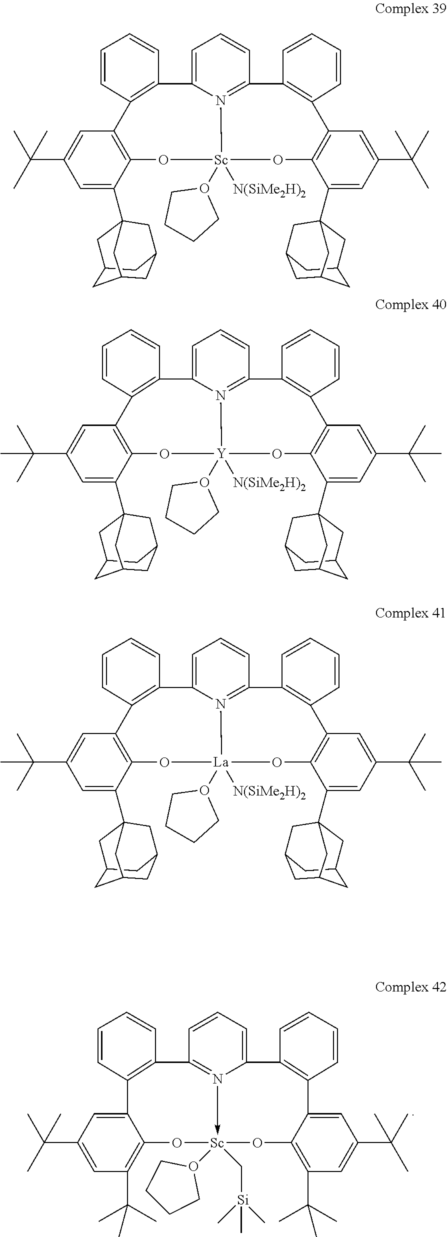

In some embodiments, TMA free (or trihydrocarbyl aluminum free) solution alumoxane (e.g., MAO), solid alumoxane (e.g., MAO), or supported alumoxane (e.g., MAO) can also be used for bis-Cp metallocene pre-catalyst compounds not having polar donors for the purpose of polymer property control, e.g., for regulating the polymer molecule weight and molecular weight distribution through limiting the free aluminum alkyls in the system that may cause chain transfer from the catalytic metal center to the free aluminum alkyls. Metallocene pre-catalyst compounds as used herein include metallocenes comprising Group 3 to Group 10 metal complexes, preferably, Group 4 to Group 6 metal complexes, for example, Group 4 metal complexes. The metallocene catalyst compound of catalyst systems of the present disclosure may be unbridged metallocene catalyst compounds represented by the formula (BC-I):

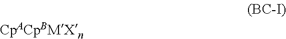

wherein each Cp^{A} and Cp^{B} is independently selected from cyclopentadienyl ligands and ligands isolobal to cyclopentadienyl, one or both Cp^{A} and Cp^{B} may contain heteroatoms, and one or both Cp^{A} and Cp^{B} may be substituted by one or more R″ groups. M′ is selected from Groups 3 through 12 atoms and lanthanide Group atoms. X′ is an anionic leaving group. n is 0 or an integer from 1 to 4. R″ is selected from alkyl, lower alkyl, substituted alkyl, heteroalkyl, alkenyl, lower alkenyl, substituted alkenyl, heteroalkenyl, alkynyl, lower alkynyl, substituted alkynyl, heteroalkynyl, alkoxy, lower alkoxy, aryloxy, alkylthio, lower alkylthio, arylthio, aryl, substituted aryl, heteroaryl, aralkyl, aralkylene, alkaryl, alkarylene, haloalkyl, haloalkenyl, haloalkynyl, heteroalkyl, heterocycle, heteroaryl, a heteroatom-containing group, hydrocarbyl, lower hydrocarbyl, substituted hydrocarbyl, heterohydrocarbyl, silyl, boryl, phosphino, phosphine, amino, amine, ether, and thioether.

In at least one embodiment, each Cp^{A} and Cp^{B} is independently selected from cyclopentadienyl, indenyl, fluorenyl, cyclopentaphenanthreneyl, benzindenyl, fluorenyl, octahydrofluorenyl, cyclooctatetraenyl, cyclopentacyclododecene, phenanthrindenyl, 3,4-benzofluorenyl, 9-phenylfluorenyl, 8-H-cyclopent[a]acenaphthylenyl, 7-H-dibenzofluorenyl, indeno[1,2-9]anthrene, thiophenoindenyl, thiophenofluorenyl, and hydrogenated versions thereof.

The metallocene catalyst compound may be a bridged metallocene catalyst compound represented by the formula (BC-II):

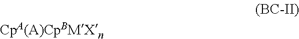

wherein each Cp^{A} and Cp^{B} is independently selected from cyclopentadienyl ligands and ligands isolobal to cyclopentadienyl. One or both Cp^{A} and Cp^{B} may contain heteroatoms, and one or both Cp^{A} and Cp^{B} may be substituted by one or more R″ groups. M′ is selected from Groups 3 through 12 atoms and lanthanide Group atoms. X′ is an anionic leaving group. n is 0 or an integer from 1 to 4. (A) is selected from divalent alkyl, divalent lower alkyl, divalent substituted alkyl, divalent heteroalkyl, divalent alkenyl, divalent lower alkenyl, divalent substituted alkenyl, divalent heteroalkenyl, divalent alkynyl, divalent lower alkynyl, divalent substituted alkynyl, divalent heteroalkynyl, divalent alkoxy, divalent lower alkoxy, divalent aryloxy, divalent alkylthio, divalent lower alkylthio, divalent arylthio, divalent aryl, divalent substituted aryl, divalent heteroaryl, divalent aralkyl, divalent aralkylene, divalent alkaryl, divalent alkarylene, divalent haloalkyl, divalent haloalkenyl, divalent haloalkynyl, divalent heteroalkyl, divalent heterocycle, divalent heteroaryl, a divalent heteroatom-containing group, divalent hydrocarbyl, divalent lower hydrocarbyl, divalent substituted hydrocarbyl, divalent heterohydrocarbyl, divalent silyl, divalent boryl, divalent phosphino, divalent phosphine, divalent amino, divalent amine, divalent ether, divalent thioether. R″ is selected from alkyl, lower alkyl, substituted alkyl, heteroalkyl, alkenyl, lower alkenyl, substituted alkenyl, heteroalkenyl, alkynyl, lower alkynyl, substituted alkynyl, heteroalkynyl, alkoxy, lower alkoxy, aryloxy, alkylthio, lower alkylthio, arylthio, aryl, substituted aryl, heteroaryl, aralkyl, aralkylene, alkaryl, alkarylene, haloalkyl, haloalkenyl, haloalkynyl, heteroalkyl, heterocycle, heteroaryl, a heteroatom-containing group, hydrocarbyl, lower hydrocarbyl, substituted hydrocarbyl, heterohydrocarbyl, silyl, boryl, phosphino, phosphine, amino, amine, germanium, ether, and thioether.

In at least one embodiment, each of Cp^{A} and Cp^{B} is independently selected from cyclopentadienyl, n-propylcyclopentadienyl, indenyl, pentamethylcyclopentadienyl, tetramethylcyclopentadienyl, and n-butylcyclopentadienyl. (A) may be CR′₂ or SiR′₂, where each R′ is independently hydrogen or C₁-C₂₀ hydrocarbyl.

In some embodiments, two or more different pre-catalyst compounds are present in the catalyst system used herein. In some embodiments, two or more different pre-catalyst compounds are present in the reaction zone where the process(es) described herein occur. It may be preferable to use the same activator for the transition metal compounds, however, two different activators, such as TMA free supported or unsupported MAO from the current disclosure and a strong Lewis acid activator (e.g., trisperfluoroaromatic boranes) or non- or weak-coordinating anion activator (e.g., N,N-dimethylanalenium or trityl tetrakisperfluoroaromatic borates), can be used in combination. If one or more transition metal compounds contain an X group which is not a hydride, hydrocarbyl, or substituted hydrocarbyl, then the MAO can be contacted with the transition metal compounds prior to addition of the non-coordinating anion activator.

The two transition metal compounds (pre-catalysts) may be used in any ratio. In some embodiments, molar ratios of (A) transition metal compound to (B) transition metal compound fall within the range of (A:B) 1:1000 to 1000:1, alternatively 1:100 to 500:1, alternatively 1:10 to 200:1, alternatively 1:1 to 100:1, and alternatively 1:1 to 75:1, and alternatively 5:1 to 50:1. The particular ratio chosen will depend on the exact pre-catalysts chosen, the method of activation, and the end product desired. In a particular embodiment, when using the two pre-catalysts, where both are activated with the same activator, useful mole percents, based upon the molecular weight of the pre-catalysts, are 10% to 99.9% A to 0.1% to 90% B, alternatively 25% to 99% A to 0.5% to 50% B, alternatively 50% to 99% A to 1% to 25% B, and alternatively 75% to 99% A to 1% to 10% B.

In some embodiments, the leaving groups of the pre-catalysts described above are preferably pre-alkylated, such as methylated, ethylated, benzylated, or trimethylsilylmethylenated because the alkylation agent in MAO, e.g., free TMA, has been removed significantly. However, non-alkylated pre-catalysts may still be used either with a mild alkylation agent, such as high carbon trialkylaluminum (e.g., trioctylaluminum) or a secondary aluminumalkyl (e.g., AlMe₂BHT or AlEt₂BHT) or without a mild alkylation agent if the solution, solid, or supported MAO system has a low TMA or trihydrocarbylaluminum residue enough for the alkylation of the pre-catalyst.

### Polymerization Processes

The present disclosure also relates to polymerization processes where monomer (e.g., ethylene; propylene), and optionally a one or more comonomers, are contacted with catalyst systems made from one of the methods described in this disclosure in a single polymerization reactor or multiple polymerization reactors in sequence following corresponding polymerization processes to obtain desired polymer products including single-phasic polymers or copolymers and multiple-phasic copolymers, such as in a single reactor for solution-, slurry-, and gas-phase polymerization and copolymerization, such as in multiple reactors for solution-, slurry-, and gas-phase sequential copolymerization. The pre-catalyst compound and activator may be combined in any suitable order. The pre-catalyst compound and activator may be combined prior to contacting with the monomer, e.g., the finished catalyst system can form first by combing a pre-catalyst compound and a TMA free silica supported MAO before it is fed into the polymerization reactor to contact with monomers. Alternatively, the pre-catalyst compound and activator may be introduced into the polymerization reactor separately, wherein the pre-catalyst compound and activator subsequently react to form the active catalyst.

Monomers may include substituted or unsubstituted C₂ to C₄₀ alpha olefins, such as C₂ to C₂₀ alpha olefins, such as C₂ to C₁₂ alpha olefins, such as ethylene, propylene, butene, pentene, hexene, heptene, octene, nonene, decene, undecene, dodecene and isomers thereof. In at least one embodiment, the monomer includes ethylene and an optional comonomer including one or more C₃ to C₄₀ olefins, such as C₄ to C₂₀ olefins, such as C₆ to C₁₂ olefins. The C₃ to C₄₀ olefin monomers may be linear, branched, or cyclic. The C₃ to C₄₀ cyclic olefins may be strained or unstrained, monocyclic or polycyclic, and may optionally include heteroatoms and or one or more functional groups. In another embodiment, the monomer includes propylene and an optional comonomer including one or more ethylene or C₄ to C₄₀ olefins, such as C₄ to C₂₀ olefins, such as C₆ to C₁₂ olefins. The C₄ to C₄₀ olefin monomers may be linear, branched, or cyclic. The C₄ to C₄₀ cyclic olefins may be strained or unstrained, monocyclic or polycyclic, and may optionally include heteroatoms and or one or more functional groups.

Exemplary C₂ to C₄₀ olefin monomers and optional comonomers may include ethylene, propylene, butene, pentene, hexene, heptene, octene, nonene, decene, undecene, dodecene, norbornene, ethylidenenorbornene, vinylnorbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof, such as hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbornene, norbornadiene, and their respective homologs and derivatives, such as norbornene, norbornadiene, and dicyclopentadiene. For some pre-catalysts, a diene with formula CₙH₍ₙ₋₂₎ (n=4 to 30), conjugated or non-conjugated, can also serve as the comonomer, such as butadiene, 2-methyl-butadiene, 1,3-pentadiene, 1,4-pentadiene, 2-methyl-1,4-pentadiene, 3-methyl-1,4-pentadiene, 1,4-hexadiene, 1,5-hexadiene, 5-methyl-1,4-hexadiene, 2-methyl-1,5-hexadiene, 1,4-heptadiene, 1,5-heptadiene, 1,6-heptadiene, 5-methyl-1,4-heptadiene, 6-methyl-1,5-heptadiene, 2-methyl-1,6-heptadiene, and the likes.

Polymerization processes of the present disclosure can be carried out in any suitable manner. Any suitable suspension, homogeneous, bulk, solution, slurry, or gas phase polymerization process can be used. Such processes can be run in a batch, semi-batch, or continuous mode. Homogeneous polymerization processes and slurry processes can be employed. (A homogeneous polymerization process is defined to be a process where at least 90 wt % of the product is soluble in the reaction media.) A homogeneous polymerization process can be a bulk homogeneous process. (A bulk process is defined to be a process where monomer concentration in all feeds to the reactor is 70 volume % or more.) Alternately, no diluent is present or added in the reaction medium, (except for the small amounts used as the carrier for the catalyst system or other additives, or amounts found with the monomer; e.g., propane in propylene). In another embodiment, the process is a slurry process. As used herein, the term “slurry polymerization process” means a polymerization process where a supported catalyst is employed and monomers are polymerized on the supported catalyst particles. At least 95 wt % of polymer products derived from the supported catalyst are in granular form as solid particles (not dissolved in the diluent).

Suitable diluents for polymerization may include non-coordinating, inert liquids. Examples of diluents for polymerization may include straight and branched-chain hydrocarbons, such as isobutane, butane, pentane, isopentane, hexanes, isohexane, heptane, octane, dodecane, and mixtures thereof, cyclic and alicyclic hydrocarbons, such as cyclohexane, cycloheptane, methylcyclohexane, methylcycloheptane, and mixtures thereof, such as can be found commercially (e.g., Isopar™); perhalogenated hydrocarbons, such as perfluorinated C₄ to C₁₀ alkanes, chlorobenzene, and aromatic and alkylsubstituted aromatic compounds, such as benzene, toluene, mesitylene, and xylene. Suitable diluents may also include liquid olefins which may act as monomers or comonomers including ethylene, propylene, 1-butene, 1-hexene, 1-pentene, 3-methyl-1-pentene, 4-methyl-1-pentene, 1-octene, 1-decene, and mixtures thereof. In at least one embodiment, aliphatic hydrocarbon diluents are used as the diluent, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof. In another embodiment, the diluent is not aromatic, such as aromatics are present in the diluent at less than 1 wt %, such as less than 0.5 wt %, such as 0 wt % based upon the weight of the diluents.

In at least one embodiment, a feedstream to the reactor has a feed concentration of the monomers and comonomers for the polymerization is 60 vol % diluent or less, such as 40 vol % or less, such as 20 vol % or less, based on the total volume of the feedstream. In at least one embodiment, the polymerization is run in a bulk process.

Polymerizations can be run at any temperature and or pressure suitable to obtain the desired polymers. Suitable temperatures for solution polymerization include a temperature of about 50° C. to about 200° C., such as about 60° C. to about 180° C., such as about 65° C. to about 160° C., such as about 80° C. to about 150° C., such as about 85° C. to about 140° C. Suitable temperatures for slurry- or gas-phase polymerization include a temperature of about 50° C. to about 120° C., such as about 60° C. to about 110° C., such as about 65° C. to about 100° C., such as about 70° C. to about 85° C., such as about 75° C. to about 80° C. Polymerizations can be run at a pressure of about 0.1 MPa to about 25 MPa, such as about 0.45 MPa to about 6 MPa, or about 0.5 MPa to about 4 MPa.

In a suitable polymerization, the run time of the reaction can be up to about 300 minutes, such as about 5 minutes to about 250 minutes, such as about 10 minutes to about 120 minutes, such as about 20 minutes to about 90 minutes, such as about 30 minutes to about 60 minutes. In a continuous process the run time may be the average residence time of the reactor. In at least one embodiment, the run time of the reaction is up to about 45 minutes. In a continuous process the run time may be the average residence time of the reactor.

In at least one embodiment, hydrogen is present in the polymerization reactor at a partial pressure of about 0.001 psig to about 50 psig (0.007 kPa to 345 kPa), such as about 0.01 psig to about 25 psig (0.07 kPa to 172 kPa), such as about 0.1 psig to about 10 psig (0.7 kPa to 70 kPa).

In at least one embodiment, the hydrogen content is about 0.0001 ppm to about 2,000 ppm, such as about 0.0001 ppm to about 1,500 ppm, such as about 0.0001 ppm to about 1,000 ppm, such as about 0.0001 ppm to about 500 ppm. Alternately, hydrogen can be present at zero ppm.

In at least one embodiment, MAO can be present at zero mol %, alternately the MAO can be present at a molar ratio of aluminum to transition metal less than 500:1, such as less than 300:1, such as less than 100:1, such as less than 1:1.

Unless otherwise indicated, “catalyst productivity” is a measure of how many grams of polymer (P) are produced using a polymerization catalyst comprising W g of catalyst (cat), over a period of time of T hours; and may be expressed by the following formula: P/(T×W) and expressed in units of gPgcat⁻¹hr⁻¹. Unless otherwise indicated, “catalyst activity” is a measure of how active the catalyst is and is reported as the mass of product polymer (P) produced per mole of catalyst (cat) used (kgP/molcat) for solution MAO derived catalyst system or as the mass of product polymer (P) produced per mass of catalyst (cat) used (kgP/gcat or gP/gcat) for solution, solid, or supported MAO derived catalyst systems. Catalyst activity may also be expressed over a period of time T of hours and reported as the mass of product polymer (P) produced per mole or millimole of catalyst (cat) used and expressed in units of gPmmolcat⁻¹hr⁻¹ for solution or solid MAO as the activator and in units of kgPgcat⁻¹hr⁻¹ for solution, solid, or supported MAO as the activator.

In at least one embodiment, according to the present disclosure, a solution catalyst system with TMA free solution MAO as the activator has a catalyst activity of greater than about 10 to 1,000 kgPgcat⁻¹hr⁻¹, such as greater than about 20 kgPgcat⁻¹hr⁻¹, such as greater than about 30 kgPgcat⁻¹hr⁻¹; such as about 100 kgPgcat⁻¹hr⁻¹ to about 300 kgPgcat⁻¹hr⁻¹; a TMA free supported MAO derived finished catalyst system used in slurry- or gas-phase polymerization has a catalyst activity of greater than about 3 to 30 kgPgcat⁻¹hr⁻¹, such as about 4 kgPgcat⁻¹hr⁻¹ to about 20 kgPgcat⁻¹hr⁻¹, such as about 6 kgPgcat⁻¹hr⁻¹ to about 15 kgPgcat⁻¹hr⁻¹, such as about 8 kgPgcat⁻¹hr⁻¹ to about 10 kgPgcat⁻¹hr⁻¹; and a TMA free solid MAO self-supported catalyst system with the activity in between the solution polymerization and supported catalyst polymerization (slurry- and gas-phase polymerization).

In at least one embodiment, for solution polymerization, the catalyst residence time in a reactor can be about 10 minutes to about 120 minutes, such as about 20 minutes to about 90 minutes, such as about 30 minutes to about 60 minutes; for solution polymerization, the catalyst residence time in a reactor can be about 10 minutes to about 120 minutes, such as about 20 minutes to about 90 minutes, such as about 30 minutes to about 60 minutes; for supported catalyst polymerization, e.g., slurry- or gas-phase polymerization, the catalyst residence time in a reactor can be about 10 minutes to about 240 minutes, such as about 30 minutes to about 120 minutes, such as about 60 minutes to about 90 minutes; and for the self-supported MAO derived catalyst system; the residence time in a slurry- or gas-phase polymerization reactor is similar to the supported catalyst system.

In at least one embodiment, the polymerization: 1) is conducted at temperatures of about 0° C. to about 300° C. (such as about 25° C. to about 250° C., such as about 50° C. to about 160° C., such as about 80° C. to about 140° C.); 2) is conducted at a pressure of atmospheric pressure to about 10 MPa (such as about 0.35 MPa to about 10 MPa, such as about 0.45 MPa to about 6 MPa, such as about 0.5 MPa to about 4 MPa); 3) is conducted without an aliphatic hydrocarbon diluent, such as in a gas phase reactor, or with the monomer also serves as a diluent, such as in a slurry reactor with propylene as the monomer and diluent, or in an aliphatic hydrocarbon diluent, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof; such as where aromatics are present in the diluent at less than 1 wt %, such as less than 0.5 wt %, such as at 0 wt % based upon the weight of the diluents for solution or slurry polymerization; 4) wherein the catalyst system used in the polymerization comprises less than 0.5 mol %, such as the MAO is present at a molar ratio of aluminum to transition metal less than 500:1, such as less than 300:1, such as less than 100:1, such as less than 1:1; 5) the polymerization occurs in at least one reaction zone; 6) optionally scavengers (such as trialkyl aluminum compounds) are absent (e.g., present at zero mol %, alternately the scavenger is present at a molar ratio of scavenger metal to transition metal of less than 100:1, such as less than 50:1, such as less than 15:1, such as less than 10:1); and 7) optionally hydrogen is present in the polymerization reactor at a partial pressure of about 0.001 psig to about 50 psig (0.007 kPa to 345 kPa) (such as about 0.01 psig to about 25 psig (0.07 kPa to 172 kPa), such as about 0.1 psig to about 10 psig (0.7 kPa to 70 kPa)). In at least one embodiment, the catalyst system used in the polymerization includes more than one pre-catalyst compound. A “reaction zone” also referred to as a “polymerization zone” is a vessel where polymerization takes place, for example a stirred-tank reactor or a loop reactor. When multiple reactors are used in a continuous polymerization process, each reactor is considered as a separate polymerization zone. For a multi-stage polymerization in a batch polymerization process, each polymerization stage is considered as a separate polymerization zone. In at least one embodiment, the polymerization occurs in one reaction zone or multiple reaction zones. Room temperature is 23° C. unless otherwise noted.

Other additives may also be used in the polymerization, as desired, such as one or more scavengers, hydrogen, aluminum alkyls, or chain transfer agents such as higher alkyl modified MAO, a compound represented by the formula AlR₃ or ZnR₂ (where each R is, independently, a C₁-C₈ aliphatic radical, such as methyl, ethyl, propyl, butyl, pentyl, hexyl octyl or an isomer thereof) or a combination thereof, such as diethyl zinc, MAO, trimethylaluminum, triisobutylaluminum, trioctylaluminum, or a combination thereof. Other additives such as reactor static electron removers or anti-fouling agents, such as Evonik S202 or Atmer™ antistatic agent, may also added catalyst preparation, post-catalyst treatment, or added during or after polymerization.

### Polyolefin Products

The present disclosure also relates to compositions of matter produced by the methods described herein. The processes described herein may be used to produce polymers of olefins or mixtures of olefins. Polymers that may be prepared include polyethylene, polypropylene, homopolymers of C₄-C₂₀ olefins, copolymers of C₄-C₂₀ olefins, copolymers of ethylene with C₃-C₂₀ olefins, copolymers of propylene with C₄-C₂₀ olefins, terpolymers of C₄-C₂₀ olefins, terpolymers of ethylene and propylene with C₄-C₂₀ olefins, and terpolymers of ethylene and propylene with 5-ethylidene-2-norbornene. The processes described herein may be used to produce polymers such as HDPE, MDPE, LDPE, or LLDPE with butene, hexene, or octene as the comonomer to turn the polymer density; such as iPP, sPP, or aPP from different stereo- or regio-regulation on the pre-catalysts; such as random copolymer plastomers from propylene rich ethylene copolymers with ethylene content not more than 30% or ethylene rich propylene copolymers with propylene content not more that 30%, ethylene propylene elastomers (rubber)s, i.e., EP rubbers, with ethylene and propylene close to 50:50, such as 30:70, 40:60, 50:50, 60:40, or 70:30, such as ethylene-butadiene copolymers from solution polymerization; such as impact copolymers, e.g., reactor made iPP-EPR, iPP-EBR (ethylene butylene rubber), iPP-EHR (ethylene hexene rubber) biphasic copolymers from supported catalyst polymerization, such as EPDM (vulcanizable ethylene propylene diene ter-polymer), EBDM (vulcanizable ethylene butylene diene ter-polymer), EHDM (vulcanizable ethylene hexene diene ter-polymer) from solution polymerization, or such as reactor made vulcanizable iPP-EPDM, iPP-EBDM, iPP-EHDM biphasic copolymers. Heterophasic copolymers more than two phases can be obtained from more reaction zones, such as a PE-RCP-EPR or iPP-RCP-EPR tri-phasic copolymers.

In some embodiments, the melt index (MI) for PE based polymers is from 0.01 to about 50 g/10 min, such as 0.1 to 10 g/10 min, such as 0.5 to 5 g/10 min, such as 1-2 g/10 min; or the melt flow rate or mass flow rate (MFR) for PP based polymers is from 0.01 to 2000 g/10 min, such as 0.05 to 1000 g/10 min, such as 0.1 to 500 g/10 min, such as 0.5 to 100 g/10 min, such as 2-50 g/10 min, with the measurement method described in the similar standards ASTM D1238 and ISO 1133.

In some embodiments, the weight average molecular weight Mw of the polymer products is in the range of 10k to 2000k measured by GPC methods, such as 50k to 1000k, such as 60k to 500k, such as 100k to 300k; and the molecular weight distribution (MWD) or polydispersity index (PDI) is 1.5 to 30, such as 2 to 10, such as 2.5 to 9, which can have single modal or multiple modal distributions, for example, bimodal distributions from a two-stage polymerization process in two different reaction zones or from a one-stage polymerization process in one reaction zone with a catalyst system containing two different pre-catalyst compounds.

In some embodiments, the comonomer distribution in the polymer products can be a conventional distribution, i.e., the comonomer incorporation is getting less with the increase of Mw; can be a flat distribution, i.e., similar incorporation with different molecular weight compositions; or can be a broad orthogonal comonomer distribution, i.e., the comonomer incorporation is getting more with the increase of Mw.

### EXPERIMENTAL

In studies to improve upon prior technology (e.g., U.S. Pat. No. 6,368,999), the fluorinated silica support containing Si—F units were found to react with free TMA in MAO to become more active supported MAO. The fluorination agents used to fluorinate the silica that also contain Si—F units, e.g., (NH₄)₂SiF₆, were therefore tested and found to react with free TMA in either a supported or an unsupported MAO system (e.g., a solution system) as well. It has now been confirmed that, with the treatment of a Si—F containing compound, either the fluorinated silica or the fluorination agent used for the fluorination of the silica, a regular MAO system with required free TMA, supported or unsupported, can be converted to an active MAO system with low or undetectable free TMA content through the matching of the total THF extractable TMA content in the regular MAO system with the Si—F units without the compromise of the MAO activation efficiency.

All reactions were carried out under a purified nitrogen atmosphere using standard glovebox, high vacuum or Schlenk techniques, in a CELSTIR reactor unless otherwise noted. All solvents used were anhydrous, de-oxygenated and purified according to known procedures. All starting materials were either purchased from Aldrich and purified prior to use or prepared according to procedures known to those skilled in the art. Silica ES70 was obtained from PQ Corporation (now Ecovyst). MAO was obtained as a 30 wt % MAO in toluene solution from W. R. Grace (e.g., 13.6 wt % Al or 5.04 mmol Al/g). Deuterated solvents were obtained from Cambridge Isotope Laboratories (Andover, Mass.) and dried over 3 A molecular sieves. All ¹H NMR data were collected on a Broker AVANCE III 400 MHz spectrometer running Topspin™ 3.0 software at room temperature (RT).

### Example 1

### Quantification of Total THF Extractable TMA Contents in a Commercial MAO Solution

The total TMA content including the coordinated and free TMA in either a supported or unsupported MAO composition can be quantified through a THF solvent treatment to convert both the coordinated and free TMA to AlMe₃(THF) as the major product and AlMe₂(THF)₂⁺ as a minor product according to Scheme 8 reaction. The total TMA is therefore the sum of AlMe₃(THF) and AlMe₂(THF)₂⁺ (converted back to TMA in calculation) and can be quantified with the ¹H NMR methods below with the solvent toluene as the internal standard for solution MAO or with an added inert compound as the internal standard for ether a solution MAO, a solid MAO, or a supported MAO.

Chemicals: W. R. Grace MAO 30% toluene solution (Al=13.6 wt % (5.0 mmol/g), MAO=26.6 wt %, total TMA (coordinated and free)=4.76 wt % from the Certificate of Analysis (COA) of the MAO product) and THF-d8 NMR solvent (Cambridge Isotope) treated with 3 A molecular sieves.

If the MAO for studies is within 3 months of storage at <−20° C., the total TMA wt % in the MAO product COA can be used with no significant error. For a MAO solution under a longer storage or frequent changing of storage temperature (e.g., taking out of freezer a portion of MAO and returning to the freezer), the total THF extractable TMA content may increase significantly due to the gelation process that releases TMA (Scheme 1).

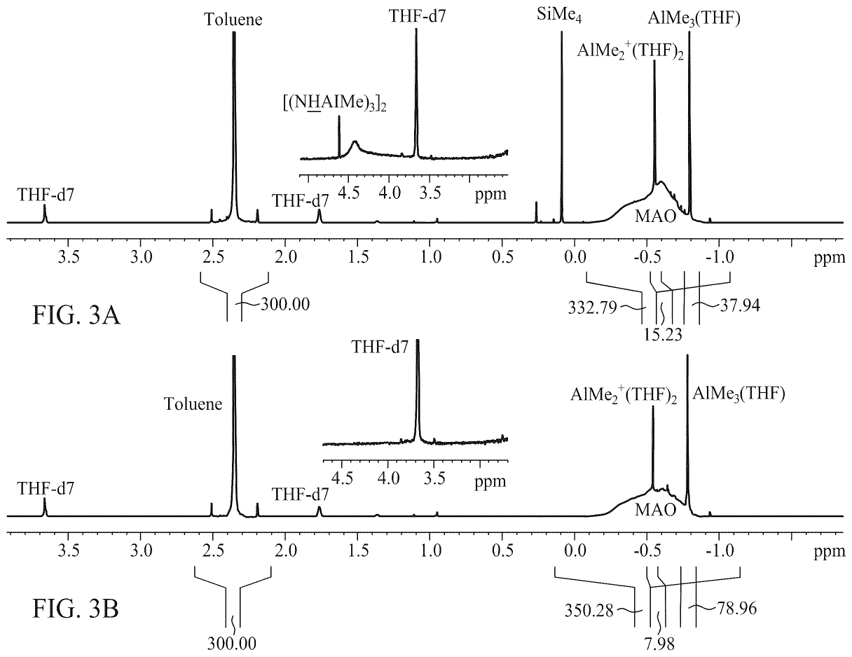

Procedure: In the drybox, fill an oven dried 5 mm NMR tube with ~0.5 inch MAO solution, followed by ~1.5 inch THF-d8 solvent, shake well, and then take the ¹H NMR spectrum of the sample using D1=30 s, ns=4. A longer relaxation time D1 may be more accurate but 30 seconds is long enough to obtain <2 wt % error of quantitative toluene CH₃ and Al—CH₃ signals. The ¹H NMR spectrum in the region from toluene Me to Al-Me is shown in FIG. 3 bottom spectrum (FIG. 3B).

Processing: integrate the peak of CH₃ on toluene, the total Al—CH₃ area, the peak of AlMe₂(THF)₂⁺, and the peak of AlMe₃(THF); set the integral of CH₃ of toluene as 300 (set as 300 instead of 3, the CH₃ proton number, in order to have at least 3 digit accuracy in the spectrum printout because the numbers after the decimal point may be cut off) and record all Al-Me species integral including MAO, AlMe₃(THF) and AlMe₂(THF)₂⁺ as 350.28, AlMe₃(THF) integral as 78.96, AlMe²(THF)₂⁺ integral as 7.98, and ignore minor species such as the processing oil that is usually present but in small amount, e.g., <1 wt %. The MAO formula without coordinated TMA is Al₁O_{0.78}Me_{1.44} based on the COA to give a Mw 61.1. The MAO integral is 350.28−78.96−7.98=263.34. The proton number in MAO is 1.44*3=4.32. Because AlMe₂⁺ is counted as TMA because it is generated from coordinated TMA. The calculation results are listed in Table 1.

TABLE 1
Total THF extractable TMA Calculation

| Species | Integral | Proton# | Mw | Weight Portion¹ | Wt %² | |
|---|---|---|---|---|---|---|
| Toluene | 300 | 3 | 92.1 | 9210 | 67.40 | |
| MAO | 263.34 | 4.32 | 61.1 | 3726.3 | 27.27 | Total TMA |
| AlMe₃ | 78.96 | 9 | 72.1 | 632.6 | 4.63 | 5.33% |
| AlMe₂⁺ | 7.98 | 6 | 72.1³ | 95.9 | 0.70 | |
| | | | Total | 13664.8 | 100 | |

¹Weight portion, = Mw*Integral/Proton#, is an individual species' weight contribution;
²wt % = individual weight portion/total weight portions* 100%;
³AlMe₂⁺ is derived from the coordinated TMA and therefore is converted back to TMA.

It can be seen that now the total TMA content is increased from 4.76 wt % (COA) to 5.33 wt %, an indication of low degree gelation.

### Example 2

### Quantification of Coordinated TMA in a Commercial MAO Solution

The quantification of coordinated TMA is based on the reaction (Scheme 11) below:

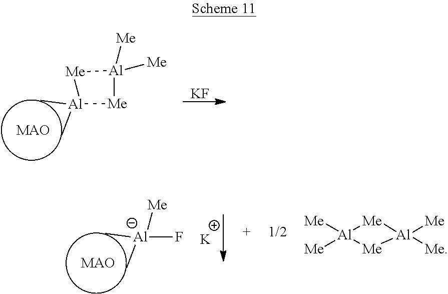

In the reaction above, KF can precipitate MAO as a clathrate phase to separate from the solution phases containing free TMA through the replacement of the coordinated TMA to form an ionic MAO composition. Applying a largely excess, known amount of KF (W1^{KF}) to an MAO solution and isolating the left KF (W2^{KF}) after the reaction, the KF consumption can be calculated as W1^{KF}−W2^{KF}, which is an indirect quantification method for the coordinated TMA content.

Chemicals: KF (Aldrich), 10 g in a 50 mL round bottom flask dried in an oil bath at 110° C. under vacuum for 4 hours; the same MAO solution and THF-d8 used for Example 1.

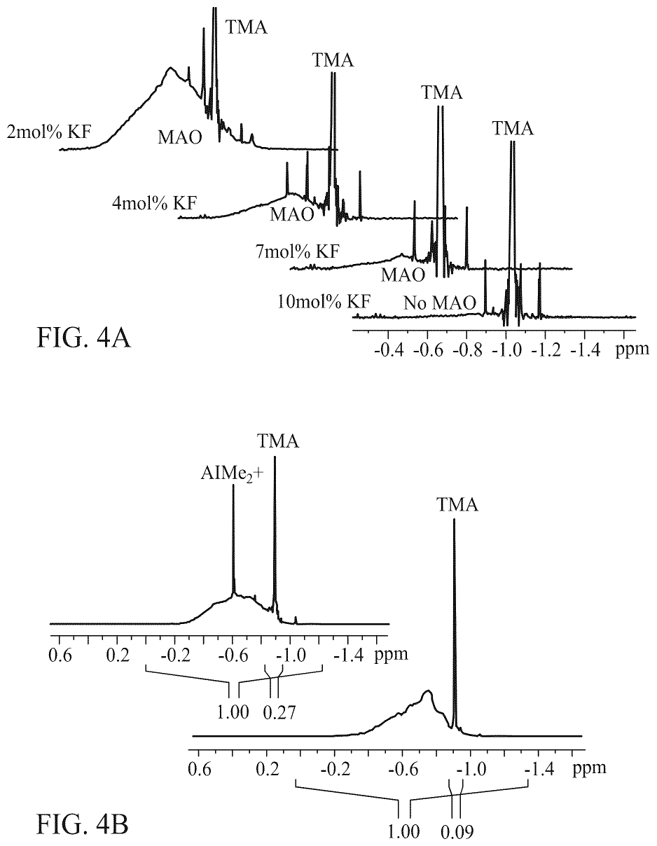

Procedure: In the drybox, each of 4 oven-dried vials (20 mL) were charged with 10.0 g MAO solution (51.1 mmol Al calculated based on Table 1 results), and then with KF (58.1 g/mol) 59.6 mg (2 mol % based on total Al), 118.9 mg (4 mol % based on total Al), 207.6 mg (7 mol % based on total Al), and 298 mg (10 mol % based on total Al), respectively. Place the vials on a shaker to shake for overnight. Remove the vials from the shaker and allow the clathrate phases to settle for 10 hours. KF in vials with 2 mol %, 4 mol %, and 7 mol % treatment all disappeared but the vial with 10 mol % treatment showed left-over KF. All upper phase solutions of the 4 vials were analyzed with ¹H NMR spectroscopy in THF-d8 NMR solvent and the spectra were compared in the Al-Me region shown in FIG. 4A that shows reducing MAO concentrations. The clathrate phase from the sample with complete conversion of regular MAO to ionic MAO (vial with 10 mmol % KF treatment) was also analyzed with ¹H NMR spectroscopy in THF-d8 NMR solvent and the spectrum of the Al-Me region is shown in FIG. 4B with the mother MAO solution for comparison, which shows the absence of AlMe₂⁺ species for the ionic MAO, meaning all coordinated TMA is removed by KF as a confirmation that the coordinated TMA is the source of AlMe₂⁺. The left-over KF in the vial of 10 mol % treatment was collected with a pre-weighted frit filter, which was washed with 3×10 mL dried toluene and 30 mL dried isohexane, then weighed to give 75.3 mg (2.54 mol % based on total Al) unreacted KF, giving the coordinated TMA in the MAO solution=10−2.5=7.5 mol %. The total Al % is 13.8 wt % and the total TMA (free+coordinated) is 5.33 wt % based on Table 1. The total TMA can be converted to 2.00 wt % Al to give 14.5 mol %.

### Example 3

(NH₄)₂SiF₆ Treatment of a Commercial MAO Solution

This example uses (NH₄)₂SiF₆ as the electron withdrawing compound to convert the majority of total TMA into AlMe₂F. The NMR reaction stoichiometry studies suggest that 1 eq. of (NH₄)₂SiF₆ is able to consume 8 eq. TMA to form 6 eq. AlMe₂F and a species having 2 eq. N—H and 2 eq. Al-Me, which is likely a species with 2 6-membered rings to satisfy 3-coordination of H and 4-coordination of Al as the stable product, although whether it is the exact structure no not doesn't influence the reaction stoichiometry (Scheme 12):

$${( {NH}_{4} )}_{2} {SiF}_{6} + 8 {AlMe}_{3} ( or 4 {( {AlMe}_{3} )}_{2} ) = 6 {AlMe}_{2} F + 2 / {6 [ {( NHAlMe )}_{3} ]}_{2} + 6 {CH}_{4} + {SiMe}_{4} . \qquad Scheme 12$$

The solution MAO after quantification of total TMA was therefore treated with ⅛ eq. of (NH₄)₂SiF₆ relative to the total TMA content.

Chemicals: commercial MAO solution same as above; (NH₄)₂SiF₆ (Aldrich, vacuum drying overnight at ambient, Mw=178.17).

Procedure: 40 g MAO solution (204 mmol Al) was charged in a 6 oz bottle with a stir bar, 0.66 g (NH₄)₂SiF₆ (3.70 mmol) was added slowly to the MAO solution under vigorously stirring. After 1 hour of agitation, all the solid disappeared. The solution was sampled for ¹H NMR with THF-d8 as the NMR solvent. FIG. 3 shows the treated MAO spectrum (FIG. 3A) comparing with the mother MAO solution spectrum (FIG. 3B) in the Al-Me region.

It can be seen from the FIGS. 3A-B NMR spectra that after the electron withdrawing compound treatment, the THF extractable TMA (AlMe₃(THF)) is reduced from an integral of 78.96 (3B) to 37.94 (3A) and the AlMe₂(THF)₂⁺ species integral is increased from 7.98 (3B) to 15.23 (3A). The THF extractable TMA is believed to be from the coordinated AlMe₂F according to the reaction below (Scheme 13), which shows AlMe₂F as a poor free TMA source if no donor is around due to the strong electron withdrawing group F that doesn't favor the F bonded Al to become coordinately unsaturated (left reaction).

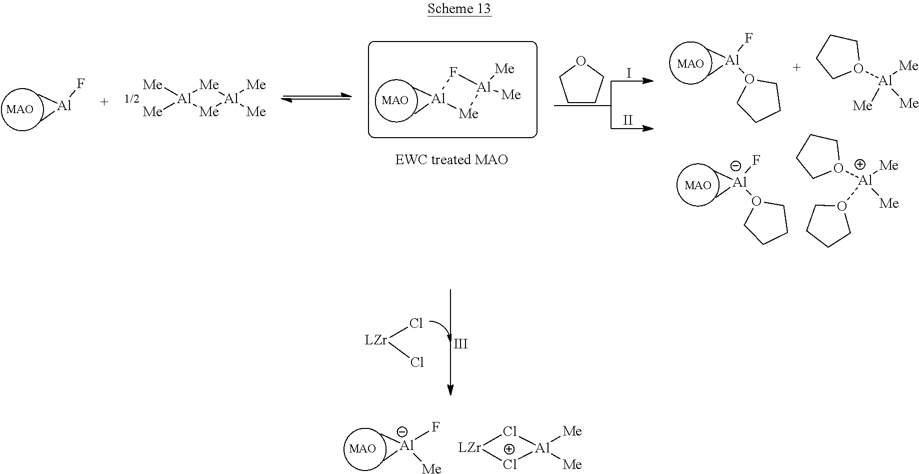

Scheme 13 also helps understanding of the observed EWC treated MAO chemistry that a monodentate donor such as THF can either replace the AlMe₃ form from the AlMe₂ of the coordinated AlMe₂F with a nearby Me directly bonded to the Al of the coordinated AlMe₂F to form the THF coordinated TMA (AlMe₃(THF) in FIG. 3A) shown as route I or extract AlMe₂⁺ from the coordinated AlMe₂F to form (AlMe₂+(THF)₂ in FIG. 3A) shown as route II, whereas a catalyst precursor with two leaving donor groups serving as a chelating agent can only extract out AlMe₂⁺ from the coordinated AlMe₂F to form an ion-pair containing a bimetallic cation of the catalyst precursor-AlMe₂⁺ complex shown as route III.

### Examples 4-1, 4-2, 4-3

### Small Scale Solution Propylene Polymerizations

Polymerization Reagents: Pre-catalyst solutions were made using a given transition metal complex dissolved in toluene (ExxonMobil Chemical-anhydrous, stored under N₂) (98%), typically at a concentration of 0.5 mmol/L. Activation of the complexes was performed using various methylaluminoxes (MAO) including commercial methylalumoxane (cMAO, 10 wt % in toluene, Albemarle Corp.—control) and F-MAO. Complex 6 can be prepared as described in U.S. Pat. No. 11,254,763.

All MAOs were typically used as a 0.2 wt % toluene solution. Micromoles of MAO reported below are based on the micromoles of aluminum in MAO, which has a formula weight of 58.0 grams/mole.

Solvents, polymerization grade toluene and/or isohexanes were supplied by ExxonMobil Chemical Co. and were purified by passage through a series of columns: two 500 cc OXYCLEAR cylinders in series from Labclear (Oakland, Calif), followed by two 500 cc columns in series packed with dried 3 Å molecular sieves (8-12 mesh; Aldrich Chemical Company), and two 500 cc columns in series packed with dried 5 Å molecular sieves (8-12 mesh; Aldrich Chemical Company).

Polymerization grade propylene was purified by passage through a series of columns: 2,250 cc OXICLEAR cylinder from Labclear followed by a 2,250 cc column packed with 3 Å molecular sieves (8-12 mesh; Aldrich Chemical Company), then two 500 cc columns in series packed with 5 Å molecular sieves (8-12 mesh; Aldrich Chemical Company), then a 500 cc column packed with SELEXSORB CD (BASF), and finally a 500 cc column packed with SELEXSORB COS (BASF).

Reactor Description and Preparation: Polymerizations were conducted in an inert atmosphere (N₂) drybox using autoclaves equipped with an external heater for temperature control, glass inserts (internal volume of reactor ~22.5 ml), septum inlets, a regulated supply of nitrogen, ethylene and propylene, and disposable PEEK mechanical stirrers (800 RPM). The autoclaves were prepared by purging with dry nitrogen at 110° C. or 115° C. for 5 hours and then at 25° C. for 5 hours.

### Propylene Polymerizations (PP):

The reactor was prepared as described above, heated to 40° C., and then purged with propylene gas at atmospheric pressure. For MAO-activated runs, toluene, MAO, propylene (1.0 ml unless otherwise listed in the tables) and comonomer (if used) were added via syringe. The reactor was then heated to process temperature (typically 70° C. or 100° C. unless otherwise mentioned) while stirring at 800 RPM. The pre-catalyst solution was added via syringe with the reactor at process conditions. The reactor temperature was monitored and typically maintained within +/−1° C. Polymerizations were halted by addition of approximately 50 psi of an air gas mixture or CO₂ gas to the autoclaves for approximately 30 seconds. The polymerizations were quenched based on a predetermined pressure loss of approximately 8 psi unless specified differently (max quench value in psi) or for a maximum of 30 minutes polymerization time unless specified differently. The reactors were then cooled and vented. The polymers were isolated after solvent removal in-vacuo. Actual quench times are reported. Quench times less than maximum reaction times indicate the reaction quenched with uptake. Yields reported include total weight of polymer and residual catalyst. Catalyst activity is reported as grams of polymer per mmol complex per hour of reaction time (gP/mmol cat·hr). Propylene homopolymerization examples including characterization are summarized in Table 1 below.

Small Scale Polymer Characterization. For analytical testing, polymer sample solutions were prepared by dissolving polymer in 1,2,4-trichlorobenzene (TCB, 99+% purity) containing 2,6-di-tert-butyl-4-methylphenol (BHT, Sigma-Aldrich, 99%) at 165° C. in a shaker oven for approximately 3 hours. The typical concentration of polymer in solution was from 0.1 to 0.9 mg/ml with a BHT concentration of 1.25 mg BHT/ml of TCB. Samples were cooled to 135° C. for testing.

High temperature size exclusion chromatography was performed using an automated “Rapid GPC” system as described in U.S. Pat. Nos. 6,491,816; 6,491,823; 6,475,391; 6,461,515; 6,436,292; 6,406,632; 6,175,409; 6,454,947; 6,260,407; and 6,294,388; each of which is incorporated herein by reference. Molecular weights (weight average molecular weight (Mw), number average molecular weight (Mn), z-average molecular weight (Mz)) and molecular weight distribution (PDI=MWD=Mw/Mn), which is also sometimes referred to as the polydispersity (PDI) of the polymer, were measured by Gel Permeation Chromatography using a Symyx Technology GPC equipped with evaporative light scattering detector (ELSD) and calibrated using polystyrene standards (Polymer Laboratories: Polystyrene Calibration Kit S-M-10: Mp (peak Mw) between 5,000 and 3,390,000). Alternatively, samples were measured by Gel Permeation Chromatography using a Symyx Technology GPC equipped with dual wavelength infrared detector and calibrated using polystyrene standards (Polymer Laboratories: Polystyrene Calibration Kit S-M-10: Mp (peak Mw) between 580 and 3,039,000). Samples (250 μL of a polymer solution in TCB were injected into the system) were run at an eluent flow rate of 2.0 ml/minute (135° C. sample temperatures, 165° C. oven/columns) using three Polymer Laboratories: PLgel 10 μm Mixed-B 300×7.5 mm columns in series. No column spreading corrections were employed. Numerical analyses were performed using Epoch® software available from Symyx Technologies or Automation Studio software available from Freeslate. The molecular weights obtained are relative to linear polystyrene standards. Molecular weight data is reported in the Tables below under the headings Mn, Mw, Mz and PDI as defined above.

Differential Scanning Calorimetry (DSC) measurements were performed on a TA-Q100 instrument to determine the melting point of the polymers. Samples were pre-annealed at 220° C. for 15 minutes (first melt) and then allowed to cool to room temperature overnight. The samples were then heated to 220° C. at a rate of 100° C./minute (2^{nd} melt) and then cooled at a rate of 50° C./minute. Melting points were collected during the heating period. Values reported are the peak melting temperatures and for the purposes of this disclosure referred to as 2^{nd} melts. The results are reported in the Tables under the heading, Tₘ.

Table 2. Propylene polymerization runs. Standard conditions include 0.015 micromoles of pre-catalyst Complex 6 (see above), and the indicated type and amount of activator in the Table. 1 ml propylene and a total of 4.1 ml of solvents were used. The reaction was heated to either 70° C. or 100° C., stirred at 800 rpm, and the reaction was quenched after 8 psi of pressure loss or a maximum of 30 minutes of reaction time if quench pressure not met.

TABLE 2
Propylene homo-polymerizations

| | | | | | | | Activity | | | |
|---|---|---|---|---|---|---|---|---|---|---|
| | Activator | | Al/Zr | T | Quench | Yield | (g/mmol | | | Tm |
| Example # | Type | μmol | (mol) | (° C.) | time (s) | (g) | cat · hr) | Mw | PDI | (° C.) |
| Ex 4-1 | TF-MAO | 3 | 200 | 100 | 177 | 0.1260 | 170,847 | 370,462 | 1.73 | 145.8 |
| Ex 4-2 | TF-MAO | 3 | 200 | 100 | 216 | 0.1627 | 180,778 | 367,049 | 1.44 | 145.5 |
| Ex 4-3 | TF-MAO | 3 | 200 | 100 | 162 | 0.1303 | 193,037 | 342,026 | 1.64 | 145.8 |
| Comp. Ex 1-1 | MAO | 3 | 200 | 100 | 151 | 0.0745 | 118,411 | 309,824 | 1.73 | 145.3 |
| Comp. Ex 1-2 | MAO | 3 | 200 | 100 | 216 | 0.1080 | 120,000 | 320,936 | 1.66 | 145.5 |
| Comp. Ex 1-3 | MAO | 3 | 200 | 100 | 123 | 0.0957 | 186,732 | 304,781 | 1.61 | 145.5 |

Data in Table 2 indicates that, even with a very short contact time of the pre-catalyst and MAO (see catalyst solution and polymerization procedures above) and a very short polymerization time (quench time) to fit the high throughput polymerization design, the activities for the TMA free MAO (TF-MAO) are significantly higher than for the regular MAO. With a longer pre-catalyst and MAO contact time, e.g., in the supported catalyst cases below, the activity difference is larger. And likely the significantly higher Mw for TF-MAO than for MAO is due to the absence of free TMA capable of chain transfer in the TF-MAO, which indicates that the manipulation of the free TMA concentration in an MAO based system can provide one more control knob for obtaining a desired polymer molecular weight.

### Examples 5-7 and Comparative Examples 2-7

### Solution Ethylene-Butadiene Co-Polymerization

### Polymerization Vessel: Symyx Discovery Tools TI-6AL-4V High Pressure Parallel Reactor

Chemicals: Complex 34, 35, and 36 were prepared as described in U.S. Pat. No. 11,254,763; iBu₂AlH (DIBAL) (neat, Nouryon); [HNMe₂Ph]⁺B(C₆F₅)₄⁻ (Boulder Scientifics); MAO (W. R Grace 30% MAO, Al=13.5%); TF-MAO (from Example 3); toluene (Aldrich, stored with 3A molecular sieves overnight); ethylene (plant line purified with standard drying/purifying columns); butadiene (BD) (Aldrich, cooled in the freezer of a drybox set at −20° C., poured into cold toluene to make a 10 wt % solution and stored with active alumina overnight).

Procedure: Each of the pre-catalysts was activated upon addition of iBu₂AlH (DIBAL, 20 eq. to pre-catalyst metal) and [HNMe₂Ph]⁺B(C₆F₅)₄⁻ (1.2 eq. to pre-catalyst metal), or MAO (100 eq. to pre-catalyst metal), or TF-MAO (100 eq. to pre-catalyst metal). After pre-catalysts and activators were stirred for about 10 minutes, the solution of butadiene in toluene (10 wt %) was added (~2500 butadiene eq./catalyst) and then the reactor equipped with six 20 mL vials was sealed. The reactor was heated to 100° C., stirred at 225 rpm, and then pressurized with ethylene (250 psi, Sigma, 99.5%). The reactor was re-pressurized when the pressure dropped below 240 psi during the first hour. After 4 hours the reactor was cooled and then depressurized. The polymer products were isolation from each vial by precipitating and washing with acetone and methanol. Then the solids were filtered out and washed with copious acetone and methanol. The polymer samples were then dried in a 50° C. vacuum oven for 18 hours.

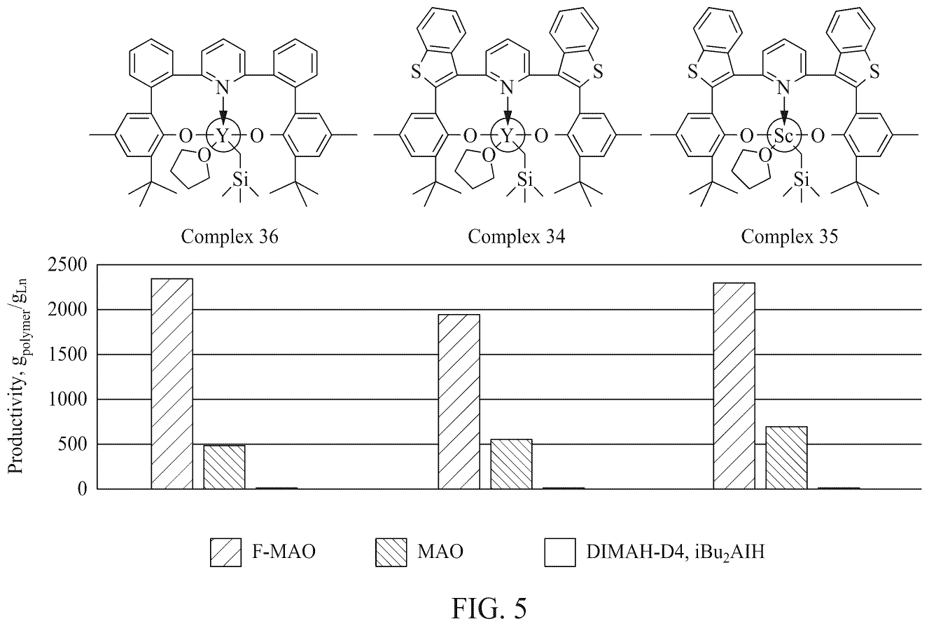

No product was formed upon activation the copolymerization reaction mixture by iBu₂AlH—[HNMe₂Ph]⁺B(C₆F₅)₄⁻ activator system (Table 3, Comparative Example 1, 4 and 7). The formation of ethylene-rich copolymers in low yields (up to 43.5 kg_{product}/mol_{RE}) was observed for the regular MAO-activated reaction mixtures (runs 2, 5 and 8). The activity of the three pre-catalysts can be significantly boosted to up to 239.4 kg_{product}/mol_{M} when TMA free MAO (TF-MAO) is employed (runs 3, 6 and 9), the graphic illustration is shown in FIG. 5.

TABLE 3
Polymerization data for Pre-Catalysts Complex 34, 35, and 36*

| | Pre- | | | BD | | |
|---|---|---|---|---|---|---|
| | catalyst | | Activity | (1, 4/1, 2)** | | |
| Example # | Complex- | Activator | (kg/mol_{M}) | mol % | M_{w}, kDa | PDI |
| Comp Ex 2 | 36 | iBu₂AlH- | 0 | | | |
| | | [HNMe₂Ph]⁺B(C₆F₅)₄⁻ | | | | |
| Comp Ex 3 | 36 | MAO | 43.5 | (0.7/0.4) | | |
| Ex 5 | 36 | TF-MAO | 239.4 | (0.1/0.1) | 163 | 2.93 |
| Comp Ex 4 | 34 | iBu₂AlH- | 0 | | | |
| | | [HNMe₂Ph]⁺B(C(F₅)₄⁻ | | | | |
| Comp Ex 5 | 34 | MAO | 25.0 | | 414 | 21.11 |
| Ex 6 | 34 | TF-MAO | 103.4 | | 187 | 3.49 |
| Comp Ex 6 | 35 | iBu₂AlH- | 0 | | | |
| | | [HNMe₂Ph]⁺B(C₆F5)₄⁻ | | | | |
| Comp Ex 7 | 35 | MAO | 5.5 | (0.1/0.3) | | |
| Ex 7 | 35 | TF-MAO | 174 | (0.4/0.2) | 123 | 2.76 |

*Conditions: ca 1 g BD, toluene solution, BD: M = 2500; 240 psi ethylene; 100° C.; 4 hours; 1.2 eq. [HNMe₂Ph]⁺B(C₆F5)₄⁻/20 eq. iBu₂AlH, or 100 eq. MAO, or 100 eq. TF-MAO to the pre-catalyst metal;
**1,4 or 1,2 insertion product

### Comparative Example 8 and Examples 8-12

The examples here used a post-metallocene (Complex 6) to test on a TMA free supported MAO (TF-sMAO) and compare to the regular supported MAO (sMAO).

### Catalyst Preparation:

Chemicals: silica ES70 (Ecovyst (formerly PQ), 400° C. calcination); MAO (W. R. Grace 30% MAO in toluene, Al=13.5 wt %); (NH₄)₂SiF₆ (Aldrich, vacuum drying overnight at ambient, Mw=178.17); Solvents toluene (Aldrich anhydrous, stored over 3A molecular sieves overnight before use) and isohexanes (ExxonMobil plant solvent, stored over 3A molecular sieves overnight before use); Post-metallocene Complex 6 (ExxonMobil lab-made, Mw=945 g/mol).

Example 8-12 Catalyst Preparation Procedure: 2.04 g silica and 12 g toluene in a 20 mL vial Slowly add MAO solution 2.8 g (14 mmol Al, based on 7.0 mmol/g silica charge); heated to 100° C. for 4 hours. Sampled supernate for NMR (no Al-Me species detected); added (NH₄)₂SiF₆ 29.1 mg based on 7 mol F % on Al (14 mmol Al×7%/6×178.12=29.1 mg), shaking for 30 minutes and heated at 70° C. for 20 minutes; filtered and washed with 10×2 toluene and 1×20 g iC6, and dried under vacuum for 30 minutes, yield was 3.0 g (this step eliminated the majority of free TMA); re-slurried 1.0 g sMAO in 4 g toluene, added 31 mg Complex 6 and shake on a shaker for 1 hour; filtered, washed with 2×5 g toluene and 1×10 g iC6, and dried under vacuum for 1 hour. Yield: 1.0 g.

Comparative Example 8 Catalyst Preparation Procedure: same chemicals and similar to procedure above except no (NH₄)₂SiF₆ treatment.

### Salt-Bed Gas-Phase PE Polymerization

Chemicals: NaCl (Fisher S271-10 dehydrated at 180° C. and subjected to several pump/purge cycles and finally passed through a 16-mesh screen prior to use); ES-70 silica (calcined at 875° C.) Supported AlᵢBu₃.

Procedures: A2 L autoclave was heated to 110° C. and purged with N2 for at least 30 minutes. It was charged with dry NaCl 350 g and silica supported AlⁱBu₃ 6 g at 105° C. and stirred for 30 minutes. The temperature was adjusted to 85° C. At a pressure of 2 psig N₂, dry, degassed 1-hexene (2.0 mL) was added to the reactor with a syringe then the reactor was charged with N₂ to a pressure of 20 psig. A mixture of H₂ and N₂ was flowed into reactor (120 SCCM; 10% H₂ in N₂) while stirring the bed. Catalysts indicated in Table 3 were injected into the reactor with ethylene at a pressure of 220 psig; ethylene flow was allowed over the course of the run to maintain constant pressure in the reactor. 1-hexene was fed into the reactor as a ratio to ethylene flow (0.1 g/g). Hydrogen was fed to the reactor as a ratio to ethylene flow (0.5 mg/g). The hydrogen and ethylene ratios were measured by on-line GC analysis. Polymerizations were halted after 1 hour by venting the reactor, cooling to room temperature then exposing to air. The salt was removed by washing with water two times; the polymer was isolated by filtration, briefly washed with acetone, and dried in air for at least two days. The yields from runs of the comparative example 8 using Complex 6 derived finished catalyst from the regular supported MAO and the examples 8-12 using Complex 6 derived finished catalyst from the inventive supported MAO (TF-sMAO) with the activities calculated based on the yields are listed in Table 3.

TABLE 3
2L Salt-Bed Gas-phase PE Polymerization Results

| | | Cat | H₂ pre- | | C₆ pre- | | run | | |
|---|---|---|---|---|---|---|---|---|---|
| | sMAO | Charge | charge | | charge | | time | Yield | Productivity |
| Example | Type | (mg) | (mL) | H₂/C₂ | (mL) | C₆/C₂ | (min) | (g) | (g/g cat/h) |
| Comp. Ex 8 | sMAO | 13.7 | 120 | 0.5 | 2.5 | 0.1 | 60 | 36.5 | 2664 |
| Ex. 8 | TF-sMAO | 13.0 | 120 | 0.5 | 2.5 | 0.1 | 60 | 54.0 | 4154 |
| Ex. 9 | TF-sMAO | 14.1 | 120 | 0.5 | 2.5 | 0.1 | 60 | 53.5 | 3794 |
| Ex. 10 | TF-sMAO | 13.2 | 0 | 0 | 2.5 | 0.1 | 60 | 43.8 | 3318 |
| Ex. 11 | TF-sMAO | 13.7 | 120 | 0.5 | 0 | 0 | 30 | 7.1 | 1036 |
| Ex. 12 | TF-sMAO | 14.0 | 480 | 0 | 2.5 | 0.1 | 60 | 65.0 | 4643 |

Table 3 data indicate that the TF-sMAO-Complex 6 catalyst system is more active can become more active by including hexane; its H₂ response is not as sensitive as metallocenes but the activity is increased with higher H₂ charge.

Overall, MAO and catalyst systems of the present disclosure provide improved catalyst activity and catalyst lifetime for post-metallocene and CGC catalysts. In addition, hydrocarbyl aluminum compounds having strong electron withdrawing atoms or groups can be formed in-situ upon forming the MAO.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including”. Likewise, whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

While the present disclosure has been described with respect to a number of embodiments and examples, those skilled in the art, having benefit of this disclosure, will appreciate that other embodiments can be devised which do not depart from the scope and spirit of the present disclosure.

1. A method of making an alumoxane composition, the method comprising:
introducing an unsupported or supported alumoxane composition with an electron withdrawing compound to form the alumoxane composition, the alumoxane composition having 0 wt % to about 2 wt % Al from free and/or dimeric trihydrocarbyl aluminum compound, based on total aluminum content of the alumoxane composition as determined by titration of the alumoxane composition with tetrahydrofuran, wherein the electron withdrawing compound is:
an inorganic compound having the Formula I 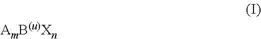
wherein A is an ammonium cation; m=0, 1, or 2, provided that when m=0, B is H or a group 3, 4, 5, 6, 7, 13, 14, 15, 16, or 17 element, and when m is not zero, B is a group 3, 4, 5, 13, 14, or 15 element; u is the valence state of element B and can be 1, 2, 3, or 4; X is a halogen or a pseudo halogen atom or a halogenated aryl or aryloxy group; and n=m+u.

2. The method of claim 1, wherein the inorganic compound of Formula (I) is selected from the group consisting of NH₄BF₄, (NH₄)₂SiF₆, NH₄PF₆, NH₄F, (NH₄)₂TaF₇, NH₄NbF₄, (NH₄)₂GeF₆, (NH₄)₂SmF₆, (NH₄)₂TiF₆, (NH₄)₂ZrF₆, MoF₆, ReF₆, GaF₃, SO₂ClF, F₂, SiF₄, SF₆, ClF₃, ClF₅, BrF₅, IF₇, NF₃, HF, BF₃, B(OC₆F₅)₃, AlF₃, Al(OC₆F₅)₃, NHF₂, NH₄HF₂, and combinations thereof.

3. A method of making an unsupported or supported alumoxane composition, the method comprising:
introducing an unsupported or supported alumoxane composition with an electron withdrawing compound to form the alumoxane composition, the alumoxane composition having 0 wt % to about 2 wt % Al from free and/or dimeric trihydrocarbyl aluminum compound, based on total aluminum content of the alumoxane composition as determined by titration of the unsupported or supported alumoxane composition with tetrahydrofuran, wherein the electron withdrawing compound is:
an organic compound having the Formula (II): 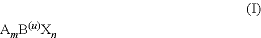
where R is a C₁ to C₁₀ hydrocarbyl group; M is a group 13 or 14 element; o=1 for M=group 13 element; o=2 for M=non-Al group 13 element; and o=1, 2, or 3, for M=group 14 element; X is an electron withdrawing atom or group; u is the valence state of element M 3 or 4; and X is a halogen, pseudo halogen, or a halogenated aryl or aryloxy group.

4. The method of claim 3, wherein the organic compound of Formula (II) is selected from the group consisting of Me₃SiF, Me₂SiF₂, MeSiF₃, Et₃SiF, Et₂SiF₂, EtSiF₃, Ph₃SiF, Ph₂SiF₂, PhSiF₃, Me₃CF, Me₂CF₂, MeCF₃, Et₃CF, Et₂CF₂, EtCF₃, Ph₃CF, Ph₂CF₂, PhCF₃, Me₂BF, MeBF₂, MeAlF₂, Et₂BF, EtBF₂, EtAlF₂, Ph₂BF, PhBF₂, Me₃Si(OC₆F₅), Me₂Si(OC₆F₅)₂, MeSi(OC₆F₅)₃, Me₃C(OC₆F₅), Ph₃C(OC₆F₅), Me₂B(OC₆F₅), MeB(OC₆F₅)₂, MeAl(OC₆F₅)₂, and combinations thereof.

5. The method of claim 1, wherein the trihydrocarbyl aluminum compound is selected from the group consisting of AlMe₃, AlEt₃, AlⁱBu₃, AlOct₃, and combinations thereof.

6. The method of claim 1, further comprising introducing a trihydrocarbyl aluminum compound with an oxygen source at a temperature of about −60° C. to about 0° C. to form the alumoxane.

7. The method of claim 1, further comprising introducing a slurry of a support with an oxygen source to a trihydrocarbyl aluminum compound solution to form an aluminoxane in-situ on the support as a supported aluminoxane.

8. The method of claim 6, wherein the trihydrocarbyl aluminum compound is trimethylaluminum.

9. The method of claim 6, wherein the oxygen source is water.

10. The method of claim 6, wherein the oxygen source is an alcohol or a carboxylic acid.

11. The method of claim 1, wherein a ratio of electron withdrawing group X to the trihydrocarbyl aluminum compound is about 1.2:1 to about 1:1.2, wherein the ratio is a molar ratio.

12. The method of claim 11, wherein the moles of the trihydrocarbyl aluminum compound are trihydrocarbyl aluminum compound present in the aluminoxane after the aluminoxane formation.

13. The method of claim 1, wherein the alumoxane is a solution methylalumoxane (MAO) and introducing the solution MAO with the electron withdrawing compound is performed at a temperature of about 10° C. to about 100° C.

14. The method of claim 1, wherein the alumoxane is a supported methylalumoxane (MAO)), and introducing the supported MAO with the electron withdrawing compound is performed at a temperature of about 10° C. to about 100° C. in the presence of a diluent.

15. The method of claim 1, further comprising introducing the supported or unsupported alumoxane composition with at least one pre-catalyst compound.

16. A composition, comprising:
1) a solid or supported alumoxane composition;
2) a blocking agent represented by the formula AlR₂X, wherein R is a C₁ to C₈ hydrocarbyl group, X is a halogen atom, a pseudo halogen group, or a halogenated aryl or aryloxy group; and
3) 0 wt % to about 2 wt % Al from free and/or dimeric forms of trihydrocarbyl aluminum compounds, based on total aluminum content of the composition as determined by titration of the composition with tetrahydrofuran.

17. The composition of claim 16, where R is methyl, ethyl, isobutyl, or octyl, and X is F atom or C₆F₅O— group.

18. A method, comprising:
providing a first composition comprising:
1) a solid or supported alumoxane composition;
2) a blocking agent represented by the formula AlR₂X, wherein R is a C₁ to C₈ hydrocarbyl group, X is a halogen atom, a pseudo halogen group, or a halogenated aryl or aryloxy group; and
3) free and/or dimeric forms of trihydrocarbyl aluminum compounds; and
separating a supernatant from the first composition to form a second composition, the second composition comprising:
1) the solid or supported alumoxane composition;
2) the blocking agent; and
3) the Al from free and/or dimeric forms of the trihydrocarbyl aluminum compounds in an amount of 0 wt % to about 2 wt %, based on total aluminum content of the second composition as determined by titration of the second composition with tetrahydrofuran.

19. A method of making an alumoxane composition, comprising:
1) a supported or solid methylalumoxane (MAO) composition;
2) a blocking agent represented by the Formula (III): 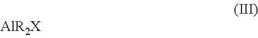
wherein R is a C₁ to C₈ hydrocarbyl group and X is a F or OC₆F₅, provided that Formula (III) is either:
a) pre-formed by bringing into contact of a compound having a formula AlR₂Y, wherein R is C₁ to C₈ hydrocarbyl group and Y is a non-fluorine halide or pseudo halide with an electron withdrawing salt represented by the Formula (IV): 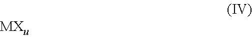
wherein M is a group 1 or 2 metal; u is the valence state of the metal M 1 or 2; and X is F or OC₆F₅; or
b) pre-formed or formed in-situ by bringing into contact of a trihydrocarbyl aluminum compound AlR₃ not present in the MAO composition, wherein R is a C₁ to C₈ hydrocarbyl group, with either the inorganic compound of Formula (I) of claim 1 or the organic compound of Formula (II) of claim 2; and
3) removing free trihydrocarbyl aluminum to obtain the alumoxane composition, the alumoxane composition having 0 wt % to about 2 wt % Al from free and/or dimeric forms of trihydrocarbyl aluminum compounds, based on total aluminum content of the alumoxane composition as determined by titration of the alumoxane composition with tetrahydrofuran.

20. The method of claim 19, wherein AlR₂Y is selected from the group consisting of AlMe₂Cl, AlMe₂Br, AlMe₂I, AlEt₂Cl, AlEt₂Br, AlEt₂I, AlⁱBu₂Cl, AlⁱBu₂Br, AlⁱBu₂I, AlOct₂Cl, AlOct₂Br, AlOct₂I, AlMe₂CN, AlEt₂CN, AlⁱBu₂CN, AlOct₂CN, and combinations thereof, the Formula (IV) compound is selected from the group consisting of LiF, NaF, KF, MgF₂, CaF₂, BaF₂, LiOC₆F₅, NaOC₆F₅, KOC₆F₅, Mg(OC₆F₅)₂, Ca(OC₆F₅)₂, Ba(OC₆F₅)₂, and combinations thereof.

21. The method of claim 19, wherein the supported or solid MAO composition comprises about 0.1 wt % to about 1 wt % of free and/or dimeric forms of the trihydrocarbyl aluminum compounds, based on total aluminum content of the supported alumoxane composition.

22. A catalyst system, comprising:
at least one pre-catalyst compound; and
the supported or unsupported alumoxane composition of claim 16.

23. The catalyst system of claim 22, wherein the pre-catalyst compound is represented by the formula: 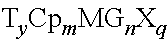
wherein:
Cp is independently a substituted or unsubstituted cyclopentadienyl ligand or substituted or unsubstituted ligand isolobal to cyclopentadienyl;
M is a Group 4 transition metal;
G is a heteroatom group represented by the formula JR*_{z} wherein J is N, P, O or S, and R* is a linear, branched, or cyclic C₁-C₂₀ hydrocarbyl;
z is 1 or 2;
T is a bridging group;
y is 0 or 1;
X is a leaving group;
m=1;
n=1, 2 or 3;
q=0, 1, 2 or 3, and
the sum of m+n+q is equal to the oxidation state of the transition metal.

24. The catalyst system of claim 22, wherein the pre-catalyst compound is a bis(aryl phenolate)pyridine complex.

25. The catalyst system of claim 24, wherein the bis(aryl phenolate)pyridine complex is selected from the group consisting of: 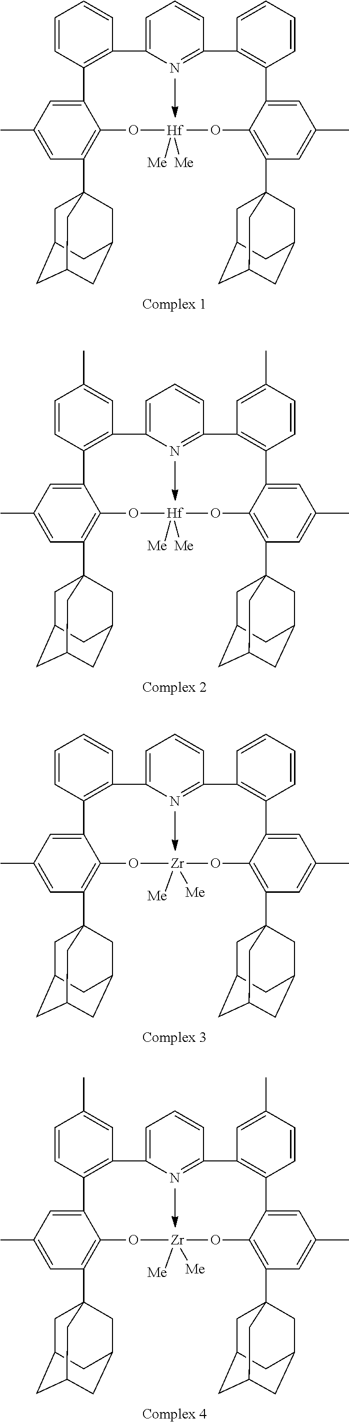 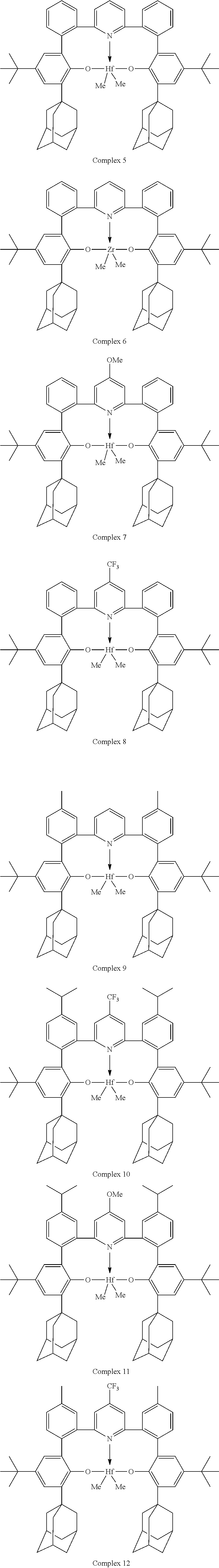 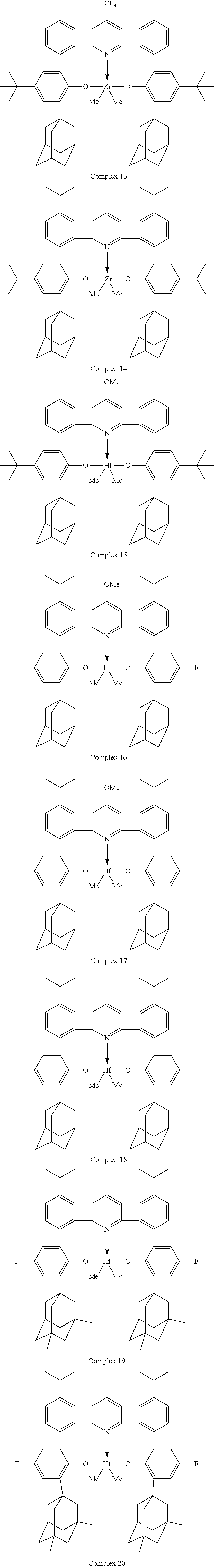 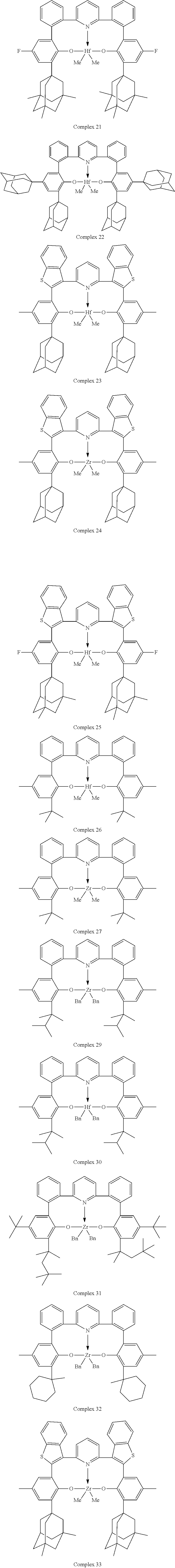 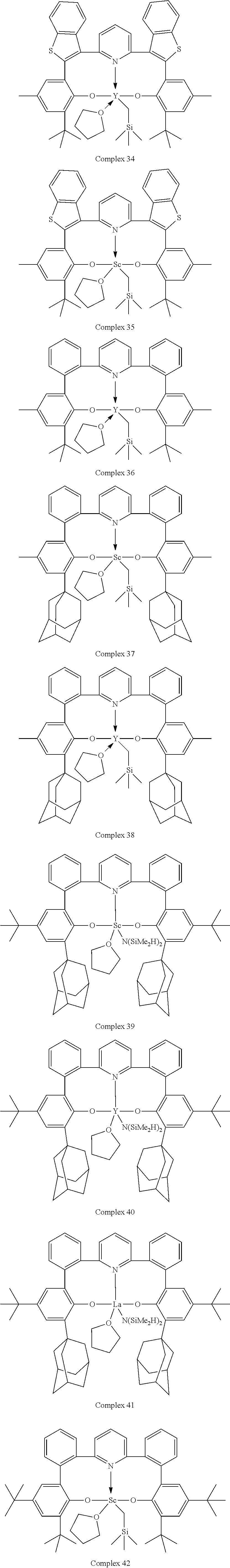
and combinations thereof.

26. The catalyst system of claim 22, wherein the pre-catalyst compound is selected from the group consisting of:

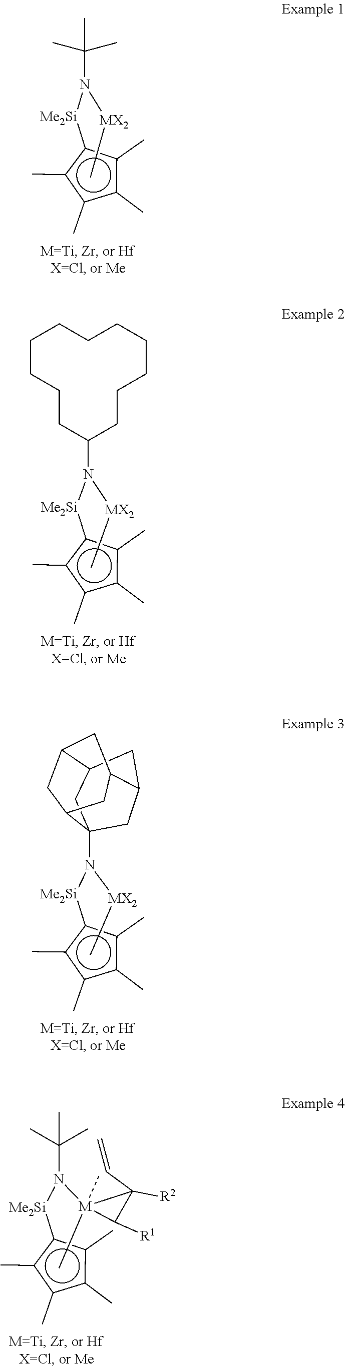

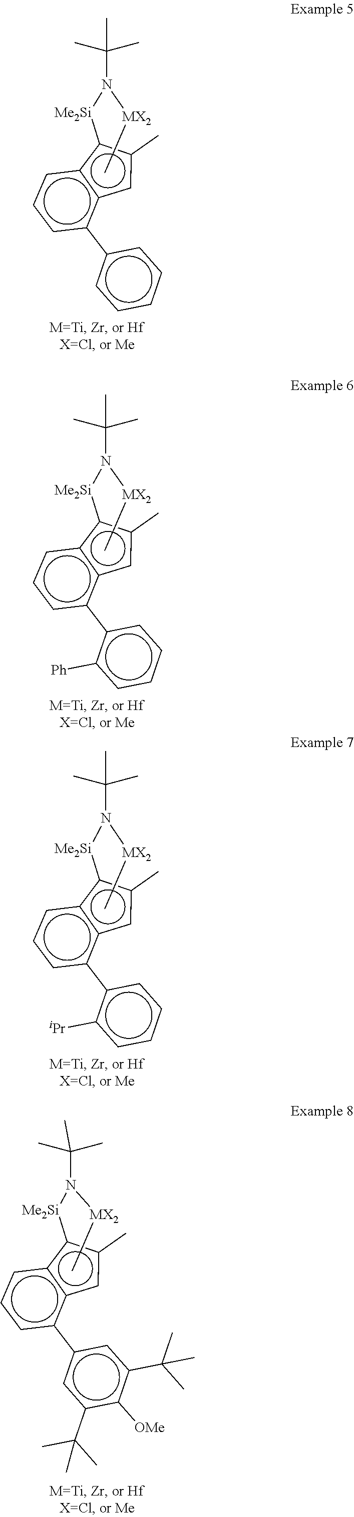

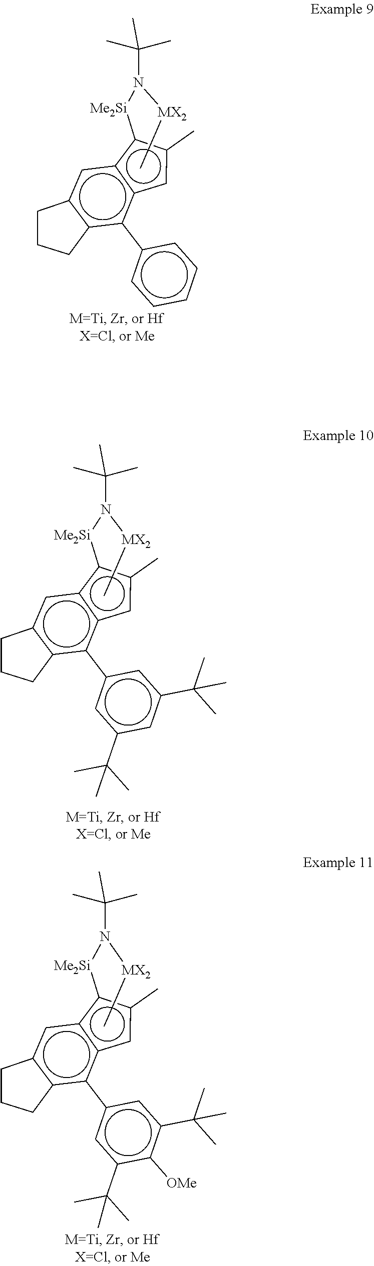

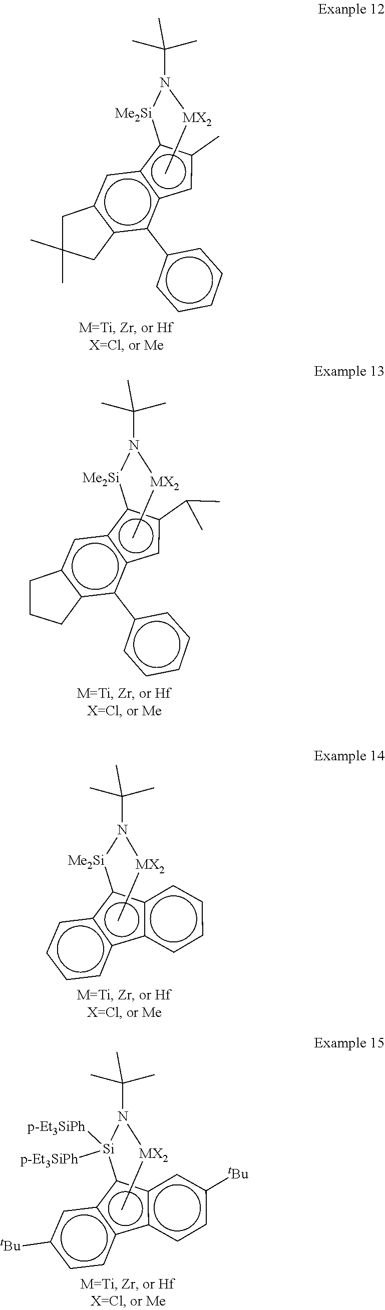

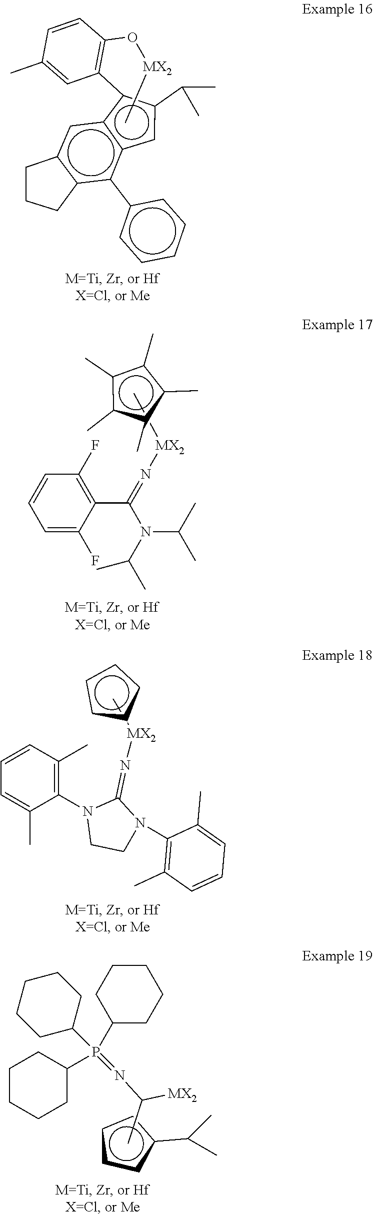

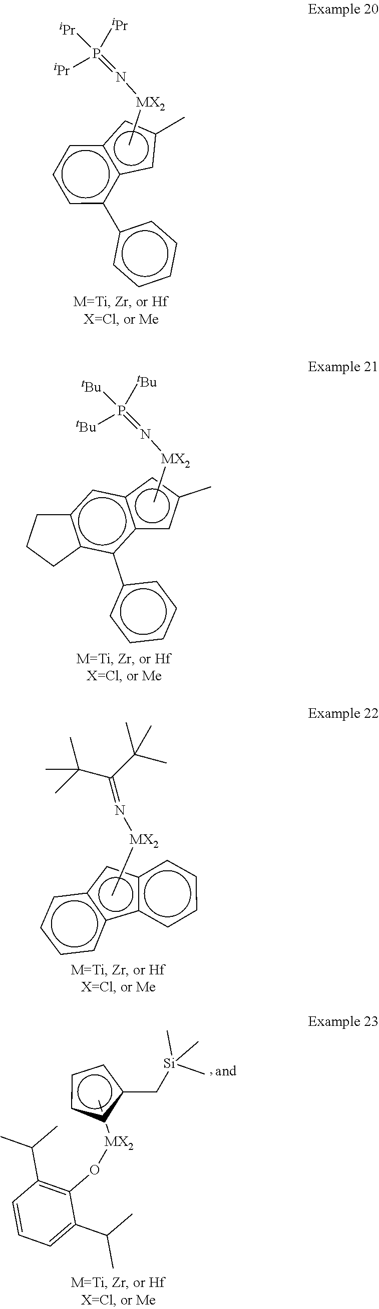

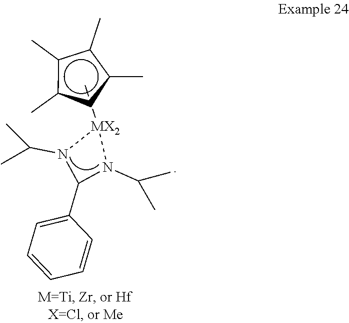

27. A method of polymerizing olefins to produce a polyolefin composition comprising contacting at least one olefin with the catalyst system of claim 22 and obtaining the polyolefin compositions from single or multiple reactor polymerization setup using batch, continuous, or sequential solution, slurry, or gas-phase polymerization.

28. The method of claim 27, wherein the catalyst system has a catalyst activity of about 2,000 gPgcat⁻¹hr⁻¹ to about 30,000 gPgcat⁻¹hr⁻¹ for supported catalyst and about 10,000 gPgcat⁻¹hr⁻¹ to about 1,000,000 gPgcat⁻¹hr⁻¹ for solution catalyst.
